(19) United States
(12) Patent Application Publication
(10) Pub. No.: US 2024/0393107 A1
(43) Pub. Date: Nov. 28, 2024

(54) STRUCTURED-LIGHT-BASED TRENCH PROFILE MEASUREMENT FOR PLANTER ROW UNIT

(71) Applicant: DEERE & COMPANY, Moline, IL (US)

(72) Inventors: Michio Kise, Bondurant, IA (US); Lee A. Johnson, Polk City, IA (US); Lee E. Zumdome, Bettendorf, IA (US); Joseph J. Ellerbach, Waukee, IA (US)

(21) Appl. No.: 18/795,410

(22) Filed: Aug. 6, 2024

Related U.S. Application Data
(63) Continuation of application No. PCT/US23/12451, filed on Feb. 6, 2023.
(60) Provisional application No. 63/307,765, filed on Feb. 8, 2022.
(60) Provisional application No. 63/269,314, filed on Mar. 14, 2022.
(60) Provisional application No. 63/438,404, filed on Jan. 11, 2023.
(60) Provisional application No. 63/440,455, filed on Jan. 23, 2023.
(60) Provisional application No. 63/442,283, filed on Jan. 31, 2023.
(60) Provisional application No. 63/442,294, filed on Jan. 31, 2023.

(51) Int. Cl. G01B 11/25; A01C 5/06; G06T 7/00; G06T 7/521; G06T 7/73; H04N 23/74

(52) U.S. Cl. CPC G01B 11/254; A01C 5/064; A01C 5/068; G06T 7/0002; G06T 7/521; G06T 7/73; H04N 23/74; G06T 2207/10028; G06T 2207/30188; G06T 2207/30252

(57) ABSTRACT

A visualization system for a planter row unit having closing and furrow opening disks. The visualization system includes a structured light unit and a camera mounted between the closing wheels and the furrow opening disks. The structured light unit is operable to project a patterned light on a trench in a ground surface formed by the planter row unit, and the camera is operable to record a field of view that includes the patterned light on the trench to determine and measure a three-dimensional trench measurement. The camera captures the 2D image of the trench with the projected patterned light. Optionally, the visualization system includes a general illumination light to illuminate the visual characteristics of the trench. The visualization system can determine the depth of the actual trench, the commodity depth of the commodity in the actual trench, and the 3D actual trench profile.

### CROSS-REFERENCE TO RELATED APPLICATIONS

This application is a continuation of International PCT application Ser. No. PCT/US2023/012451, filed Feb. 6, 2023, which claims priority to U.S. Provisional patent application Ser. No. 63/307,765 filed Feb. 8, 2022, U.S. Provisional patent application Ser. No. 63/269,314 filed Mar. 14, 2022, U.S. Provisional patent application Ser. No. 63/438,404 filed Jan. 11, 2023, U.S. Provisional patent application Ser. No. 63/440,455 filed Jan. 23, 2023, U.S. Provisional patent application Ser. No. 63/442,283 filed Jan. 31, 2023, and U.S. Provisional patent application Ser. No. 63/442,294 filed Jan. 31, 2023, the contents of which are incorporated herein by reference in their entireties.

### FIELD OF THE DISCLOSURE

The present disclosure relates to a visualization system for a work machine, and in particular to a visualization system for a planter row unit. The present disclosure relates to improving a camera line of visualization for the visualization system for a work machine. The present disclosure relates to optical imaging sensed by a visualization system mounted on a work machine. The present disclosure relates to optical imaging sensed by a visualization system mounted on a work machine that adjusts for environmental conditions. The present disclosure relates to assessing one or more furrow characteristics from a visual display of a furrow profile accessed from images provided by a visualization system for a work machine.

### BACKGROUND OF THE DISCLOSURE

Farmers, like others, seek to increase their productivity. Farmers typically use planter row units that include various ground-engaging tools that assist in the commodity or seed deposition process by, for example, opening furrows to form trenches, placing or depositing commodities or seed in the trenches, packing the soil, and closing the furrows or trenches over the newly-deposited commodities. From the operator's cab, it is difficult to see the shape of the trench after formation of the trench because the closing wheels on the planter row unit close or replace the displaced soil into the trench after depositing the seed or commodity in the trench. It is also difficult to see deposition of the commodities or seeds in the trench because the closing wheels close the trench quickly.

Farmers want to optimize placement of seed in trenches to maximize growth of plants from the seeds. When the seed is being deposited from the planter row unit, the farmer or operator is typically located in the cab of the tractor and cannot see the placement of the seed and shape of the trench because the trench is closed and the seed is covered as the planter row unit operates across the field. To see the trench before it is closed, the farmer must stop movement of the tractor that is pulling the planter row unit, and then the farmer exits the cab and visually inspects the shape of the trench and placement of the seed in the trench. Typically, farmers will begin planting a crop in a field by placing seed in a trench for a short distance such as 15 to 20 feet before stopping the tractor and walking to visually inspect the seeds that were placed in that 15 to 20 feet of field by removing soil to find the seeds. When the operator stops the tractor and exits the operator's cab for visual inspection of the planted seeds, this decreases efficiency and decreases productivity.

One option to increase efficiency, increase productivity, and increase the quality of trench formation and commodity placement by planter row units is to add one or more cameras to the planter row unit such that an operator from an operator's cab of the planter row unit or elsewhere can see the seed furrow.

There are some notable challenges for the practical implementation of a camera on a planter row unit wherein the camera is viewing the furrow and commodity or seed placement. One of the most significant challenges is dust and debris that can occur while the planter row unit operates thereby causing an obstruction of a camera line of visualization CV of the camera. For example, as a furrow opener or furrow opening disks on the planter row unit opens or cuts into the soil to form the trench there is dust, residue, debris, corn stalks, and other vegetation that is kicked up into the air and into the camera line of visualization CV of the camera or the camera's range of view. Another challenge that can occur while the planter row unit operates is entry of sunlight at different angles to the camera's view thereby affecting visualization of the commodity and the shape of the trench and any light plane LP from a structured light unit. A good and consistent view of the shape of the trench and commodity therein by the camera is important so that the image can be used for computer processing.

Therefore, further contributions in this area of technology are needed to mitigate issues caused by dust and debris during trench formation and commodity placement during operation of the planter row units. Further contributions in this area of technology are needed to mitigate issues caused by varying angles and entry of sunlight into the view of the camera. Therefore, there remains a significant need for the apparatuses, methods, and systems disclosed herein.

It is contemplated that the quality of seeding has significant impacts on crop yield. It is further contemplated that there are several essential factors which govern seed planting quality. These factors include, but are not limited to: a seed's final resting place, spacing between planted seeds, depths of the planted seeds, furrow integrity, which may be represented by a desirable furrow shape and structure, and seed to soil contact, which may be represented by seedbed quality metrics indicating soil content materials. In particular, it is contemplated that seed to soil contact may be estimated by establishing a ratio of soil to debris, wherein higher percentages of debris (i.e., MOG, or refuse) may indicate that the soil contains an abundance of debris and thus a planted seed is not resting in contact with soil but instead resting in contact with debris matter.

Planting quality and assessment of the commodity by the farmer's visual inspection of the planted commodity and shape of the trench can be subjective. The frequency in which the farmer stops planting operation of the planter row unit to exit the cab to visually inspect the trench formation and commodity placement can be infrequent as this reduces productivity of the planting operation. Moreover, the farmer may manually dig into the soil to physically measure planting depth and observe the seedbed quality. These techniques utilize time, produce measurements that vary due to inconsistencies and subjectiveness and may only assess a small fraction of the planted seeds for an entire field.

To increase productivity, the farmer may not frequently stop the planter row unit to visually inspect the commodity placement and quality of trench formation which results in infrequent inspection. Infrequent inspection of the commodity placement and quality of trench formation assesses only a small fraction of an entire field for the planted commodity and quality of trench formation. The location and depth of the planted commodity and the quality of trench formation may vary significantly between these infrequent inspection checks. There may be inconsistent or suboptimal depth of commodity placement and inconsistent quality of trench formation between these infrequent inspection checks.

Another seed metric obtaining technique includes utilizing seed counting mechanisms on the planter row unit that sense commodity or seed while the commodity falls or is conveyed through a seed drop chute of the seed counting mechanism of the planter row unit. Seed counting mechanisms sense seeds or commodity before the seed or commodity contacts the soil or ground surface. When the seed or commodity contacts the soil or ground, the seed or commodity can bounce or otherwise move after making contact with the soil or ground surface, and thus the commodity may be in a different final position than where it was desired to be. Other seeding metric techniques utilize a seed firmer to physically guide seeds into an open furrow and control of the seed fall and manually establish a depth dictated by a physical position of the firmer.

Therefore, further contributions in this area of technology are needed to increase efficiency, increase productivity, and increase the quality of trench formation and certainty of commodity placement by planter row units during operation. Therefore, there remains a significant need for the apparatuses, methods, and systems disclosed herein.

Various environmental factors such as air quality and angle of and amount of sunlight relative to an imaging unit and/or an illumination unit affect the quality of trench images that can be captured by the imaging unit. Poor or low quality of captured trench images limits the amount of trench characteristics that can be determined from the captured images.

Therefore, further contributions in this area of technology are needed to increase efficiency, increase productivity, and increase the quality of trench formation and certainty of commodity placement by planter row units during operation. Therefore, there remains a significant need for the apparatuses, methods, and systems disclosed herein.

The practical implementation of a camera on a planter row unit wherein the camera is viewing and capturing images of the furrow and commodity or seed placement while a structured light unit projects a patterned light onto the furrow can be challenging. Typically the furrow or trench consists of dark soil and there can be poor lighting conditions since the planter row unit is traveling over the trench while the images are being captured by the camera. The captured images from the camera are displayed on a graphical user interface in a cab of the planter row unit for an operator to view.

Often when a furrow is formed in a ground surface by a furrow opener or furrow opening disks on the planter row unit, there is dust, residue, debris, corn stalks, and other vegetation that is kicked up into the air and then this material falls back into the trench or furrow while the commodity or seed is being deposited. It is difficult to see if any of this foreign or unwanted material is in the trench because the closing wheels close the trench quickly. This additional unwanted material in the furrow is captured in the images by the camera and displayed on the user interface. However, it is often difficult for the operator to identify this additional unwanted material in the furrow in the captured images on the user interface while the planter is traveling across the field at an efficient speed for depositing commodities that is desired for productivity.

Another challenge that can occur is that the captured image on the user interface appears two-dimensional on the user interface to the operator, rather than three-dimensional. The two-dimensional appearance of the trench in the captured images affects the operator's visualization of the commodity, visualization of the cross-sectional shape of the trench, and visualization of the actual construction of the trench along the length of the trench. It is also difficult for the operator to determine from the captured image displayed on the user interface whether the actual depth of the furrow is too shallow and/or to determine the actual cross-sectional shape of the furrow.

Therefore, further contributions in this area of technology are needed to increase efficiency, increase productivity, and increase the quality of trench formation and commodity placement by planter row units during operation. Therefore, there remains a significant need for the apparatuses, methods, and systems disclosed herein.

Therefore, further contributions in this area of technology are needed to increase efficiency, increase productivity, and increase the quality of trench formation and commodity placement by planter row units during operation. Therefore, there remains a significant need for the apparatuses, methods, and systems disclosed herein.

### SUMMARY

According to one embodiment of the present disclosure, a visualization system for a planter row unit, the planter row unit having a closing system and one or more furrow opening disks, the visualization system comprising: a structured light unit attached to the planter row unit, wherein the structured light unit is mounted between the closing system and the one or more furrow opening disks, wherein the structured light unit is operable to project a patterned light on a ground surface having a trench therein formed by the one or more furrow opening disks; a camera attached to the planter row unit, wherein the camera is mounted between the closing system and the one or more furrow opening disks, wherein the camera is operable to capture the patterned light on the trench in the ground surface in a two-dimensional image; and a controller operatively coupled to the camera, the controller including one or more processors configured to execute computer readable instructions that perform processing steps to determine a three-dimensional measurement of the trench in the ground surface from the two-dimensional image.

One example of this embodiment, further comprising: a general illumination light attached to the planter row unit, wherein the general illumination light is mounted between the closing system and the one or more furrow opening disks. Another example of this embodiment, wherein the general illumination light and the structured light unit are operable in an alternating sequence while the camera is operable.

Another example of this embodiment, wherein the general illumination light, the structured light unit, and the camera are operable in a synchronized manner, and wherein the general illumination light and the structured light unit are activated when the camera captures the two-dimensional image.

Another example of this embodiment, wherein the structured light unit is positioned between the closing system and a seed delivery system on the planter row unit.

Another example of this embodiment, further comprising: one or more of a commodity positioned in the actual trench; wherein the camera and the controller are operable to determine a commodity depth from a location of the commodity in the trench in the two-dimensional image and three-dimensional measurement of the trench.

Another example of this embodiment, wherein the camera and the controller are operable in a synchronized manner to capture the image of the one or more commodity in the trench.

Another example of this embodiment, wherein the camera and the controller are operable to determine a depth of the trench from the three-dimensional measurement of the trench.

Another example of this embodiment, wherein the patterned light includes one or more points in the two-dimensional image, and the three-dimensional measurement of the trench is determined from the one or more points.

Another example of this embodiment, wherein the structured light unit and the camera are both operable in a non-visible spectrum range.

Another example of this embodiment, further comprising: determining a three-dimensional trench profile of the trench in the ground surface from the two-dimensional image and three-dimensional measurement of the trench.

Another example of this embodiment, wherein the camera and the controller are operable to determine a trench quality condition of the trench formed in the ground surface by comparing the three-dimensional actual trench profile to an ideal trench profile.

Another example of this embodiment, wherein the structured light unit is a visible light.

According to another embodiment of the present disclosure, a method comprising: forming an actual trench by a planter row unit, the planter row unit having a closing system and one or more furrow opening disks; emitting a patterned light from a visualization system onto—the actual trench in a ground surface formed by the one or more furrow opening disks, wherein the visualization system includes a structured light unit mounted on the planter row unit; capturing a two-dimensional image of the projected patterned light on the trench with the visualization system that includes a camera mounted on the planter row unit; and determining a three-dimensional measurement of the trench in the ground surface from the two-dimensional image with the visualization system that includes a controller operably connected to the camera.

One example of this embodiment, further comprising: determining a three-dimensional location of the projected patterned light from the captured two-dimensional image with the visualization system and the three-dimensional measurement of the trench; and measuring a three-dimensional actual trench profile from the three-dimensional measurement of the trench with the visualization system.

One example of this embodiment, further comprising: determining a trench quality condition of the trench in the ground surface by comparing the three-dimensional actual trench profile to an ideal trench profile.

One example of this embodiment, further comprising: accumulating two or more images of the actual trench profile with the camera; and reconstructing a length of the actual trench profile with the accumulated two or more images with the visualization system.

One example of this embodiment, further comprising: operating a general illumination light that is mounted on the planter row unit to illuminate the trench in the ground surface.

One example of this embodiment, further comprising: alternating the operating the general illumination light and the emitting the patterned light from the structured light unit.

One example of this embodiment, wherein the operating includes synchronizing the general illumination light, the structured light unit, and the camera such that the general illumination light and the structured light unit are activated when the camera captures the two-dimensional image.

One example of this embodiment, further comprising: depositing a commodity in the actual trench by the planter row unit; determining a location of the commodity in the trench in the two-dimensional image with the visualization system; and determining the commodity depth from the location of the commodity in the two-dimensional image and the three-dimensional measurement of the trench with the visualization system.

According to another embodiment of the present disclosure, a method of measuring an actual trench profile formed by a planter row unit, the planter row unit having a closing system and one or more furrow opening disks, the method comprising: emitting a patterned light from a visualization system onto a trench in a ground surface formed by the one or more furrow opening disks, wherein the visualization system includes a structured light unit mounted on the planter row unit; capturing a two-dimensional image of the projected patterned light on the trench with the visualization system that includes a camera mounted on the planter row unit; determining a three-dimensional location of the projected patterned light from the captured two-dimensional image with the visualization system that includes a controller operably coupled to the camera; and measuring an actual trench depth from the three-dimensional location of the projected patterned light with the visualization system.

One example of this embodiment, further comprising: measuring a three-dimensional actual trench profile from the three-dimensional location of the projected patterned light with the visualization system; accumulating two or more images of the actual trench profile with the camera; and reconstructing a length of the actual trench profile with the accumulated two or more images.

One example of this embodiment, further comprising: determining a trench quality condition of the trench in the ground surface by comparing the three-dimensional actual trench profile to an ideal trench profile.

One example of this embodiment, further comprising: operating a general illumination light that is mounted on the planter row unit to illuminate the trench in the ground surface.

One example of this embodiment, further comprising: alternating the operating the general illumination light and the emitting the patterned light from the structured light unit.

One example of this embodiment, further comprising: depositing a commodity in the actual trench by the planter row unit; determining a location of the commodity in the trench in the two-dimensional image; and determining the commodity depth from the location of the commodity in the two-dimensional image and the actual trench depth.

One example of this embodiment, wherein the controller is operatively coupled to the structured light unit.

One example of this embodiment, further comprising: one or more of a spotlight or a light emitting diode attached to the planter row unit, wherein the one or more of the spotlight or the light emitting diode is mounted between the closing system and the one or more furrow opening disks.

One example of this embodiment, wherein the camera and the controller are operable to determine a furrow depth from the trench in the two-dimensional image and the three-dimensional measurement of the trench.

One example of this embodiment, wherein the controller is operatively coupled to the structured light unit.

One example of this embodiment, further comprising operating one or more of a spotlight or a light emitting diode that is mounted on the planter row unit to illuminate the trench in the ground surface.

One example of this embodiment, wherein the controller is operatively coupled to the structured light unit.

One example of this embodiment, further comprising: operating one or more of a spotlight or a light emitting diode that is mounted on the planter row unit to illuminate the trench in the ground surface.

According to one embodiment of the present disclosure, a visualization system for a planter row unit, the planter row unit having a closing system and one or more furrow opening disks, the visualization system comprising: a structured light unit attached to the planter row unit, wherein the structured light unit is mounted between the closing system and the one or more furrow opening disks, wherein the structured light unit is operable to project a patterned light on a ground surface having a trench therein formed by the one or more furrow opening disks; a camera attached to the planter row unit, wherein the camera is mounted between the closing system and the one or more furrow opening disks, wherein the camera is operable to capture the patterned light on the trench in the ground surface in a two-dimensional image; and a controller operatively coupled to the camera, the controller including one or more processors configured to execute computer readable instructions that perform processing steps to measure a three-dimensional actual trench profile from the two-dimensional image, and wherein the controller is operatively coupled to the structured light unit.

In one example of this embodiment, further comprising: one or more of a spotlight or a light emitting diode attached to the planter row unit, wherein the one or more of the spotlight or the light emitting diode is mounted between the closing system and the one or more furrow opening disks.

In a second example of this embodiment, wherein the camera and the controller are operable to determine a furrow depth from the trench in the two-dimensional image and the three-dimensional actual trench profile.

According to another embodiment of the present disclosure, a method comprising: forming an actual trench by a planter row unit, the planter row unit having a closing system and one or more furrow opening disks; depositing a commodity in the actual trench by the planter row unit; emitting a two-dimensional patterned light from a visualization system onto a trench in a ground surface formed by the one or more furrow opening disks, wherein the visualization system includes a structured light unit mounted on the planter row unit; capturing a two-dimensional image of the projected patterned light on the trench with the visualization system that includes a camera mounted on the planter row unit; determining a location of the commodity in the trench in the two-dimensional image with the visualization system that includes a controller operably connected to the camera, wherein the controller is operatively coupled to the structured light unit; and determining the commodity depth from the location of the commodity in the two-dimensional image and the actual trench profile with the visualization system.

In one example of this embodiment, further comprising: operating one or more of a spotlight or a light emitting diode that is mounted on the planter row unit to illuminate the trench in the ground surface.

In one example of this embodiment, further comprising: determining a furrow depth from the trench in the two-dimensional image and/or the three-dimensional actual trench profile with the visualization system.

According to another embodiment of the present disclosure, a method of measuring an actual trench profile formed by a planter row unit, the planter row unit having a closing system and one or more furrow opening disks, the method comprising: emitting a two-dimensional patterned light from a visualization system onto a trench in a ground surface formed by the one or more furrow opening disks, wherein the visualization system includes a structured light unit mounted on the planter row unit; capturing a two-dimensional image of the projected patterned light on the trench with the visualization system that includes a camera mounted on the planter row unit, wherein the controller is operatively coupled to the structured light unit; determining a three-dimensional location of the projected patterned light from the captured two-dimensional image with the visualization system that includes a controller operably coupled to the camera; and measuring a three-dimensional actual trench profile from the three-dimensional location of the projected patterned light with the visualization system.

In one example of this embodiment, further comprising: operating one or more of a spotlight or a light emitting diode that is mounted on the planter row unit to illuminate the trench in the ground surface.

In another example of this embodiment, further comprising: determining a furrow depth from the trench in the two-dimensional image and/or the three-dimensional actual trench profile.

According to one embodiment of the present disclosure, a shield for assembly on a planter row unit, the planter row unit having a closing system and a furrow opening disk, the shield comprising: a top edge opposite a bottom edge; and an upper portion adjacent a lower portion that span between the top and bottom edges, wherein the upper portion is configured for assembly to the planter row unit adjacent to the furrow opening disk, wherein the upper portion has a height that extends from the top edge to the lower portion, wherein the lower portion has a height that extends from the upper portion to the bottom edge.

In one example of this embodiment, wherein an outside face of at least one of the upper or the lower portions forms a shield angle relative to a plane that is defined by an intersection of a longitudinal axis and a vertical axis of the planter row unit; and wherein an inboard side of the furrow opening disk forms a disk angle relative to the plane that is defined by the intersection of the longitudinal axis and the vertical axis of the planter row unit, the shield angle being substantially similar to the disk angle.

In one example of this embodiment, wherein the outside face of the at least one of the upper or the lower portions forms a second shield angle relative to a plane that is defined by an intersection of the vertical axis and a horizontal axis of the planter row unit; and wherein an inboard side of the furrow opening disk forms a second disk angle relative to the plane that is defined by the intersection of the vertical axis and the horizontal axis of the planter row unit, the second shield angle being substantially similar to the second disk angle.

In one example of this embodiment, further comprising: an adjustment mechanism configured to move at least one of the upper or the lower portions such that a portion of the outside face of the at least one of the upper or the lower portions contacts the inboard side of the furrow opening disk.

In one example of this embodiment, wherein the upper portion is assembled onto the planter row unit such that a gap exists between an outside face of at least one of the upper or the lower portions and an inboard side of the furrow opening disk. In one example of this embodiment, wherein the gap is less than 5 millimeters.

In one example of this embodiment, wherein the upper portion includes a rigid section, and the lower portion includes a flexible section.

In one example of this embodiment, wherein the height of the lower portion is sufficient such that the lower portion extends into a furrow created by the furrow opening disk when the upper portion is assembled to the planter row unit.

In one example of this embodiment, further comprising: a second shield component assembled with at least one of the upper or the lower portions, wherein the second shield component is adjustable relative to the at least one of the upper or the lower portions such that an adjusted height of the second shield component combined with the upper and the lower portions is greater than a total height of the upper and the lower portions.

In one example of this embodiment, further comprising: a visualization system attached to the planter row unit, the visualization system includes a camera and a structured light unit; wherein the length of the lower portion extends from an outer diameter of the furrow opening disk to a position located between the furrow opening disk and the closing system such that all or a portion of a structured light pattern emitted from the structured light unit is visible on the lower portion.

In one example of this embodiment, wherein an inside face of at least one of the upper and the lower portions includes a marker positioned at a designated location on the inside face for identification by the camera line of visualization of the camera.

In one example of this embodiment, wherein at least one of the upper and the lower portions is attached to a frame of the planter row unit.

In one example of this embodiment, further comprising: a bracket pivotably attached to a frame of the planter row unit, the bracket includes a pivot attachment arm that is mounted on the frame, the bracket includes a leg portion having one or more holes; and one or more fasteners engage the one or more holes and attach at least one of the upper and the lower portions to the bracket.

In one example of this embodiment, further comprising: an actuator operably connected to the frame of the planter row unit and at least one of the upper and the lower portions, the actuator configured to move the shield relative to the frame.

In one example of this embodiment, further comprising: wherein the top edge of the upper portion includes a tab to engage a frame of the planter row unit, wherein the tab defines a hole; and a fastener engages the hole of the tab and attaches the upper portion to the frame.

In one example of this embodiment, further comprising: one or more of a brush or a ski member attached to the bottom edge.

In one example of this embodiment, further comprising: an extension piece assembled with the lower portion, the extension piece having a portion that extends below the bottom edge. In one example of this embodiment, wherein the extension piece extends outwardly from an outside face of the lower portion.

In one example of this embodiment, wherein the lower portion includes a bent section that extends outwardly relative to a frame of the planter row unit.

In one example of this embodiment, further comprising: an air blower that provides an airflow near at least one of the upper and the lower portions, the air blower attached to the planter row unit.

According to another embodiment of the present disclosure, a shield for assembly on a planter row unit, the planter row unit having a closing wheel and an furrow opening disk, the shield comprising: a first shield component configured for assembly to the planter row unit, the first shield component has a first height that extends from a top edge to a bottom edge; and a second shield component, wherein the second shield component is connected with the first shield component, the second shield component is movable relative to the first shield component such that an adjusted height of the first and second shield components together is greater than the height of the first shield component.

In one example of this embodiment, wherein an outside face of either of the first or the second shield components forms a shield angle relative to a plane that is defined by an intersection of a longitudinal axis and a vertical axis of the planter row unit; and wherein an inboard side of the furrow opening disk forms a disk angle relative to the plane that is defined by the intersection of the longitudinal axis and the vertical axis of the planter row unit, the shield angle being substantially similar to the disk angle.

In another example of this embodiment, wherein the outside face of either of the first or the second shield components forms a second shield angle relative to a plane that is defined by an intersection of the vertical axis and a horizontal axis of the planter row unit; and wherein an inboard side of the furrow opening disk forms a second disk angle relative to the plane that is defined by the intersection of the vertical axis and the horizontal axis of the planter row unit, the second shield angle being substantially similar to the second disk angle. In one refinement of this embodiment, further comprising: an adjustment mechanism configured to move the second shield component to contact the inboard side of the furrow opening disk.

In one example of this embodiment, wherein the first shield component is assembled onto the planter row unit such that a gap exists between an outside face of the first shield component and an inboard side of the furrow opening disk. In one refinement of this embodiment, wherein the gap is less than 5 millimeters.

In one example of this embodiment, wherein at least one of the first or the second shield components includes a rigid section and the other of the first or the second shield components includes a flexible section.

In another example of this embodiment, wherein a portion of the second shield component extends into a furrow created by the furrow opening disk when the first shield component is assembled to the planter row unit.

In yet another example of this embodiment, further comprising: a visualization system attached to the planter row unit, the visualization system includes a camera and a structured light unit; wherein a length of at least one of the first or the second shield components extends from an outer diameter of the furrow opening disk to a position located between the opening and closing wheels that includes portions of a camera line of visualization of the camera and a light plane from the structured light unit.

In another example of this embodiment, wherein an inside face of at least one of the first or the second shield components includes a marker positioned at a designated location on the inside face for identification by the camera line of visualization of the camera. In one refinement of this embodiment, wherein the marker includes a plurality of markers, each of the plurality of markers positioned at a particular designated location on the inside face for calibration of the visualization system.

In yet another example of this embodiment, wherein the first shield component is attached to a frame of the planter row unit. In one refinement of this embodiment, further comprising: a bracket pivotably attached to a frame of the planter row unit, the bracket includes a pivot attachment arm that is mounted on the frame, the bracket includes a leg portion having one or more holes; and one or more fasteners engage the one or more holes and attach the first shield component to the bracket.

In one example of this embodiment, further comprising: an actuator operably connected to the frame of the planter row unit and the first shield component, the actuator configured to move the shield relative to the frame.

In another example of this embodiment, further comprising: wherein a top edge of the first shield component includes a tab to engage a frame of the planter row unit, wherein the tab defines a hole; and a fastener engages the hole of the tab and attaches the first shield component to the frame.

In yet another example of this embodiment, further comprising: one or more of a brush or a ski member attached to a bottom edge of the second shield component.

In one example of this embodiment, further comprising: an extension piece assembled with the second shield component, the extension piece having a portion that extends below a bottom edge of the second shield component. In one refinement of this embodiment, wherein the extension piece extends outwardly from an outside face of the second shield component.

In another example of this embodiment, wherein the second shield component includes a bent section that extends outwardly relative to a frame of the planter row unit.

In one example of this embodiment, further comprising: an air blower that provides an airflow near at least one of the first and second shield components, the air blower attached to the planter row unit.

According to another embodiment of the present disclosure, a method of calibrating a visualization system attached to a planter row unit, the method comprising: providing a shield attached to the planter row unit, wherein the shield has a marker; determining if the marker on the shield can be detected with the visualization system attached to the planter row unit; upon detection of the marker with a camera from the visualization system, calibrating the visualization system; and if the marker is not detected with the camera, ceasing operation of the visualization system.

In one example of this embodiment, wherein the determining if the marker on the shield can be detected includes determining if two or more markers on the shield can be detected with the visualization system.

In another example of this embodiment, wherein the visualization system includes a camera and a structured light unit.

The currently disclosed system, method, and computer readable medium, embodying computer readable instructions for furrow imaging and analysis according to embodiments of the present application enable users to assess one or more of a seed's final resting place, a spacing between planted seeds, depths of the planted seeds, furrow integrity, and/or seed to soil contact by way of soil content characterization. Embodiments of the presently described application relate to one or more systems, one or more methods, and computer readable instructions embodied on one or more computer readable mediums which when executed by one or more processors of the one or more systems, causes the one or more systems to perform processing steps for furrow imaging and analysis, which further provides contact-free and automatic assessment of a seeding process in real time and/or offline.

One primary aspect of the present application provides systems, methods, and computer readable media, embodying computer readable instructions, which when executed by one or more processors of a system, causes the system to perform processing steps for furrow imaging and analysis. In any of the embodiments, the furrow imaging and analysis is performed under controlled illumination including any of passive illumination, active illumination, and/or structured light. In any of the embodiments, the furrow imaging and analysis is performed with a vehicle speed of the planting device that effects or controls the frame rate and/or shutter speed of the imaging unit. As demonstrated the vehicle speed is used to inform the camera exposure time. Controlling the illumination and frame rate or shutter speed for the captured image will determine what type of image is captured by the one or more processors and will govern analyzation of the particular image that is captured at the vehicle speed of the planting device.

Another primary aspect of the present application provides systems, methods, and computer readable media, embodying computer readable instructions, which when executed by one or more processors of a system, causes the system to perform processing steps that determine seed placement, within a furrow, during planting. Another primary aspect of the present application provides systems, methods, and computer readable media, embodying computer readable instructions, which when executed by one or more processors of a system, causes the system to perform processing steps that estimate planting depth of planted seeds. Another primary aspect of the present application provides systems, methods, and computer readable media, embodying computer readable instructions, which when executed by one or more processors of a system, causes the system to perform processing steps that determine furrow shape and furrow structure estimation metrics. Another primary aspect of the present application provides systems, methods, and computer readable media, embodying computer readable instructions, which when executed by one or more processors of a system, causes the system to perform the processing steps for furrow imaging and analysis, seed placement, seed depth estimation, furrow shape estimation, and furrow structure estimation, all in real-time.

Yet another aspect of the present application provides systems and methods for estimating seedbed content metrics. Another aspect of the present application provides systems and methods for notifying an operator of seed, furrow, and seedbed metrics. Another aspect of the present application provides systems and methods for location-based field registration and mapping of any of seed placement, seed depth estimation, furrow shape estimation, and furrow structure estimation. The location-based field registration can also account for the velocity of the planting vehicle at the time any images were captured. Another aspect of the present application provides systems and methods for automatically adjusting planter components in response to determined furrow and/or seeding metrics.

Another aspect of the present application provides a system that does not require an operator to stop the planter to manually take measure or make component adjustments. Yet another aspect of the present application provides a technique that allows for a closed-loop system that can self-adjust on the go to optimize according to the operator's targets. Another aspect of the present application provides a system that allows for the closed loop control of planter setting functions such as, and not limited to, planter downforce, row cleaning aggressiveness, and closing force.

According to one embodiment of the present disclosure, a method of measuring a furrow depth of a trench formed by a planter row unit, the planter row unit having a closing system and one or more furrow opening disks, the method comprising: projecting, with an illumination unit mounted on the planter row unit, an active illumination at an angle onto the trench in a ground surface formed by the one or more furrow opening disks, capturing one or more images of the trench with an imaging unit mounted on the planter row unit, while the planter row unit is traveling at a vehicle velocity; determining a pixel position of an illumination baseline in the captured one or more velocity based images with a furrow analyzing processor operatively coupled with the imaging unit and the illumination unit; determining a pixel position of an illumination nadir in the captured one or more velocity based images with the furrow analyzing processor; determining the furrow depth of the trench using the pixel position of the illumination baseline and the pixel position of the illumination nadir.

In one example of this embodiment, wherein the vehicle velocity is zero.

In a second example of this embodiment, further comprising: determining a color percentage of a particular color on the one or more images with the furrow analyzing processor operatively coupled with the imaging unit; and comparing the color percentage to a predetermined color threshold, wherein the color percentage being less than the predetermined color threshold indicates an acceptable amount of refuse material in the furrow, wherein the color percentage being greater than the predetermined color threshold indicates an unacceptable amount of refuse material in the furrow.

In a third example of this embodiment, further comprising: determining a motion blur amount in the captured one or more images with the furrow analyzing processor operatively coupled with the imaging unit; and comparing the captured motion blur amount to a predetermined threshold; wherein the captured motion blur amount being less than the predetermined threshold indicates an acceptable amount of motion blur is present in the captured one or more images, and determining a pixel position of the ground surface with the furrow analyzing processor; wherein the captured motion blur amount being greater than the predetermined threshold indicates an unacceptable amount of motion blur is present in the captured one or more images, and activating a LED module in the illumination unit to illuminate the trench.

In a fourth example of this embodiment, further comprising: during activation of the LED module in the illumination unit, capturing one or more illumination based images of the trench with the imaging unit while the planter row unit is traveling at the vehicle velocity; wherein the determining the pixel position of the illumination baseline includes the captured one or more illumination based images.

In a fifth example of this embodiment, wherein the determining the pixel position of the illumination nadir includes the captured one or more illumination based images.

In a sixth example of this embodiment, wherein the capturing images includes capturing the images in a second exposure mode that includes opening an imaging shutter of the imaging unit one of every five frames while the projecting the active illumination is performed.

In a seventh example of this embodiment, wherein the capturing images includes capturing the images under a first exposure mode that includes capturing the projected active illumination one out of every twenty frames while the projecting the active illumination is performed.

In a ninth example of this embodiment, wherein the capturing images includes capturing the images under a third exposure mode that includes capturing the projected active illumination one out of every frames while the projecting the active illumination is performed.

In a tenth example of this embodiment, further comprising: providing an imaging apparatus assembled with the planter row unit, the imaging apparatus includes the imaging unit and the illumination unit.

According to one embodiment of the present disclosure, a method of determining an orientation of a commodity in a trench formed by a planter row unit, the planter row unit having a closing system and one or more furrow opening disks, the method comprising: projecting, with an illumination unit mounted on the planter row unit, an active illumination at an angle onto the trench in a ground surface formed by the one or more furrow opening disks, capturing one or more images of the trench with one or more imaging units mounted on the planter row unit, while the planter row unit is traveling at a vehicle velocity; inverting the captured one or more images with a furrow analyzing processor operatively coupled with the imaging unit; determining a pose parameter of one or more blobs in the inverted captured one or more images with the furrow analyzing processor; positioning a blob overlay based on the pose parameter of the one or more blobs onto the corresponding captured one or more velocity based images; and determining the orientation of the commodity in the trench using the blob overlay and the captured one or more velocity based images.

In one example of this embodiment, wherein the pose parameter corresponds to any of a triangle shape, a circular shape, or a rectangle shape.

In a second example of this embodiment, wherein the commodity is corn seed.

In a third example of this embodiment, further comprising: determining a depth from the ground surface of each commodity using the blob overlay and the captured one or more velocity based images.

In a fourth example of this embodiment, further comprising: determining a location of each commodity using the blob overlay and the captured one or more velocity based images.

In another example of this embodiment, further comprising: determining a distance between two of the blobs using the blob overlay and the captured one or more velocity based images.

In another example of this embodiment, further comprising: determining a standard deviation of an average distance between the one or more blobs using the blob overlay and the captured one or more velocity based images.

In another example of this embodiment, further comprising: displaying on a user interface the blob overlay on the captured one or more velocity based images.

In another example of this embodiment, further comprising: cropping the captured one or more images to a region of interest that includes the commodity.

In another example of this embodiment, further comprising: contrasting the cropped one or more images to black and white colors; and wherein the inverting includes the contrasted one or more images.

According to another embodiment of the present disclosure, a method of determining a furrow integrity of a trench formed by a planter row unit, the planter row unit having a closing system and one or more furrow opening disks, the method comprising: projecting, with an illumination unit mounted on the planter row unit, an active illumination at an angle onto the trench in a ground surface formed by the one or more furrow opening disks, capturing one or more images of the trench with an imaging unit mounted on the planter row unit, while the planter row unit is traveling at a vehicle velocity; contrasting the captured one or more images to black and white colors with a furrow analyzing processor operatively coupled with the imaging unit; generating one or more hough edge lines from the contrasted one or more images; filtering the one or more hough edge lines based on the proximity to a centerline of the contrasted one or more images; determining a parallelism metric amount between the filtered one or more hough edge lines; and comparing the parallelism metric amount to a predetermined threshold; and wherein the parallelism metric amount being less than the predetermined threshold indicates the furrow in the ground surface is stable; wherein the parallelism metric amount being greater than the predetermined threshold indicates the furrow in the ground surface is unstable or partially collapsed.

In one example of this embodiment, wherein the predetermined threshold is equal or less than 12 inches.

In another example of this embodiment, further comprising: providing a notification of the parallelism metric amount to a user interface assembled with the planter row unit.

According to another embodiment of the present disclosure, a method of determining a furrow integrity of a trench formed by a planter row unit, the planter row unit having a closing system and one or more furrow opening disks, the method comprising: projecting, with an illumination unit mounted on the planter row unit, an active illumination at an angle onto the trench in a ground surface formed by the one or more furrow opening disks, capturing one or more images of the trench with an imaging unit mounted on the planter row unit, while the planter row unit is traveling at a vehicle velocity; during activation of an LED module in the illumination unit, capturing one or more illumination based images of the trench with the imaging unit while the planter row unit is traveling at the vehicle velocity; determining an amount of image noise in the projected illumination in the captured one or more illumination based images; and comparing the image noise amount to a predetermined threshold; and wherein the image noise amount being less than the predetermined threshold indicates the furrow in the ground surface is stable; wherein the image noise amount being greater than the predetermined threshold indicates the furrow in the ground surface is unstable or partially collapsed.

In one example of this embodiment, further comprising: providing a notification of the image noise amount to a user interface assembled with the planter row unit.

In another example of any embodiment, wherein the imaging unit includes an IR imaging unit and the illumination unit includes an IR laser emitter.

In a refinement, further comprising: providing a lidar scanning mechanism operably coupled with the illumination unit for determining any of a cross-sectional shape, depth, and/or elevation of the trench.

In another example of any embodiment, further comprising: wherein the imaging unit includes an optical imaging unit for coordinated imaging, wherein the illumination unit includes a plurality of pulse laser lighting devices arranged to illuminate the trench from a plurality of distinct angles for synchronized illumination with the coordinated imaging from the optical imaging unit.

In a refinement, wherein the projecting with plurality of pulse laser lighting devices includes illuminating with one or more wavelengths of an electromagnetic spectrum onto the trench.

According to another embodiment of the present disclosure, a method of imaging a trench formed by a planter row unit, the planter row unit having a closing system and one or more furrow opening disks, the method comprising: projecting, with an illumination unit mounted on the planter row unit wherein the illumination unit includes a plurality of pulse laser lighting devices arranged to illuminate the trench in a ground surface from a plurality of distinct angles, the plurality of pulse laser lighting devices configured for synchronized illumination, the trench being formed by the one or more furrow opening disks; synchronizing illumination of the plurality of pulse laser lighting devices; capturing one or more images of the trench with one or more optical imagers mounted on the planter row unit, while the planter row unit is traveling at a vehicle velocity, and while coordinating the capture and/or exposure of the one or more images with a furrow analyzing processor operatively coupled with the one or more optical imagers and the illumination unit; and executing a comparative feature analysis algorithm via the furrow analyzing processor to infer one or more furrow characteristics of the trench.

In a refinement, wherein the synchronizing illumination includes triggering strobe illumination at a predetermined frame rate.

In a refinement, further comprising: a safety interlock mechanism operably coupled to the illumination unit.

According to another embodiment of the present disclosure, a method of imaging a trench formed by a planter row unit, the planter row unit having a closing system and one or more furrow opening disks, the method comprising: projecting, with an illumination unit mounted on the planter row unit wherein the illumination unit includes a plurality of laser lighting devices arranged to illuminate the trench in a ground surface from a plurality of distinct angles, the trench being formed by the one or more furrow opening disks; selectively illuminating with one or more wavelengths of an electromagnetic spectrum at a given time the trench via the plurality of laser lighting devices; capturing one or more images of the trench with a plurality of imaging devices mounted on the planter row unit, while the planter row unit is traveling at a vehicle velocity; processing the one or more images captured while the trench is illuminated under alternating wavelengths of the electromagnetic spectrum with a furrow analyzing processor operatively coupled with the plurality of imaging devices and the illumination unit; and executing a comparative feature analysis algorithm via the furrow analyzing processor to infer one or more furrow characteristics of the trench.

In a refinement, wherein the plurality of lighting devices include pulsed illumination devices across a broadband range of the electromagnetic spectrum.

In a refinement, further comprising: a safety interlock mechanism operably coupled to the illumination unit.

In a refinement, wherein one or more of the plurality of laser lighting devices provides illumination at a first wavelength; wherein one or more of the plurality of laser lighting devices provides broadband illumination; and sequencing illumination of the plurality of laser lighting devices between the first wavelength and the broadband illumination.

In a refinement, wherein the illumination sequence continues at each instance of illumination providing one or more electromagnetic spectrum wavelengths for illumination of the trench.

According to another embodiment of the present disclosure, a method of imaging a trench formed by a planter row unit, the planter row unit having a closing system and one or more furrow opening disks, the method comprising: projecting, with an illumination unit mounted on the planter row unit wherein the illumination unit includes a plurality of illumination devices arranged to illuminate the trench in a ground surface from a plurality of distinct angles, the trench being formed by the one or more furrow opening disks; illuminating the trench via the plurality of illumination devices; capturing one or more images of the trench with an imaging unit mounted on the planter row unit, while the planter row unit is traveling at a vehicle velocity; synchronizing the one or more images with one or more sensors for image analysis with a furrow analyzing processor operably coupled to the plurality of illumination devices and the imaging unit; and processing the one or more images captured while the trench is illuminated with the furrow analyzing processor.

In another example of this embodiment, wherein the plurality of illumination devices provide one or more of edge source illumination, line source illumination, point source illumination, diffused source illumination, and/or two or more axial illuminations.

In another example of any of these embodiments, further comprising: one or more applicator devices operably coupled to the furrow analyzing processor, wherein the furrow analyzing processor is configured to operate the one or more applicator devices to expel fluid material in one or more directions and to a plurality of locations within the trench based at least on an identified seed location in the one or more captured images. In one refinement, further comprising: generating a trigger signal by the furrow analyzing processor based on one or more of the identified seed location in the captured image, a soil characteristic determined from the captured image, or a pest identified in the captured image; and triggering the one or more applicator devices when an applicator control module receives the trigger signal. In one refinement, the plurality of locations within the trench is based at least on one or more of a furrow and seed image data/models and a vehicle parameter.

According to another embodiment of the present disclosure, a method of detecting one or more furrow characteristics of a trench formed by a planter row unit, the planter row unit having a closing system and one or more furrow opening disks, the method comprising: providing an illumination unit mounted on the planter row unit, wherein the illumination unit includes an LED module, a laser module, and an imaging unit; projecting with the laser module an active illumination at an angle onto the trench in a ground surface formed by the one or more furrow opening disks while the planter row unit is traveling at a vehicle velocity; during de-activation of the LED module, capturing one or more non-illumination based images of the trench with the imaging unit; displaying the one or more captured non-illumination based images on a graphical user interface operably coupled with the illumination unit; and determining one or more furrow characteristics from the projected illumination in the captured one or more non-illumination based images displayed on the graphical user interface.

In one example of this embodiment, further comprising: during activation of the LED module, capturing one or more illumination based images of the trench with the imaging unit; and alternatively displaying the one or more captured illumination based images or the one or more captured non-illumination based images on the graphical user interface.

In another example of this embodiment, further comprising: determining, from the one or more furrow characteristics, one or more operational parameters of the planter row unit for adjustment of the planter row unit. In one refinement, wherein the determining step is performed by a vehicle controller operably coupled with the imaging unit. In another refinement, wherein the determining step is performed by an operator of the planter row unit. In another refinement, further comprising: adjusting the one or more operational parameters of the planter row unit based on the one or more furrow characteristics. In another refinement further comprising: displaying the one or more furrow characteristics on the graphical user interface. In another refinement further comprising: displaying the one or more operational parameters on the graphical user interface.

In another example of this embodiment, wherein the alternatively displaying is determined by a vehicle controller operably coupled with the imaging unit.

In another example of this embodiment, wherein the one or more furrow characteristics include any of a trench depth, a commodity depth, a three-dimensional trench profile, a trench integrity, a trench formation quality, a speed optimization of the planter, a productivity score, a commodity planting rate, a commodity orientation, a commodity spacing, a residue optimization, and/or a seed to soil contact ratio.

According to another embodiment of the present disclosure, a method of detecting one or more furrow characteristics of a trench formed by a planter row unit, the planter row unit having a closing system and one or more furrow opening disks, the method comprising: providing an illumination unit mounted on the planter row unit, wherein the illumination unit includes a cast illumination module, a laser module, and an imaging unit; projecting with the laser module an active illumination at an angle onto the trench in a ground surface formed by the one or more furrow opening disks while the planter row unit is traveling at a vehicle velocity; during de-activation of the cast illumination module, capturing one or more non-illumination based images of the trench with the imaging unit; during activation of the cast illumination module, capturing one or more illumination based images of the trench with the imaging unit; determining one or more furrow characteristics from the projected illumination in the captured one or more non-illumination based images; and based on the one or more furrow characteristics, determining whether the one or more captured illumination based images or the one or more captured non-illumination based images is displayed on a graphical user interface operably coupled with the illumination unit.

In one example of this embodiment, further comprising: determining, from the one or more furrow characteristics, one or more operational parameters of the planter row unit for adjustment of the planter row unit. In one refinement, wherein the determining step is performed by a vehicle controller operably coupled with the imaging unit. In another refinement, wherein the determining step is performed by an operator of the planter row unit. In another refinement, wherein the one or more operational parameters includes any of an amount of downforce applied by the one or gauge wheels, a depth adjustment of the furrow opening disks, or adjustment of the closing system.

In one example of this embodiment, wherein the one or more furrow characteristics include any of a trench depth, a commodity depth, a three-dimensional trench profile, a trench integrity, a trench formation quality, a speed optimization of the planter, a productivity score, a commodity planting rate, a commodity orientation, a commodity spacing, a residue optimization, and/or a seed to soil contact ratio.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a side view of a visualization system mounted on a planter row unit;

FIG. 2 is a side view of the visualization system mounted on the planter row unit of FIG. 1;

FIG. 3 is an image that is projected by a structured light unit of the visualization system of FIG. 1;

FIG. 4 is a cross-sectional view of an ideal trench profile and an actual or measured trench profile as determined by the visualization system of FIG. 1;

FIG. 5 is a procedure to determine a three-dimensional measured trench profile from a two-dimensional measured trench profile of the FIG. 1 embodiment;

FIG. 6 is a side view of one embodiment of a shield attached to a planter row unit;

FIG. 7 is a partial top perspective view of the shield illustrated in FIG. 6 attached to the planter row unit in a position to engage a furrow;

FIG. 8 is a partial side perspective view of the shield illustrated in FIG. 6 attached to the planter row unit without a furrow opening disk attached thereto for clarity;

FIG. 9 is a partial side perspective view of the shield illustrated in FIG. 6 attached to the planter row unit with the furrow opening disk illustrated in dashed lines;

FIG. 10 is a partial cross-sectional top perspective view of the shield illustrated in FIG. 6 attached to the planter row unit with a furrow opening disk;

FIG. 11 is a side view of an alternative embodiment of a shield attached to a planter row unit;

FIG. 12 is a side view of the shield illustrated in FIG. 6;

FIG. 13 is a rear view of the shield illustrated in FIG. 12;

FIG. 14 is a partial view of the shield illustrated in FIG. 6 mounted to the planter row unit wherein the shield is in a first configuration that is closer to a ground surface;

FIG. 15 is a partial view of the shield illustrated in FIG. 6 mounted to the planter row unit wherein the shield is in a second configuration that is farther away from a ground surface;

FIG. 16 is a partial cross-sectional view of the shields illustrated in FIG. 6 configured to extend a penetration distance PD into an actual trench in a ground surface;

FIG. 17 is a partial perspective view of the shield illustrated in FIG. 16 mounted to the planter row unit;

FIG. 18 is a side view of the shield illustrated in FIG. 6 mounted to the planter row unit wherein one of the closing wheels of the planter row unit is not illustrated for clarity to illustrate attachment of the shield to the planter row unit in an exemplary configuration;

FIG. 19a is an exploded view of another embodiment of a shield;

FIG. 19b is a view of an extension piece that can be assembled with the shield illustrated in FIG. 19a;

FIG. 20 is a side view of the shield illustrated in FIG. 19a and the extension piece illustrated in FIG. 19b assembled with the planter row unit in a first configuration;

FIG. 21 is a side view of the shield illustrated in FIG. 19a and the extension piece illustrated in FIG. 19b assembled with the planter row unit in a second configuration;

FIG. 22 is a side perspective partial view of the shield illustrated in FIG. 19a and another embodiment of the extension piece.

FIG. 23 is a side perspective view of another embodiment of a shield attached to the planter row unit in a first configuration;

FIG. 24 is a side perspective view of the shield attached to the planter row unit from FIG. 23 in a second configuration;

FIG. 25 is a side view of the shield from FIG. 23;

FIG. 26 is a side view of the shield assembled to the planter row unit from FIG. 6 in one configuration;

FIG. 27 is a side partial view of the shield assembled to the planter row unit from FIG. 6 in a second configuration;

FIG. 28 is a side view of the shield assembled to the planter row unit from FIG. 6 in a third configuration;

FIG. 29 is a side view of the shield assembled to the planter row unit from FIG. 6 in a fourth configuration;

FIG. 30 is a rear view of a planter with a plurality of embodiments of the shield assembled to the planter row units from FIG. 6;

FIG. 31 is a partial perspective view of another embodiment of a shield assembled to the planter row unit from FIG. 6;

FIG. 32 is a camera field of view of a furrow by the visualization system of FIG. 1;

FIG. 33 is a camera field of view of a furrow by the visualization system of FIG. 1 and shield illustrated in FIG. 6 mounted to the planter row unit;

FIG. 34 is a camera field of view of a furrow by the visualization system of FIG. 1 and shield illustrated in FIG. 6 mounted to the planter row unit;

FIG. 35 is a camera field of view of a furrow by the visualization system of FIG. 1 and shield illustrated in FIG. 6 mounted to the planter row unit;

FIG. 36 is a schematic of a partial cross-sectional view of the pair of furrow opening disks of planter row unit illustrated in FIG. 6 to illustrate a first shield angle;

FIG. 37 is a schematic of a partial cross-sectional view of the shields attached to the planter row unit illustrated in FIG. 6 to illustrate a disk angle;

FIG. 38 is a schematic of a partial cross-sectional view of the pair of furrow opening disks of planter row unit illustrated in FIG. 9 to illustrate a second shield angle;

FIG. 39 is a schematic of a partial cross-sectional view of the shields attached to the planter row unit illustrated in FIG. 9 to illustrate a second disk angle;

FIG. 40 is a schematic of a partial cross-sectional view of the shields attached to the planter row unit;

FIG. 41 is a schematic of a partial cross-sectional view of the shields attached to the planter row unit;

FIG. 42 is a schematic of a partial cross-sectional view of the shields attached to the planter row unit;

FIG. 43 is a schematic of a partial cross-sectional view of the shields attached to the planter row unit;

FIG. 44 is a schematic of a partial cross-sectional view of the shields attached to the planter row unit; and

FIG. 45 is a schematic of a partial cross-sectional view of the shields attached to the planter row unit.

FIG. 46 is a schematic view of an imaging system for assembly with the planter row unit;

FIG. 47 is a side view of an imaging apparatus of the imaging system of FIG. 46 assembled on the planter row unit;

FIG. 48 is a partial side view of the imaging apparatus and the planter row unit of FIG. 47;

FIG. 49 is a first exemplary illustration of an illumination unit and an imaging unit of the imaging apparatus of FIG. 6;

FIG. 50 is a second exemplary illustration of an illumination unit and an imaging unit of the imaging apparatus of FIG. 46;

FIG. 51 is an illustrative example of a scene that is expected to be captured by the imaging system of FIG. 46;

FIG. 52 is an exemplary image captured by the imaging system of FIG. 46;

FIG. 53 is an isometric view of an embodiment of an imaging apparatus for assembly with the planter row unit;

FIGS. 54 and 55 are opposing side views respectively of an outer portion of the imaging apparatus of FIG. 53;

FIGS. 56 and 57 are front and back views, respectively, of an outer portion of an embodiment of the imaging apparatus of FIG. 53;

FIGS. 58 and 59 are top (vehicle facing) and bottom (soil facing) views, respectively, of an outer portion of the imaging apparatus of FIG. 53;

FIGS. 60 and 61 respectively are isometric angled views of an exploded configuration of the imaging apparatus of FIG. 53;

FIG. 62 is a side view of the imaging apparatus of FIG. 53 in an exploded configuration and the planter row unit;

FIG. 63 is a side view of the imaging apparatus of FIG. 53 in an exploded configuration;

FIG. 64 illustrates a depth detection submodule executed by a furrow analyzing processor of an imaging apparatus;

FIG. 65 illustrates a seed placement determination submodule executed by a furrow analyzing processor of an imaging apparatus;

FIG. 66 illustrates a furrow integrity submodule executed by a furrow analyzing processor of an imaging apparatus;

FIG. 67 illustrates a furrow refuse characterization submodule executed by a furrow analyzing processor of an imaging apparatus;

FIG. 68 is a side perspective view of an alternative embodiment of an imaging apparatus and a partial view of the planter row unit;

FIG. 69 is another side perspective view of the alternative embodiment of the imaging apparatus and the partial view of the planter row unit of FIG. 67;

FIG. 70 is another embodiment of an imaging system that is coupled to a planter row unit (not illustrated);

FIG. 71 illustrates a captured image as displayed on a graphical user interface wherein the captured image includes an actual furrow in a ground surface, and cast illumination and targeted illumination from the imaging system of FIG. 70;

FIG. 72 illustrates the captured image from FIG. 71 without the cast illumination; and

FIG. 73 is another cross-sectional view of an ideal trench profile and an actual or measured trench profile as determined by the visualization system of FIG. 1.

Corresponding reference numerals are used to indicate corresponding parts throughout the several views.

### DETAILED DESCRIPTION

The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure.

Some of the benefits of the present disclosure include measuring and visualizing a three dimensional (3D) geometric shape of a seed trench created by a planter row unit while the planter row unit is forming the seed trench. Other benefits of the present disclosure include measuring a depth of the seed trench, measuring a depth of a seed or commodity placed in the seed trench, and determining a seed trench quality. The present disclosure utilizes a camera and a structured light unit that are each attached to the planter row unit. The structured light unit projects a known or patterned shape of light, such as lines, dots or other shapes onto the camera's field of view. The present disclosure utilizes various type of structured light patterns for measuring three-dimensional geometric features of the trench, some examples include but are not limited to, a single point projection to a trench bottom for determining a trench depth, a single line projection for measuring cross-section of the trench as well as the trench depth, and an area projection such as multiple lines, grids, or stripes for measuring a section of the trench and the trench depth at various points within the measured section. Based on the geometric relationship between the camera and the structured light unit, a three-dimensional or 3D location of the projected light is measured. The spectrum of the structured light unit could be in the visible range for a visible range camera such as a color camera, or the spectrum of the structured light unit could be in the near infrared (NIR), infrared (IR) or other non-visible range for better visibility in a challenging condition such as when the planter row unit is operable in a dusty, rainy, foggy, or other visually difficult situation. The structured light unit can be used together with a flood light to capture visual context of the trench as well. The structured light unit and flood light can be turned on/off alternatively so that each image is captured with either one of the lights. Even without 3D reconstruction of the trench, visualization of structured light unit in the trench image could be used as visual indicator of trench shape.

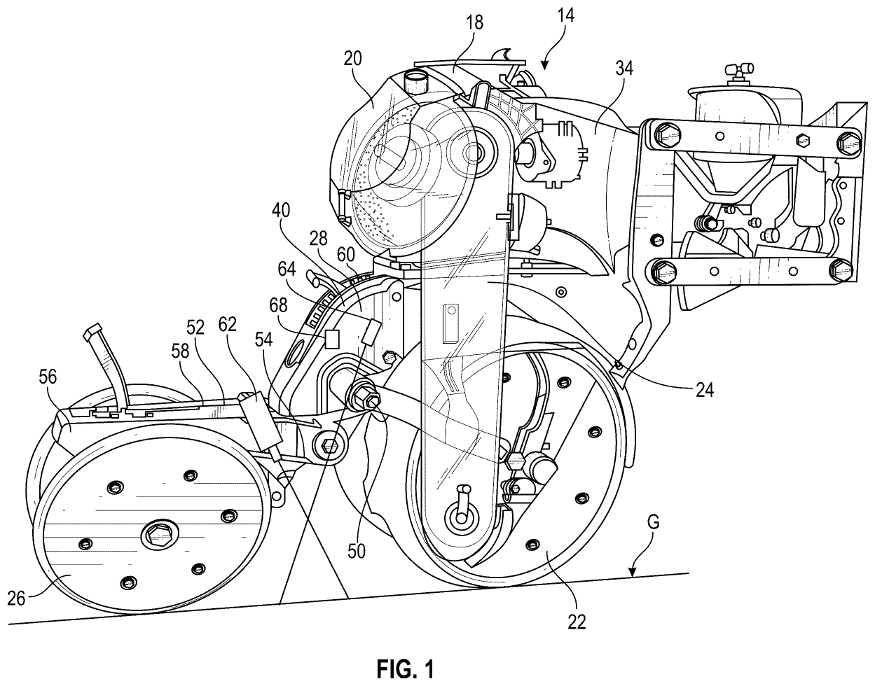

Referring now to FIG. 1 of the present disclosure, an embodiment of a planter row unit 14 is connected to an agricultural work machine (not illustrated) such as a planter or seeder. The planter row unit 14 is an illustrative embodiment wherein other embodiments of planter row units can be used with the present disclosure. In FIG. 1, only a single planter row unit 14 is shown, but a plurality of planter row units 14 may be coupled to a frame of the agricultural work machine in any known manner. The planter row unit 14 may be coupled to the frame by a linkage (not illustrated) so that the planter row unit 14 can move up and down to a limited degree relative to the frame.

Each planter row unit 14 may include an auxiliary or secondary hopper 18 for holding product such as fertilizer, seed, chemical, or any other known product or commodity. In this embodiment, the secondary hopper 18 may hold seed. As such, a seed meter 20 is shown for metering seed received from the secondary seed hopper 18. A furrow opener or furrow opening disk 22 may be provided on the planter row unit 14 for forming a furrow or trench in a field for receiving metered seed (or other product) from the seed meter 20. The seed or other product may be transferred to the trench from the seed meter 20 by a seed delivery system 24. In one embodiment, a closing system or closing wheel 26 may be coupled to each planter row unit 14 and is used to close the furrow or trench with the seed or other product contained therein. The closing system includes a closing wheel but in other embodiments the closing system can include closing disks, closing tires, and/or drag chains to name a few examples.

In one embodiment, the seed meter 20 is a vacuum seed meter, although in alternative embodiments other types of seed meters using mechanical assemblies or positive air pressure may also be used for metering seed or other product. As described above, the present disclosure is not solely limited to dispensing seed. Rather, the principles and teachings of the present disclosure may also be used to apply non-seed products to the field. For seed and non-seed products, the planter row unit 14 may be considered an application unit with a secondary hopper 18 for holding product, a product meter for metering product received from the secondary hopper 18 and an applicator for applying the metered product to a field. For example, a dry chemical fertilizer or pesticide may be directed to the secondary hopper 18 and metered by the product meter 20 and applied to the field by the applicator.

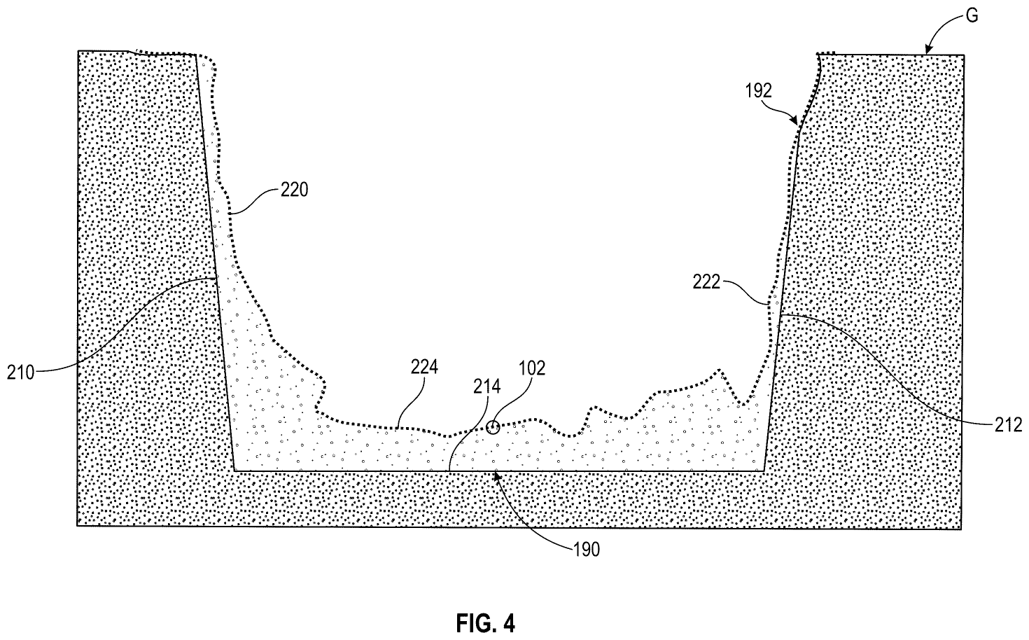

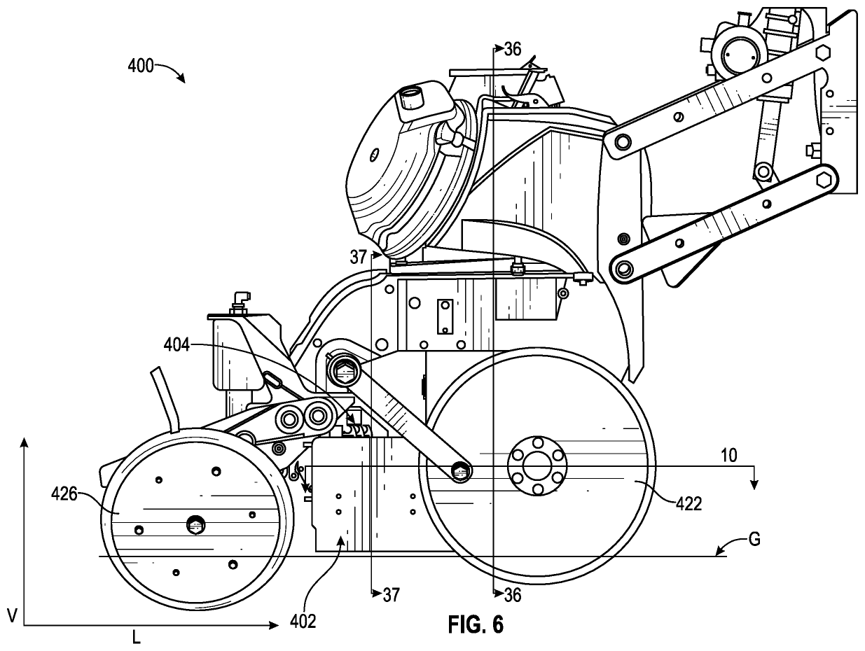

The planter row unit 14 includes a shank 40. The shank 40 is coupled to a closing wheel frame 52. The closing wheel frame 52 has a pivot end 54 that is pivotably connected to a pivot 49 and an opposite end 56 with a body portion 58 that spans between the pivot end 54 and the opposite end 56. The planter row unit 14 includes a pair of furrow opening disks 22 rotatably mounted on the shank 40 and a pair of closing wheels 26 rotatably mounted on the closing wheel frame 52. The planter row unit 14 can also include a pair of gauge wheels but those are not illustrated. The pair of furrow opening disks 22 form an actual trench or furrow 192 in the field or in a ground surface G during operation of the planter row unit 14. Alternatively, other opening devices can be used in place of the pair of furrow opening disks 22. The actual trench 192 has a trapezoidal cross-sectional shape or profile that is illustrated in FIG. 4. The actual trench 192 can have other cross-sectional shapes such as a V shape as illustrated in FIG. 6. In yet another embodiment, the actual trench 192 can have other cross-sectional shapes such as a rectangular or semi-circular shape. The pair of closing wheels 26 close or cover the actual trench or furrow 192 with displaced soil that occurs from the pair of furrow opening disks 22 opening or forming the trench 192 in the ground surface G. Alternatively, other closing devices can be used in place of the pair of closing wheels 26.

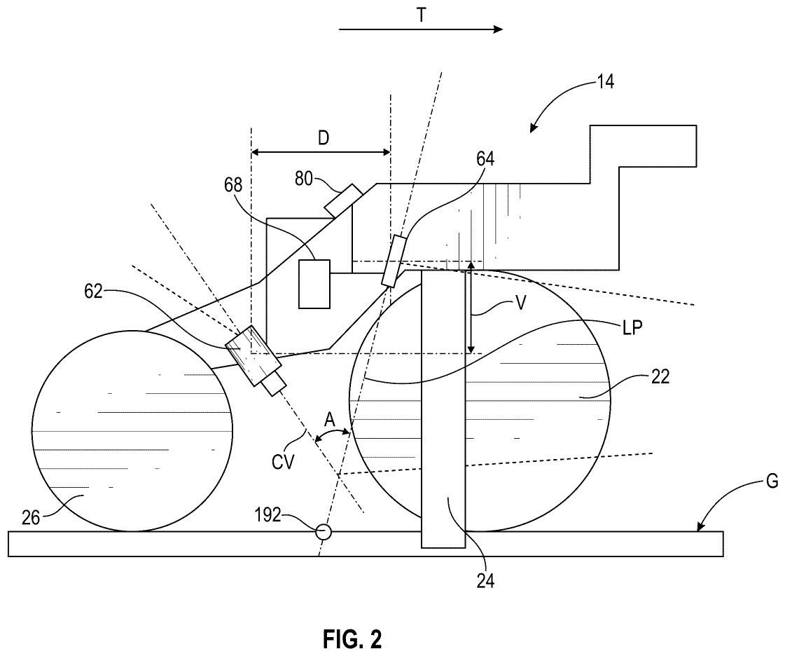

A visualization system 60 is operably connected and mounted to the planter row unit 14 as illustrated in FIGS. 1 and 2. The visualization system 60 includes a camera or imaging unit 62 and a structured light unit 64 wherein the camera or imaging unit 62 is laterally or horizontally offset a distance D from the structured light unit 64. In the illustrated embodiment, the camera or imaging unit 62 is vertically offset a distance V from the structured light unit 64. In one embodiment, the horizontal and vertical distances D and V are very small such that the camera or imaging unit 62 and the structured light unit 64 are very close to one another and can be assembled in a visualization kit that includes a package or container that holds the camera or imaging unit 62 and the structured light unit 64 that is mounted on the planter row unit 14. In other embodiments, the camera or imaging unit 62 is not vertically offset from the structured light unit 64 such that V is zero distance. In the illustrated embodiment in FIG. 2, the camera or imaging unit 62 has a principle optical axis CV that intersects with a light plane LP from the structured light unit 64 to form an angle A there between. The angle A can be less than 90 degrees, 90 degrees, or an obtuse angle. In other embodiments, the camera or imaging unit 62 is oriented such that the principle optical axis CV is close to the actual trench 192 or may be oriented towards the closing wheels 26. In any embodiment, the principle optical axis CV of the camera or imaging unit 62 may or may not intersect the light plane LP from the structured light unit 64. The principle optical axis CV is along a centerline of a field of view of the camera or imaging unit 62. In any of these embodiments, the field of view of the camera or imaging unit 62 is arranged to capture images of the patterned light from the structured light unit 64 that intersects with the actual trench 192 at the ground surface G.

Although one camera or imaging unit 62 is illustrated, additional cameras 62 can be used with the structured light unit 64. The camera or imaging unit 62 is mounted between the pair of closing wheels 26 and the pair of furrow opening disks 22 or alternatively the camera or imaging unit 62 is mounted between the pair of closing wheels 26 and the seed delivery system 24. The structured light unit 64 is also mounted between the pair of closing wheels 26 and the pair of furrow opening disks 22 or alternatively the structured light unit 64 is mounted between the pair of closing wheels 26 and the seed delivery system 24. In the illustrated embodiment, the camera or imaging unit 62 is positioned close to the pair of closing wheels 26 and the structured light unit 64 is positioned close to the seed delivery system 24 and/or the pair of furrow opening disks 22. In other embodiments, the structured light unit 64 is positioned close to the pair of closing wheels 26 and the camera or imaging unit 62 is positioned close to the seed delivery system 24 and the pair of furrow opening disks 22.

In some embodiments, the visualization system 60 includes a general illumination light 68 mounted to the planter row unit 14. The general illumination light 68 can include one or more light emitting diodes (LED) or broad-beamed, high intensity artificial light. The general illumination light 68 can illuminate the actual trench 192 to help capture the visual context of the actual trench 192 by the camera or imaging unit 62. The general illumination light 68 can be used with the structured light unit 64. Imaging by the camera or imaging unit 62 can be performed with alternating light sources such that the structured light unit 64 is operable while the general illumination light 68 is non-operable, and vice versa wherein the structured light unit 64 is non-operable while the general illumination light 68 is operable. Non-operation of the general illumination light 68 during operation of the structured light unit 64 enables the camera or imaging unit 62 to capture a 2D image where the pattern created by the structured light unit 64 stands out significantly from the rest of the background. Non-operation of the structured light unit 64 during operation of the general illumination light 68 enables the camera or imaging unit 62 to capture a better image of the visual context of the actual trench 192 by the camera or imaging unit 62. Alternatively, the general illumination light 68 and the structured light unit 64 can be operational together. For example, the structured light unit 64 is activated while the camera or imaging unit 62 captures images however the general illumination light 68 is not operational for every image that is captured by the camera or imaging unit 62. As a further example, the general illumination light 68 can be operational for some of the images that are captured and non-operational for other of the images that are captured by the camera or imaging unit 62. The general illumination light 68 is placed between the pair of closing wheels 26 and the pair of furrow opening disks 22. The general illumination light 68 can alternatively be mounted or combined with the camera or imaging unit 62. The general illumination light 68 can be placed under the shank 40 or under the closing wheel frame 52. The general illumination light 68 can be placed anywhere on the planter row unit 14 to illuminate a field of view of the camera or imaging unit 62.

In any embodiment, the camera or imaging unit 62 is oriented to point down towards the ground surface G at the actual trench 192 that is formed by the pair of furrow opening disks 22. The camera or imaging unit 62 also points down toward the projected light from the structured light unit 64 at the trench 192 in the ground surface G. The structured light unit 64 projects a narrow band of light across the actual trench 192 to produce a line of illumination or patterned light and can be used for an exact geometric reconstruction of the surface shape or cross-section of the actual trench 192. The structured light unit 64 points towards the ground surface G and the actual trench 192 formed therein. In any embodiment, the structured light unit 64 and the camera or imaging unit 62 are accurately calibrated relative to each other so that 3D locations of the actual trench 192 can be recovered by triangulation as explained in more detail below.

The structured light unit 64 includes a single laser or single light source that projects a single line, multiple lines, grids, stripes, one or more dots or point projections, cross, triangle, or other known pattern of light, collectively “patterned light” on the trench in the ground surface G. Alternatively, the structured light unit 64 can include multiple lasers or light sources. For example, the structured light unit 64 can emit a single point projection to a trench bottom for determining a trench depth. As another example, the structured light unit 64 can emit a single line projection for measuring cross-section of the trench as well as the trench depth. As yet another example, the structured light unit 64 can emit an area projection such as multiple lines, grids, or stripes for measuring a section of the trench and the trench depth at various points within the measured section. In one embodiment, a slit in a light cover can be positioned in front of the structured light unit 64 to thereby project multiple lines on the trench 192 to provide additional points, mesh, or an area of 3D points to perform a multiple cross sectional measurement. Multiple lines may be beneficial in a dusty environment to increase the potential to obtain a good trench profile. The structured light unit 64 can also pass through a digital spatial light modulator to form a pattern with regular and equidistant stripes of light on the trench 192. In one embodiment, projection by the structured light unit 64 of a single line is beneficial because the planter row unit 14 moves towards the direction of laser scanning T so additional scanning of cross sectional measurements is compiled or accumulated to reconstruct a large section or length of the actual trench 192. The movement of the planter row unit 14 enables a controller 80 to accumulate many single cross sections of the actual trench 192 to reconstruct a large section or length of the actual trench 192. In one embodiment, the structured light unit 64 is a green light but in other embodiments the structured light unit 64 can be another colored light such as blue or a white light. If the structured light unit 64 is configured as a colored light, then the camera or imaging unit 62 is a color or monochrome camera. Alternatively, the structured light unit 64 can be a near-infrared (NIR), infrared (IR), or other non-visible range for better visibility in challenging or obstructive environmental conditions such as dust, fog, or haze wherein the NIR or IR light is used with the camera or imaging unit 62 being infrared or near-infrared. As such, the camera or imaging unit 62 and the structured light unit 64 can be operated in the visible spectrum range, or outside of the visible spectrum range such as infrared range in order to have better air obscurant penetration such as dust penetration. While the actual trench 192 is formed by the furrow opening disks 22, soil and dust can fill or permeate the air so it is difficult for the operator or a conventional color camera to capture the actual trench 192 cross-sectional shape. A near infrared camera or imaging unit 62 can be used in dusty or visibly challenging environments to improve the visualization of the 2D plane that is projected by the structured light unit 64.

In certain embodiments, the visualization system 60 includes or is operatively connected to a controller 80 structured to perform certain operations to control the camera or imaging unit 62, the structured light unit 64, and the general illumination light 68. The controller 80 can be placed anywhere on the planter row unit 14, the planter, a tractor, or any work machine that may be connected to or capable of performing one or more planting operations. In certain embodiments, the camera or imaging unit 62 includes the controller 80. In certain embodiments, the controller 80 forms a portion of a processing subsystem including one or more computing devices having memory, processing, and communication hardware. The controller 80 may be a single device or a distributed device, and the functions of the controller 80 may be performed by hardware or by instructions encoded on computer readable medium. The controller 80 may be included within, partially included within, or completely separated from other controllers (not shown) associated with the work machine and/or the visualization system 60. The controller 80 is in communication with any sensor or other apparatus throughout the visualization system 60, including through direct communication, communication over a datalink, and/or through communication with other controllers or portions of the processing subsystem that provide sensor and/or other information to the controller 80.

In certain embodiments, the controller 80 is described as functionally executing certain operations. The descriptions herein including the controller operations emphasizes the structural independence of the controller, and illustrates one grouping of operations and responsibilities of the controller. Other groupings that execute similar overall operations are understood within the scope of the present application. Aspects of the controller may be implemented in hardware and/or by a computer executing instructions stored in non-transient memory on one or more computer readable media, and the controller may be distributed across various hardware or computer based components.

Example and non-limiting controller implementation elements include sensors providing any value determined herein, sensors providing any value that is a precursor to a value determined herein, datalink and/or network hardware including communication chips, oscillating crystals, communication links, cables, twisted pair wiring, coaxial wiring, shielded wiring, transmitters, receivers, and/or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), and/or digital control elements.

The listing herein of specific implementation elements is not limiting, and any implementation element for any controller described herein that would be understood by one of skill in the art is contemplated herein. The controllers herein, once the operations are described, are capable of numerous hardware and/or computer based implementations, many of the specific implementations of which involve mechanical steps for one of skill in the art having the benefit of the disclosures herein and the understanding of the operations of the controllers provided by the present disclosure.

One of skill in the art, having the benefit of the disclosures herein, will recognize that the controllers, control systems and control methods disclosed herein are structured to perform operations that improve various technologies and provide improvements in various technological fields. Certain operations described herein include operations to interpret one or more parameters. Interpreting, as utilized herein, includes receiving values by any method known in the art, including at least receiving values from a datalink or network communication, receiving an electronic signal (e.g. a voltage, frequency, current, or PWM signal) indicative of the value, receiving a software parameter indicative of the value, reading the value from a memory location on a non-transient computer readable storage medium, receiving the value as a run-time parameter by any means known in the art, and/or by receiving a value by which the interpreted parameter can be calculated, and/or by referencing a default value that is interpreted to be the parameter value.

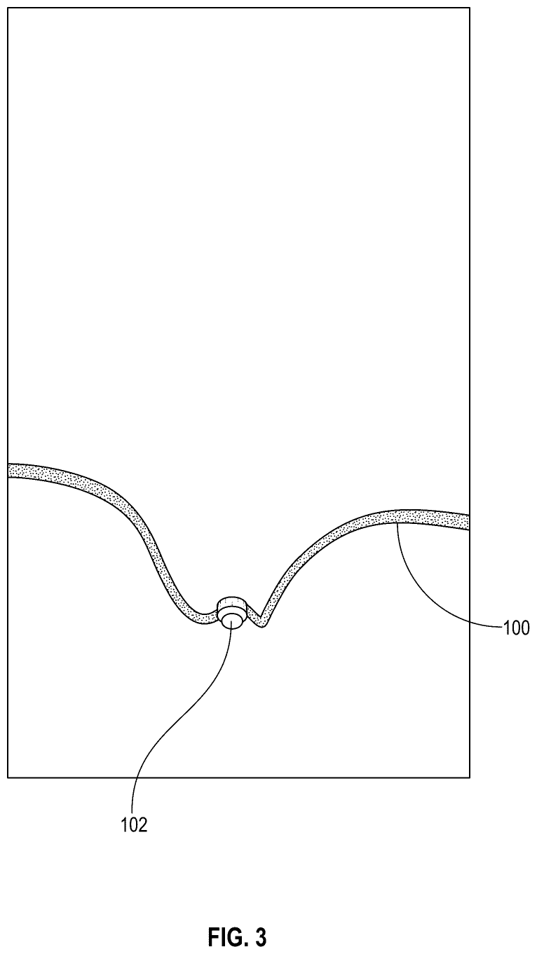

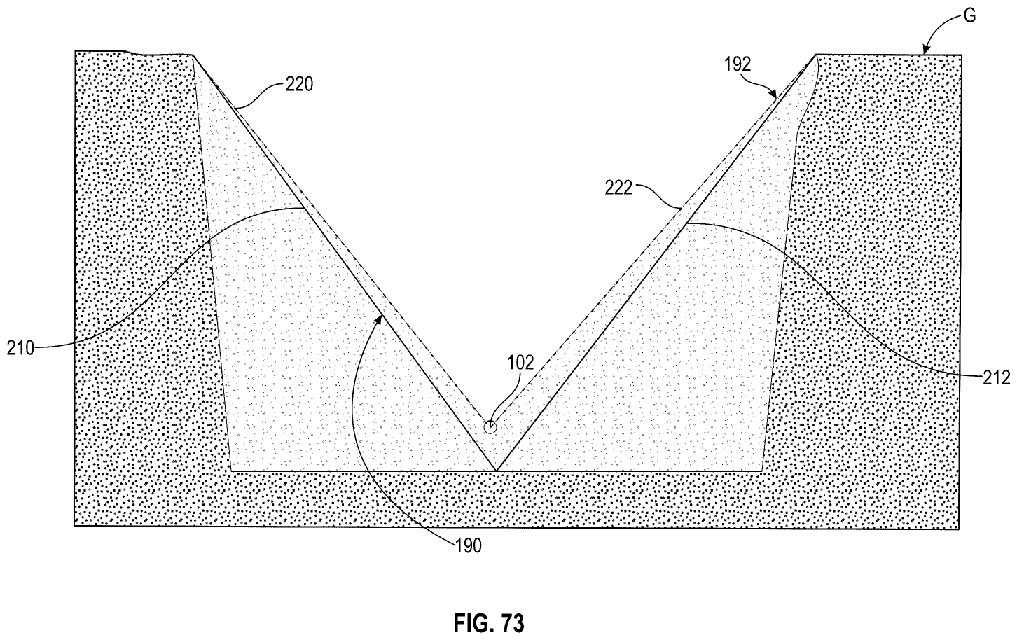

Measurement of the actual trench profile 192 will now be described by measuring the three-dimensional (3D) location of the laser points or patterned light of an image 100 that is projected by the structured light unit 64 as illustrated in FIG. 3. In one form, the measurement of the actual trench 192 is determined by using structured-light based sensing. In the embodiment wherein the structured light unit 64 projects a single line laser, the structured light unit 64 emits patterned light (see FIG. 2) toward the ground surface G, and the image 100 illustrated as a line (see FIG. 3) is the intersection of the laser plane LP and the actual trench 192 in the ground surface G. The image 100 is a single line in FIG. 3, but more complicated patterns such as multiple lines, grids, or dots, or any type of patterned light previously discussed could be used in order to have more or less 3D points. The camera or imaging unit 62 captures the image 100 of the trench with the projected patterned light. The geometric relationship between the laser or light plane LP projected by the structured light unit 64 and the principle optical axis CV of the camera or imaging unit 62 is determined by the location and orientation of the camera or imaging unit 62 and the structured light unit 64 relative to each other, therefore the 3D location of the laser line pixels in the image 100 is determined. After the 3D location of the laser line pixels are determined, a 3D point cloud of the actual trench profile 192 is generated as an actual 3D trench profile 192. The actual 3D trench profile 192 over multiple images can be accumulated for reconstructing a large section of the measured trench profile 192. The depth, width and other geometric features of the trench are computed based on 3D measurement (point-cloud) and used for determining the quality of the trench formed by the pair of furrow opening disks 22 as illustrated in FIGS. 4 and 73.

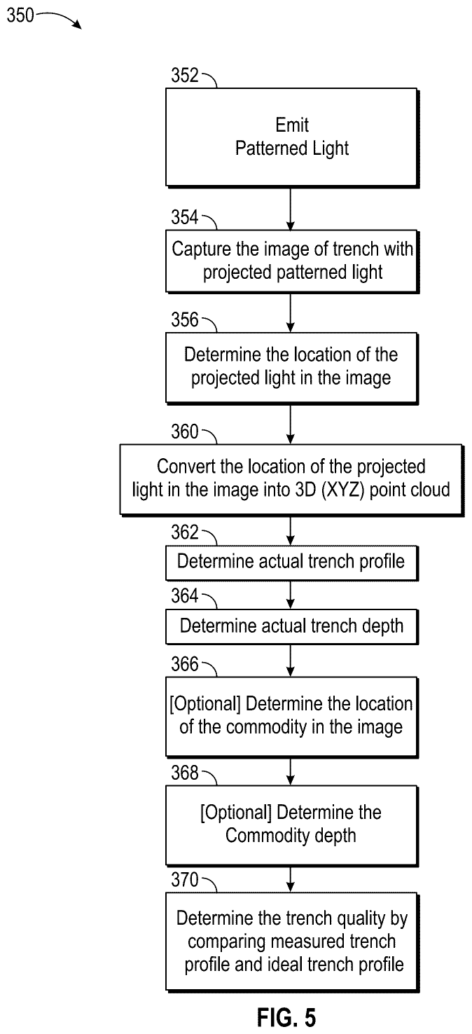

Certain systems are described and include examples of controller operations in various contexts of the present disclosure. In certain embodiments, such as procedure 350 shown in FIG. 5, the structured light unit 64 emits the patterned light toward the ground surface G at an operation 352 that includes the image 100 illustrated as a line is the intersection of the emitted patterned light or laser plane LP and the actual trench in the ground surface G. The camera or imaging unit 62 captures the emitted patterned light or the light plane LP from the structured light unit 64 such that the camera or imaging unit 62 captures the image 100 of the trench with the projected patterned light at an operation 354. As discussed previously, the emitted patterned light includes a single line, multiple lines, grids, stripes, one or more dots or point projections, cross, triangle, or other known pattern of light, which corresponds to the projected patterned light that is captured in the image 100 at operation 354. Next, the controller 80 is operable to determine the location of the projected light in the image 100 (2D or two-dimensional space) at operation 356. The controller 80 is operable to determine the location of the projected light in 3D coordinates (3D or three-dimensional space) or 3D point cloud at operation 360. In one embodiment, at operation 362, the controller 80 is further operable to determine an actual 3D trench profile 192 from the 3D location of the actual trench 192 from step 360. The controller 80 is operable to interpret the 3D location of the laser line pixels in the image 100 at operation 360 to determine the actual or measured trench profile 192 in operation 362. In procedure 350, the operation or step 362 may or may not be performed and the procedure 350 continues to operation or step 364. As such, operation or step 362 is not necessary for operation 364 to be performed. At operation 364, the controller 80 is further operable to determine an actual trench depth that is determined from the operation 360. In operation 364, any of the emitted patterned light types can be used in operation 360 and 364 to determine the actual trench depth. Optionally, procedure 350 continues to operation 366 wherein the controller 80 is further operable to determine a location of the seed or commodity 102 in the image 100 (2D). Optionally, procedure 350 continues to operation 368 wherein the controller 80 is further operable to determine the actual seed depth from the location of the seed 102 in the image 100. Optionally, at operation 368 the controller 80 can determine the actual seed depth from the actual 3D trench profile 192. In some embodiments, the controller 80 is further operable to accumulate or reconstruct using multiple images of the 3D point cloud of the actual 3D trench profile 192. At operation 370, the controller 80 is further operable to determine the trench quality by comparing the actual or measured trench profile 192 and an ideal trench profile 190.

Turning now to FIG. 4, a comparison of an ideal trench profile 190 and an actual or measured trench profile 192 are illustrated. The ideal trench profile 190 includes a first trench wall 210, a second trench wall 212, and a trench floor 214 that spans between the first and second trench walls 210 and 212, respectively. The actual or measured trench profile 192 includes a first trench wall 220, a second trench wall 222, and a trench floor 224 that spans between the first and second trench walls 220 and 222, respectively. It is preferable that the measured trench profile 192 matches the ideal trench profile 190 but will vary due to the various characteristics of the soil as well as the operating condition of the planter row unit 14 and the pair of furrow opening disks 22. The ideal trench profile 190 is a U shape and the actual or measured trench profile 192 also has a somewhat U shape. In other embodiments, cither or both of the ideal and measured trench profiles 190 and 192, respectively, of the furrow can be an alternative shape such as a V shape as illustrated in FIG. 73. In FIG. 73, the first trench walls 210, 220 correspondingly intersect with the second trench walls 212, 222 to form the V shape thereby eliminating the trench floors 214, 224. In other embodiments, the trench walls 210 and 212 are closer together to minimize or eliminate the width of the trench floor 214, or the trench walls 210 and 212 may be further apart to maximize the width of the trench floor 214. Controller 80 is operable to determine an actual furrow depth from the measured trench profile 192.

The ideal trench profile 190 is the optimal or preferred trench profile that would ideally be formed by the pair of furrow opening disks 22 but the measured trench profile 192 is the actual trench profile that is formed by the pair of furrow opening disks 22 in the ground surface G. Many factors contribute to the shape of the measured trench profile 192 that is actually made by the pair of furrow opening disks 22. The measured trench profile 192 is compared to the ideal trench profile 190 to determine if the quality of the trench formation is acceptable. The quality of the trench formation includes the depth, width, and other geometric features of the measured trench profile 192 as compared to the ideal trench profile 190. The quality of the trench formation is important because if the first and second trench walls 220 and 222 are not strong enough, then the first and second trench walls 220 and 222 could collapse such that loose soil and other materials will fall onto the trench floor 224, if present, or the first and second trench sidewalls 220 and 222 collapse onto themselves or each other before the commodity is placed by the seed delivery system 24 and the pair of closing wheels 26 close the actual trench 192. An unacceptable trench condition happens when cither or both of the trench sidewalls 220 and 222 crumble and fall onto the trench floor 224, the trench sidewalls 220 and/or 222 collapse upon themselves, or the first trench wall 220 is not even with the second trench wall 222, or vice versa. To determine whether an unacceptable trench condition exists, the first trench wall 210, the second trench wall 212, and the trench floor 214 (if present) are respectively compared to the first trench wall 220, the second trench wall 222, and the trench floor 224 (if present), to determine a trench quality condition. If the trench quality condition is not acceptable, then a signal is sent to the operator to alert that the trench quality condition is not acceptable. Thereafter the operator or operating system of the work machine will adjust the planter row unit 14. If an unacceptable trench quality condition exists, then the operator or operating system can take steps to improve the depth, width, angle, and/or smoothness of the first and second trench walls 220 and 222, respectively, and the trench floor 224 (if present). For example, adjustment of the down pressure of the pair of the furrow opening disks 22 can be made to improve the trench quality condition such that the actual trench profile 192 more closely aligns with the ideal trench profile 190. Alternatively, if the first and/or second trench walls 220 and 222 collapse, then more pressure is applied by the pair of furrow opening disks 26 so the down pressure is increased. Other adjustments can be made to the planter row unit 14 if the unacceptable trench quality condition exists.

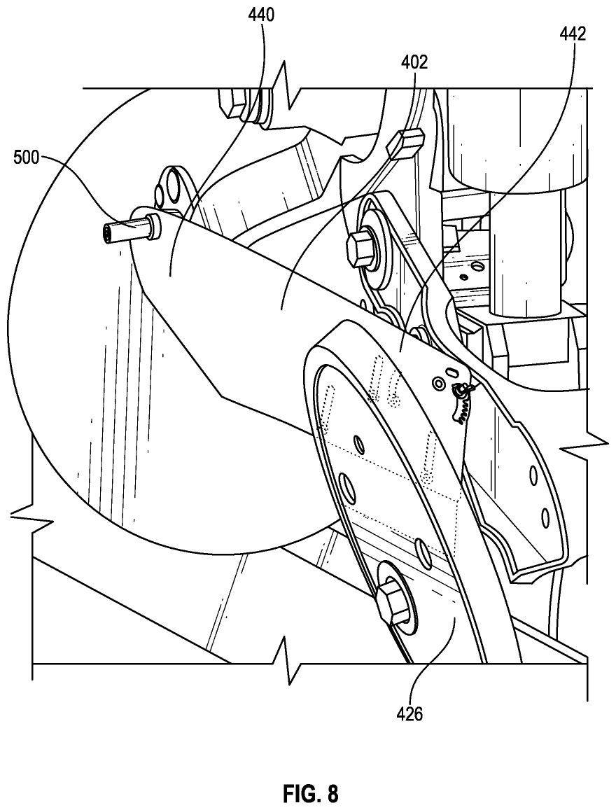

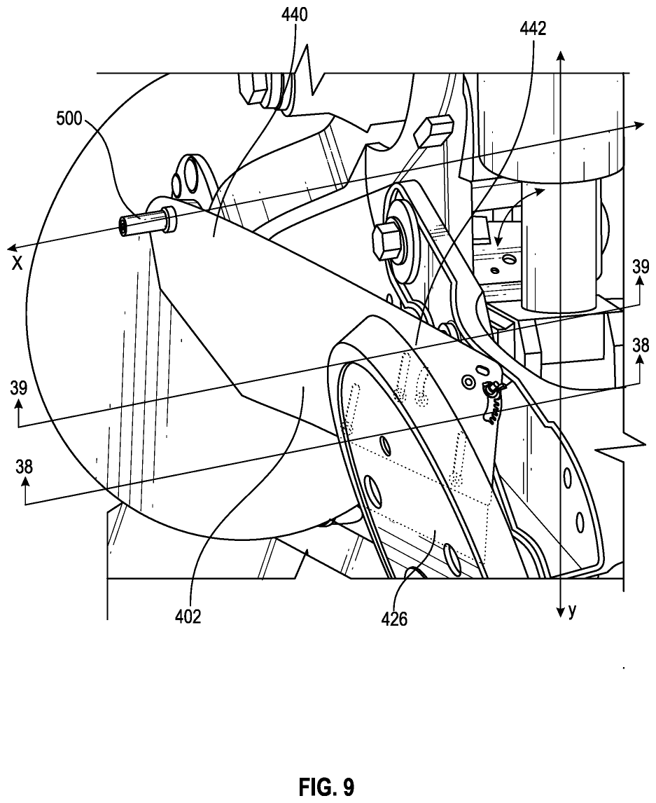

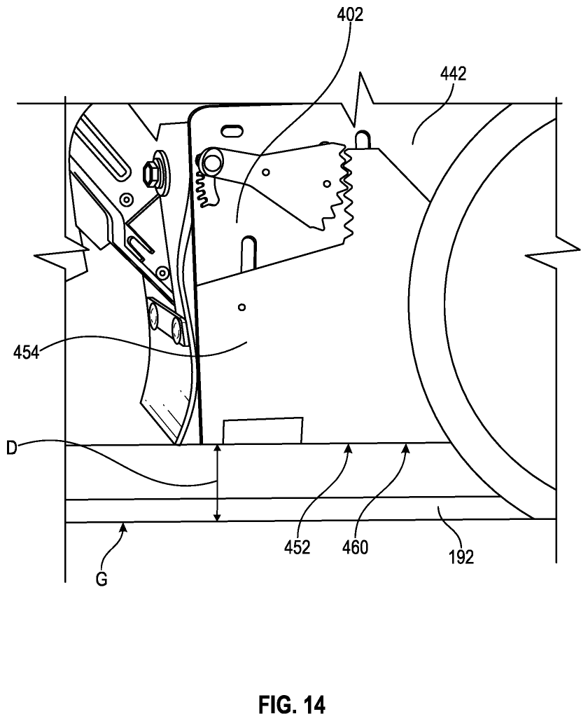

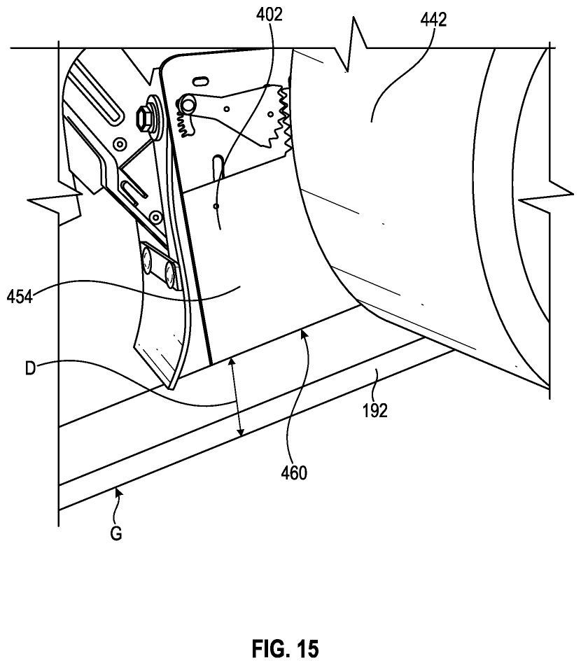

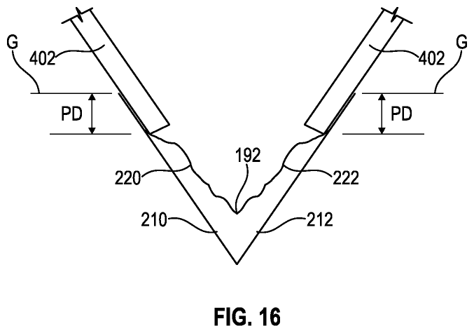

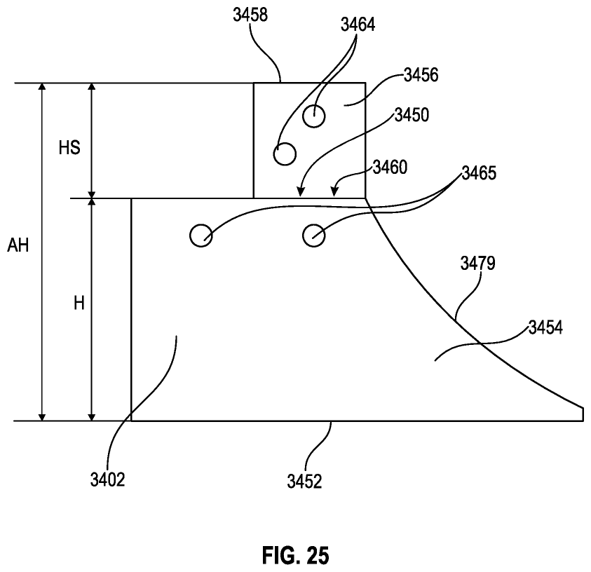

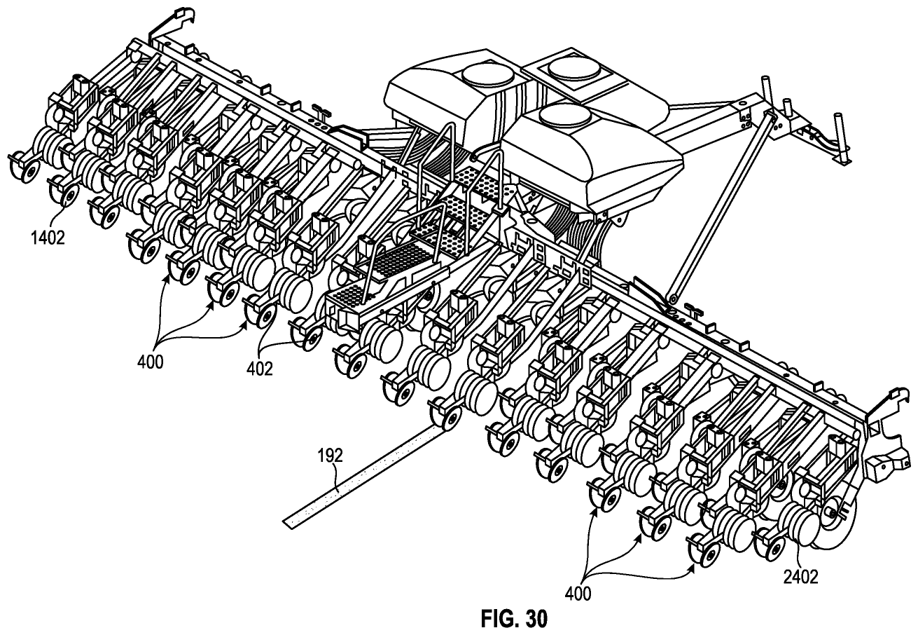

Turning now to FIGS. 6-37, multiple embodiments of a shield for attachment to the planter row unit 400 are illustrated. The configurations of the shield may vary between the embodiments. The shields disclosed herein improve the camera's field of view CV so a visualization system 404 can provide a more accurate measurement and visualization of a three dimensional (3D) geometric shape of a seed trench created by the planter row unit 400 while the planter row unit 400 is forming the seed trench or furrow 192. The present disclosure utilizes a visualization system 404 that is attached to a planter row unit 400.

The planter row unit 400 is similar to planter row unit 14 described above unless noted otherwise, therefore the planter row unit 400 includes similar reference numbers as the planter row unit 14. A visualization system 404 is operably connected and mounted to the planter row unit 400. The visualization system 404 is similar to the visualization system 60 described above unless noted otherwise. The visualization system 404 includes one or more of a camera or imaging unit, a structured light unit, and in some embodiments, a floodlight. The visualization system 404 is schematically represented on the planter row unit 400 but can be any arrangement as previously described.

As the planter row unit 400 operates in a field, a lot of dust, debris, and other pollutants are formed and can obstruct the camera's field of view CV of the seed trench or furrow 192. The dust, debris, and other pollutants can also obstruct the light or laser plane LP of patterned light of the structured light unit 64 and the image 100 illustrated as a line (see FIG. 3) which is the intersection of the laser plane LP and the actual trench 192 in the ground surface G. Sunlight can also affect the camera's field of view CV of the seed trench or furrow 192, the laser plane LP of light, and the image 100.

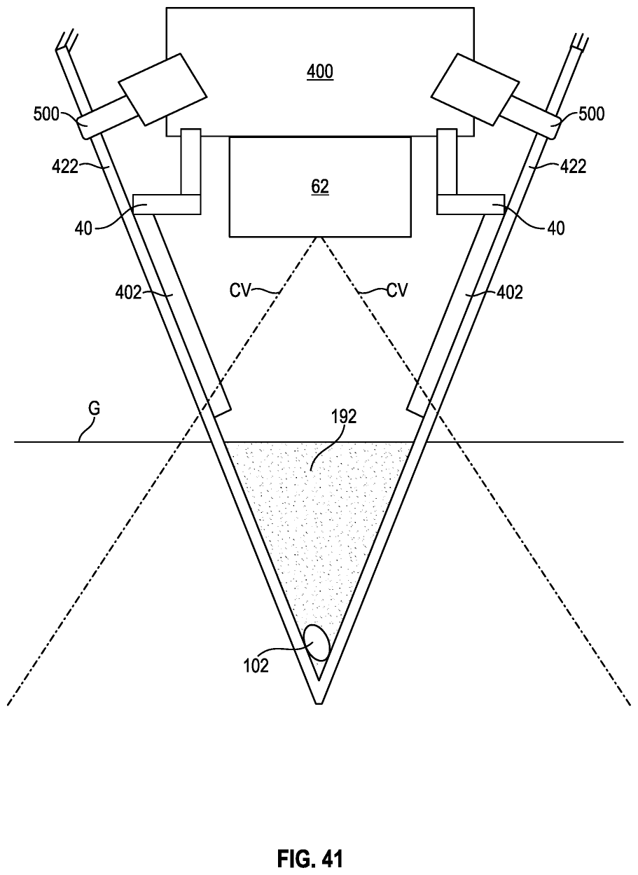

The shields mounted or attached to the planter row unit 400 prevent, block, and/or minimize sunlight, debris, dust, or other pollutants from penetrating or obstructing the projected light from the structured light unit and the camera's field of view CV. The shields increase the visibility of the furrow 192 by the visualization system 404 in challenging environmental conditions and every day field operation of the planter row unit 400. The shields can be mounted on the planter row unit 400 and form a shield angle S1 that is measured between an outside face of the shield and a plane that is defined by the intersection of a longitudinal axis L and a vertical axis V of the planter row unit 400. The shields can be mounted on the planter row unit 400 and form a second shield angle S2 that is measured between the outside face of the shield and a plane that is defined by an intersection of the vertical axis V and a horizontal axis X of the planter row unit 400. As illustrated in FIG. 41, the shields 402 are mounted or attached to the shank 40 of the planter row unit 400.

A disk angle W1 of the furrow opening disk is measured between an inboard side of the furrow opening disk 422 and the plane that is defined by the intersection of a longitudinal axis L and a vertical axis V of the planter row unit 400. A second disk angle W2 of the furrow opening disk is measured between the inboard side of the furrow opening disk and the plane that is defined by the intersection of the vertical axis V and the horizontal axis X of the planter row unit 400.

The shield angle S1 can match the disk angle W1 which is beneficial to prevent debris from accumulating between the shield and the furrow opening disk 422. It can also be beneficial if the second shield angle S2 is substantially similar to the second disk angle W2 to prevent or block sunlight from penetrating through the camera line of visualization CV. For example, in one embodiment the disk angle W1 of the pair of furrow opening disks 422 and the shield angle S1 of the shields is 32 degrees. In another embodiment, the disk angle W1 and the shield angle S1 are between 25 and 45 degrees. In yet another embodiment, the disk angle W1 and the shield angle S1 are different from each other or within a few degrees of each other. In any of these embodiments, the disk angle W2 and the shield angle S2 are different from each other or within a few degrees of each other. The shield angle S1, second shield angle S2, disk angle W1, and the second disk angle W2 are independent of each.

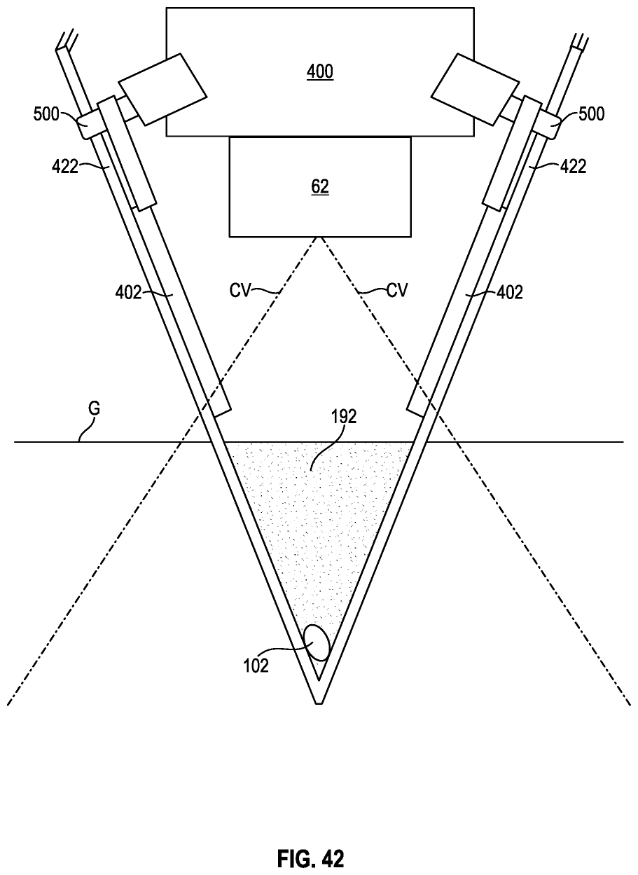

The shields are configured for attachment directly to any portion of the planter row unit or the planter, or indirectly attached via a bracket, plate, or other mechanism connected to the planter row unit or the planter and the shields. In some embodiments, the shields are configured for attachment to the planter row unit and may include an extension portion or a bent portion that retains the shields on the planter row unit and/or enables remaining portions of the shields to extend toward the ground surface G. In some embodiments, the shields are configured for attachment to the planter row unit 400 such as attached to the disc blade axle 500 as illustrated in FIG. 42. In some embodiments, the shields are configured for attachment to the planter row unit such that portions of the shields contact inboard sides 428 of the pair of furrow opening disks 422. In a further refinement, the shields are forced outwardly to contact the inboard sides 428 and eliminate or reduce any gaps between the inboard sides 428 and the shields. For example, a mechanical device such as a screw or turn buckle could be assembled with the shields wherein the screw or turn buckle is engaged to force the shields outwardly to and engage the inboard sides 428 of the pair of furrow opening disks 422. In other embodiments, the position of shields relative to the pair of furrow opening disks 422 can be adjusted either manually or automatically such as by an actuator and a motor that operates to move the shields out of or away from the camera line of visualization CV of the camera or imaging unit 62.

In some embodiments, the shields can improve the construction and stability of the trench. The shields can prevent furrow or trench collapse after the pair of gauge or furrow opening disks 422 create the furrow but before the pair of closing wheels 426 close the trench. Preventing furrow or trench collapse is very beneficial for proper seed or commodity 102 placement in the trench 192. In some embodiments, the shields can function as a mud scraper for the pair of furrow opening disks 422 of the planter row unit 400 to thereby assist in removing mud, soil, or other debris from the pair of furrow opening disks 422.

The longitudinal length of the shields can vary such that in some embodiments the shields are not visible in the camera line of visualization CV of the camera or imaging unit 62. In other embodiments, a portion of the shields is visible in the camera line of visualization CV of the camera or imaging unit 62 but this visible portion of the shields does not interfere with the light plane LP from the structured light unit 64. In yet other embodiments, a larger portion of the shields is visible in the camera line of visualization CV of the camera or imaging unit 62 and this portion of the shields does interfere with or cross the light plane LP from the structured light unit 64. In this embodiment, the larger portion of the shields extends along the furrow 192. Alternatively the camera line of visualization CV is changed by the camera or imaging unit 62 such that the camera or imaging unit 62 zooms into a different angle and the camera or imaging unit 62 does not see or detect the shields in the camera line of visualization CV but the shields are adjacent to this zoomed in area.

The shields include various shapes, including a top edge opposite a bottom edge and a front portion adjacent a rear portion wherein the front and rear portions can span between the top and bottom edges. The bottom edge can be straight in some embodiments and curved in other embodiments. In a particular form, the bottom edge along the rear portion may be convexly curved relative to the ground surface G, which can be beneficial to avoid contact between the bottom edge of the shield and the ground surface G. In other forms, the bottom edge along the front portion may be convexly curved relative to the ground surface G. There is an overlap between the front portion of the shields and the pair of furrow opening disks such that the front portion of the shields are positioned laterally adjacent to the pair of furrow opening disks.

The shields may have exterior surface properties that can be used with the camera or imaging unit 62. In some embodiments, the exterior surface of the shields is a certain color which can reduce glare from the sun and improve computer processing by the visualization system 404 or controllers associated with the planter row unit 400 or planter. Some colors for the exterior surface of the shields include matte black, brown, green, white, cream, tan, or a combination of these colors. Another exterior surface property includes markings or markers that can be positioned at designated locations on the shields such that the camera line of visualization CV of the camera or imaging unit 62 can identify the markings or markers. The markings or markers can be used to calibrate the camera or imaging unit 62, or used in diagnostics of the camera or imaging unit 62. If the marker is not seen, or not seen in focus, by the camera or imaging unit 62, then a warning is sent to any of the operator, planter, or controllers associated with the planter or planter row unit. The markings or markers can be used for alignment of the visualization system 404.

One embodiment of the shield is a shield 402 illustrated in FIG. 6. One shield 402 is illustrated in FIG. 6, however a second one of the shields 402 is positioned opposite or adjacent to the first shield 402. In one embodiment, the two shields 402 are positioned between the pair of furrow opening disks 422 such that the two shields 402 are both positioned on inboard sides 428 of the pair of furrow opening disks 422. In other embodiments, the two shields 402 are positioned in-line with the pair of furrow opening disks 422.

The shield 402 is connected to the planter row unit 400 which is connected to an agricultural work machine (not illustrated) such as a planter or seeder. The planter row unit 400 is an illustrative embodiment wherein other embodiments of planter row units can be used with the present disclosure, the shield 402, and other embodiments of the shield 402. In FIG. 6, only a single planter row unit 400 is shown, but a plurality of planter row units 400 may be coupled to a frame of the agricultural work machine in any known manner as described above with respect to the planter row unit 14.

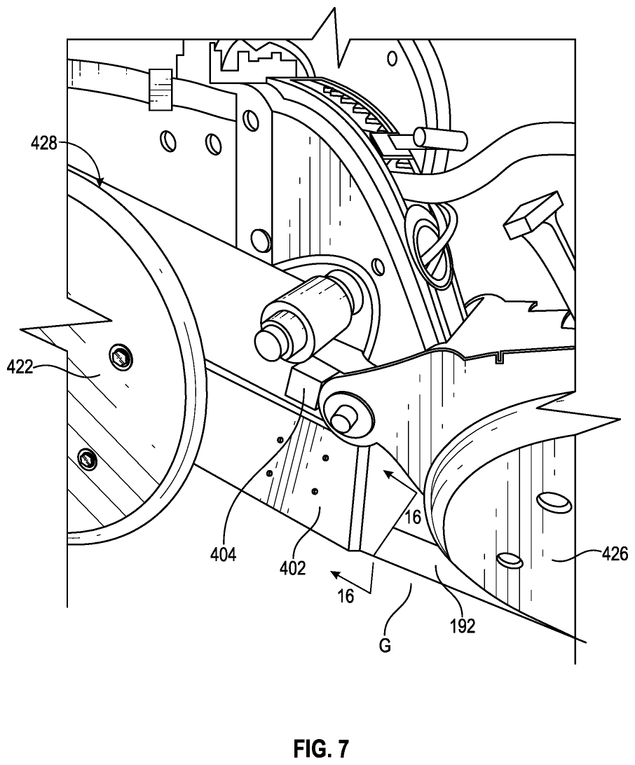

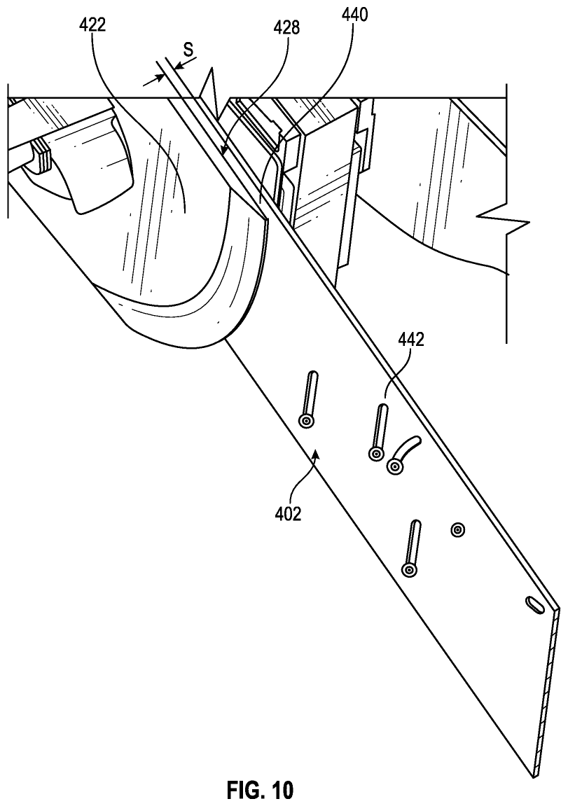

Referring now to FIGS. 7-10 of the present disclosure, the two shields 402 are attached or mounted to the planter row unit 400 such that the pair of shields 402 is inboard of the pair of furrow opening disks 422. Each of the pair of furrow opening disks 422 includes an inboard side 428 wherein one of the shields 402 is positioned very close to the inboard side 428 such that a small gap S exists between the shield 402 and the inboard side 428. In some embodiments, the small gap S is between 1 millimeter and 10 millimeters such that the shield 402 is very close to the inboard side 428 to scrape dirt, debris, or mud that may be stuck on the inboard side 428 of the furrow opening disk 422 as illustrated in FIG. 10. In other embodiments, the small gap S is larger than 10 millimeters such that the shield 402 is placed some distance from the inboard side 428 to avoid scraping the inboard side 428 of the furrow opening disk 422.

In some forms, the shields 402 are arranged parallel to a plane formed by a longitudinal axis L and a vertical axis V of the planter row unit 400. In other forms, the shields 402 are arranged in the same plane as the inboard side 428 of the furrow opening disks 422.

The shields 402 have a length that includes a first or front portion 440 and a second or rear portion 442 arranged as described below. The shields 402 are positioned relative to the pair of furrow opening disks 422 such that the first or front portion 440 of each of the shields 402 are directly adjacent or behind the pair of furrow opening disks 422 to form an overlapping region between the front portion 440 and the pair of furrow opening disks 422. The second or rear portion 442 of each of the shields 402 extends away from the pair of furrow opening disks 422 towards the closing wheels 426 as illustrated in FIGS. 8-10. The second or rear portion 442 of the shields 402 attached to the planter row unit 400 on the inboard side 428 of the furrow opening disks or disk blades 422 extends rearward past the furrow opening disk blades 422. The second or rear portion 442 can have a length that extends from the outer diameter of the furrow opening disk 422 to the rear or outer diameter of the pair of closing wheels 426. In another embodiment, the second or rear portion 442 can have a length that extends from the outer diameter of the furrow opening disk 422 to a position that is between the outer diameters of the opening and closing wheels 422 and 426, respectively. In another embodiment, the second or rear portion 442 has a length that extends from the outer diameter of the furrow opening disk 422 to a position that is shorter than a mid-distance between the outer diameters of the opening and closing wheels 422 and 426, respectively. In another embodiment, the second or rear portion 442 has a length that extends from the outer diameter of the furrow opening disk 422 to a position that is longer than a mid-distance between the outer diameters of the opening and closing wheels 422 and 426, respectively. In another embodiment, the second or rear portion 442 has a length that extends from the outer diameter of the furrow opening disk 422 to a position that is located between the opening and closing wheels 422 and 426 wherein the position includes all of or portions of the camera line of visualization CV of the camera and the light plane LP from the structured light unit in the visualization system 404.

An alternative embodiment of the shield 1402 is illustrated in FIG. 11. Generally, the shields 402 and 1402 each have an initial height H that extends from a top edge 450 to a bottom edge 452 as illustrated in FIG. 11. The shields 1402 are similar to the shields 402 unless identified otherwise below.

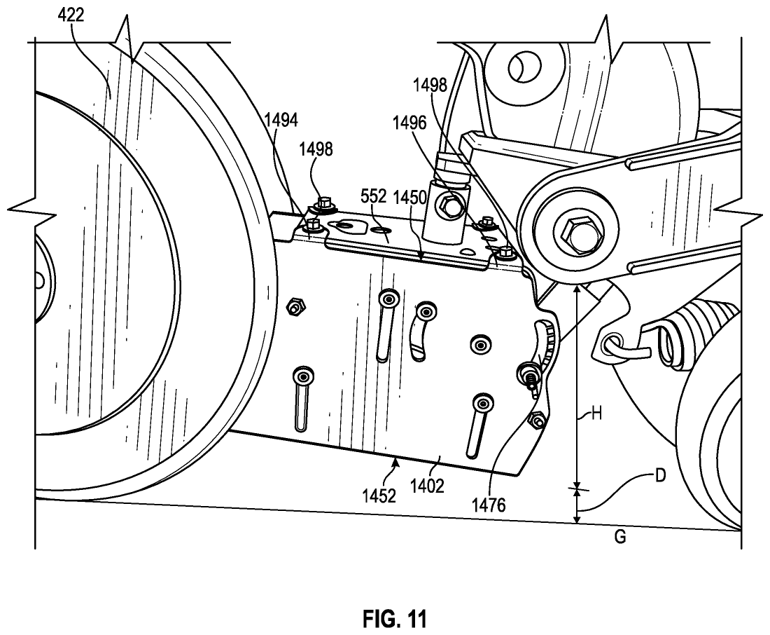

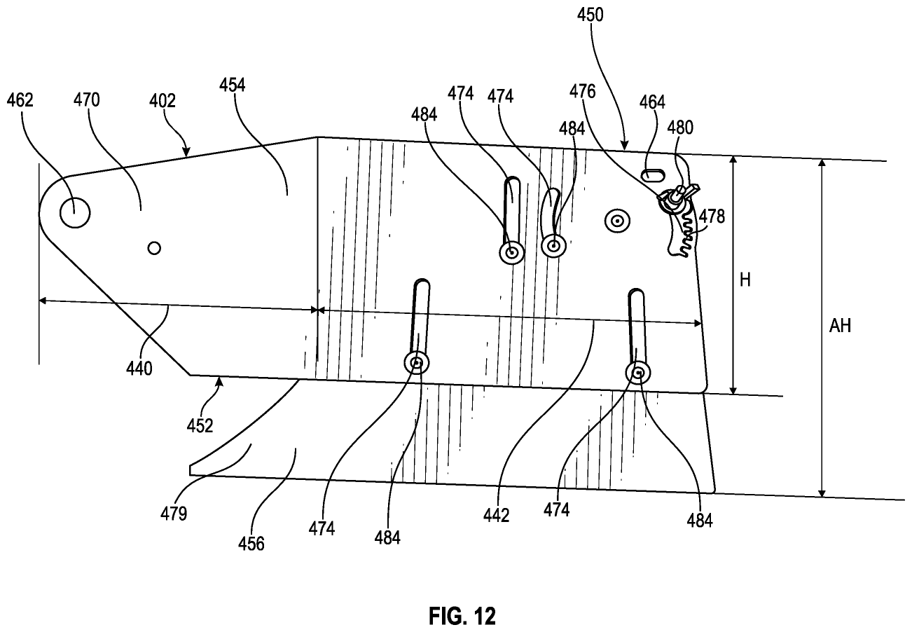

Each of the shields 402 includes a first shield component 454 operably connected to a second shield component 456 as illustrated in FIGS. 12 and 13. Other embodiments of the shield 402 may have only one shield component or may have more than two shield components assembled together to form a single shield. Other embodiments of the shield 402 may have one or more attachment pieces that are assembled with the shield 402. In other embodiments of the shield 402, either the first or the second shield components 454 or 456 may be removeable from the other of the first or the second shield components 454 or 456 in certain operating conditions of the planter row unit 400. In yet other embodiments, the shields 402 are removed from the planter row unit 400.

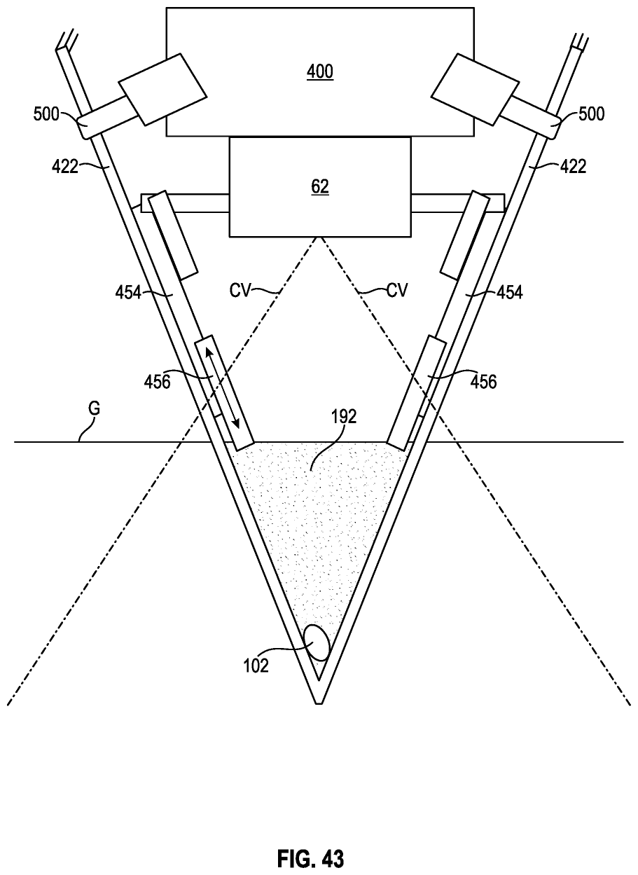

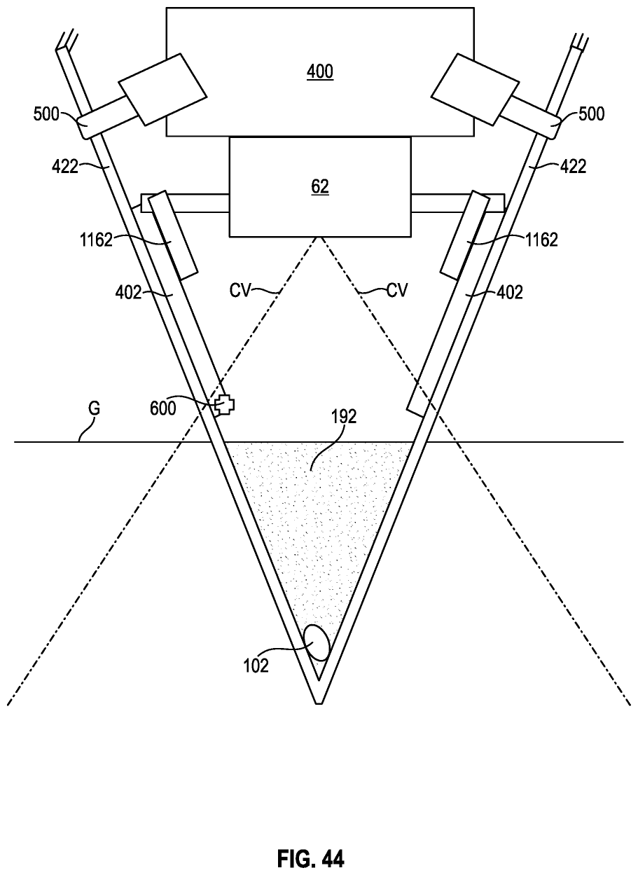

The first shield component 454 includes the top edge 450 and the bottom edge 452. The second shield component 456 includes a top edge 458 opposite a bottom edge 460 with a height that spans between the top and bottom edges 458 and 460. The second shield component 456 is adjustable relative to the first shield component 454 when the first shield component 454 is mounted to the planter row unit 400 as illustrated in FIG. 43.

One form of attaching or mounting the shield 402 to the planter row unit 400 is described next, although other techniques or embodiments of the shield 402 may be configured differently to attach the shield 402 to the planter row unit 400 as described below. In this first form, the first shield component 454 includes a first mounting hole 462 that is configured for assembling onto a disc stud 500 of the planter row unit 400 to attach the shield 402 to the planter row unit 400 as illustrated in FIG. 18. The first shield component 454 also includes a second mounting hole 464 that is configured for assembling onto a visualization mounting bracket 552 of the planter row unit 400 to attach the shield 402 to the planter row unit 400. In other embodiments, the second shield component 456 is configured for assembly and attachment to the planter row unit 400.

As illustrated in FIGS. 12 and 13, the second shield component 456 is adjusted away or laterally from the first shield component 454 to thereby increase the overall height of the shield 402 to an adjusted height AH. As such, the adjusted height AH is larger or taller than the initial height H. In one arrangement, the bottom edge 460 of the second shield component 456 extends below or lower than the bottom edge 452 of the first shield component 454 when the shield 402 is attached to the planter row unit 400. In a second arrangement, the top edge 458 of the second shield component 456 extends above the top edge 450 of the first shield component 454 to thereby increase the overall height of the shield 402 to the adjusted height AH. In other embodiments, the first shield component 454 is adjusted relative to the second shield component 456 wherein the second shield component 456 is mounted to the planter row unit 400.

In any arrangement of adjustment wherein the second shield component 456 is adjustable relative to the first shield component 454, or vice versa, a gap or distance D from the bottom edge 452 to the ground surface G can vary as the first or the second shield components 454 and 456 are adjusted. For example, when the planter row unit 400 is used to create furrows, the depth of the furrow can vary depending on the planting depth that is desired therefore adjustment of the first and/or second shield components 454 and 456 is desired as the pair of furrow opening disks 422 are adjusted for the planting depth desired. As another example, the angle of sunlight towards the shield 402 can vary throughout the day and with continued use of the planter row unit 400, therefore the first or the second shield components 454 and 456 may need adjustment to block sunlight from and improve the camera line of visualization CV of the camera, the visibility of the light plane LP from the structured light unit, and any additional lights in the visualization system 404. Adjustment of the second shield component 456 relative to the first shield component 454 can be done manually by an operator or automatically by one or more of the controllers associated with the planter row unit 400.

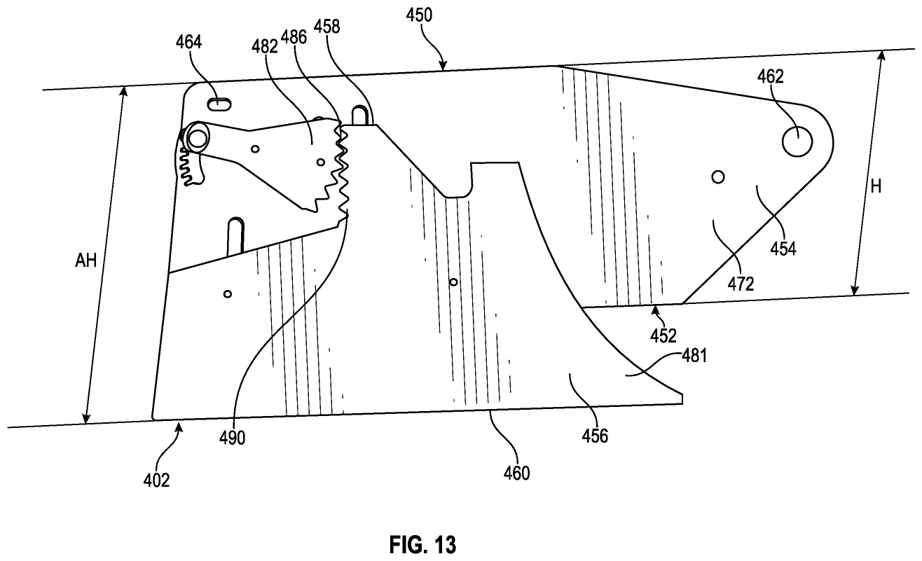

Illustrated in FIG. 14 is one embodiment of a partial view of the shield 402 mounted to the planter row unit 400. In this arrangement, the second shield component 456 is adjustable downward relative to the first shield component 454 such that the bottom edge 460 of the second shield component 456 extends below or lower than the bottom edge 452 of the first shield component 454. The gap or distance D from the bottom edge 452 to the ground surface G is small such that the bottom edge 460 of the second shield component 456 is close to the ground surface G and the actual trench or furrow 192. In other embodiments, the first shield component 454 is adjustable downward relative to the second shield component 456 such that the bottom edge 452 of the first shield component 454 is closer to the ground surface G.

Illustrated in FIG. 15 is one embodiment of a partial view of the shield 402 mounted to the planter row unit 400. Compared to FIG. 14, the second shield component 456 is adjustable downward relative to the first shield component 454 a lesser or smaller distance such that the bottom edge 460 of the second shield component 456 extends below or lower than the bottom edge 452 of the first shield component 454 but not as low as or close to the ground surface G as the second shield component 456 in FIG. 14. In FIG. 15, the gap or distance D from the bottom edge 452 to the ground surface G is larger than the gap or distance D illustrated in FIG. 14. In FIG. 15, the bottom edge 460 of the second shield component 456 is further away from the ground surface G and the actual trench or furrow 192. In other embodiments, the first shield component 454 is adjustable downward relative to the second shield component 456 such that the bottom edge 452 of the first shield component 454 is closer to the ground surface G.

In another form of adjustment, the second shield component 456 is adjustable relative to the first shield component 454 such that the bottom edge 460 of the second shield component 456 extends a penetration distance PD into the actual trench or furrow 192 in the field or ground surface G as illustrated in FIGS. 7, 16, and 17. In an alternative embodiment, the first shield component 454 is adjustable relative to the second shield component 456 such that the bottom edge 452 of the first shield component 454 extends to the penetration distance PD. In other embodiments, the shield 402 including both the first and second shield components 454 and 456 are positioned relative to the planter row unit 400 such that both of the bottom edges 452 and 460 extend to the penetration distance PD into the actual trench or furrow 192. The shields 402 are illustrated in the same plane as the inboard side 428 of the furrow opening disks 422 such that the shields 402 align more with the first and second trench walls 220 and 222, however, in other embodiments the shields 402 are oriented in a vertical orientation. In any of these embodiments, the shields 402 may also prevent furrow collapse of the actual trench or furrow 192 until the pair of closing wheels 426 close the trench or the shields 402 pass by the seed or commodity 102. For example, when the furrow 192 is cut in soil that consists of sand or other loose materials that are resistant to maintaining the furrow cross-sectional shape and allow furrow collapse, the shields 402 that extend to the penetration distance PD help prevent the first and second trench walls 220 and 222 from collapsing until the seed or commodity 102 is placed in the actual trench or furrow 192. The furrow opener or furrow opening disks 422 form the actual furrow or trench 192 in the field for receiving metered seed (or other product) 102 from the seed meter 20. After or while the actual trench 192 is formed, the shields 402 enter or are positioned in the furrow 192 and extend to the penetration distance PD into the furrow 192. While the shields 402 are positioned to the penetration distance PD in the furrow 192, the seed or commodity 102 is transferred from the seed meter 20 by the seed delivery system 24 to the trench or furrow 192. Optionally, the shields 402 are positioned adjacent to the seed or commodity 102 while the seed or commodity 102 is placed in the furrow 192 and thereby prevent furrow collapse. After the seed or commodity 102 is placed in the furrow 192, the planter row unit 400 traverses a short distance and the shields 402 pass the seed or commodity 102. After the shields 402 pass by the seed or commodity 102, the pair of closing wheels 426 close the trench or furrow 192 and cover the seed or commodity 102 in the furrow 192.

Turning now to the embodiment of the shield 402 that is illustrated in FIGS. 12 and 13. As discussed previously, the shield 402 includes the first shield component 454 having the top edge 450 and the bottom edge 452. The first shield component 454 includes an outside face 470 and an inside face 472. The first shield component 454 includes a plurality of first shield openings 474 arranged to align with and receive a plurality of fasteners 484 that are mounted on the second shield component 456 such that the second shield component 456 slides relative to the first shield component 454 as the plurality of fasteners 484 travel along the plurality of first shield openings 474. As the second shield component 456 slides relative to the first shield component 454, the second shield component 456 is adjusted away or laterally from the first shield component 454 to thereby increase the overall height of the shield 402 to the adjusted height AH. The first shield component 454 includes an arm opening 476 that includes a plurality of notches 478 sized to receive a locking fastener 480 therein. The locking fastener 480 assembles the first shield component 454 to an arm member 482 that is configured for engagement with the second shield component 456. In particular, the arm member 482 includes a plurality of teeth 486 that are sized and configured to operate with a plurality of teeth 490 of the second shield component 456. The locking fastener 480 assembled with the arm member 482 can be tightened to a particular resistance to either resist or enable movement of the arm member 482 relative to the second shield component 454. In a locked position, the locking fastener 480 assembled with the arm member 482 resists movement of the arm member 482 and the second shield component 454 and stiffens or strengthens the shield 402 to resist bending or distortion of the shield 402. In one embodiment, the arm member 482 is a turnbuckle.

The second shield component 456 includes the top edge 458 opposite the bottom edge 460. The second shield component 456 includes an outside face 479 and an inside face 481. The second shield component 456 is adjustable relative to the first shield component 454 when the first shield component 454 is mounted to the planter row unit 400. The plurality of fasteners 484 are mounted and arranged on the second shield component 456 such that the plurality of fasteners 484 travel or slide along the plurality of first shield openings 474 of the first shield component 454. The second shield component 456 includes the plurality of teeth 490 that are sized and configured to operate with the plurality of teeth 486 of the arm member 482.

Turning now to FIG. 11, the shields 1402 are attached to the visualization mounting bracket 552 of the planter row unit 400. Each of the shields 1402 includes a first tab 1494 spaced apart from a second tab 1496 wherein both of the first and second tabs 1494 and 1496 extend from a top edge 1450. Generally the first and second tabs 1494 and 1496 are each bent to form an angle relative to the first shield component 454 such that the first and second tabs 1494 and 1496 rest against the visualization mounting bracket 552. Each of the first and second tabs 1494 and 1496 has a hole sized to receive a fastener 1498 therein to attach each of the shields 1402 with a corresponding hole in the visualization mounting bracket 552 of the planter row unit 400. The fastener 1498 can include a screw, bolt, or other mechanical device to attach the first and second tabs 1494 and 1496 to the visualization mounting bracket 552. In one embodiment, a bracket (not illustrated) is attached to the visualization mounting bracket 552 wherein the bracket is configured to receive the first and second tabs 1494 and 1496.

Each of the shields 1402 includes an arm opening 1476 that is similar to the arm opening 476 wherein the arm opening 1476 is positioned in a different location on the shield 1402 as compared to the arm opening 476 of the shield 402.

In another embodiment, the shields 1402 may include a first mounting hole similar to the first mounting hole 462 that is configured for assembling onto the disc stud 500 of the planter row unit 400 to attach the shield 1402 to the planter row unit 400. The shields 1402 may include a second mounting hole similar to the second mounting hole 464 that is configured for assembling onto the visualization mounting bracket 552 of the planter row unit 400 to attach the shield 1402 to the planter row unit 400.

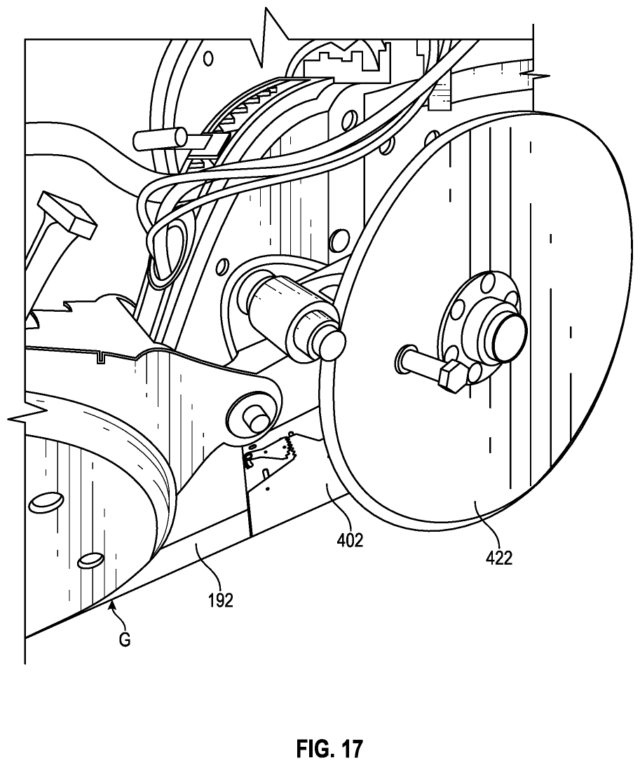

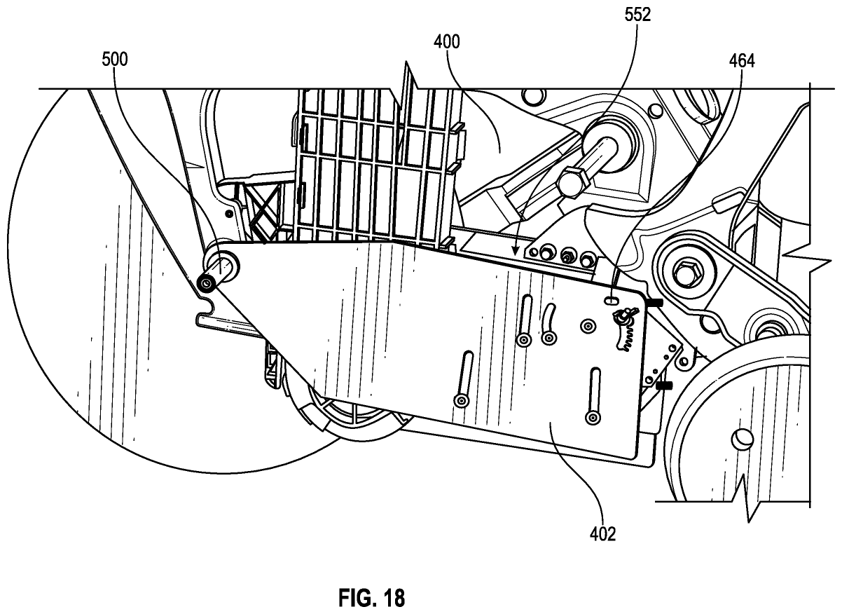

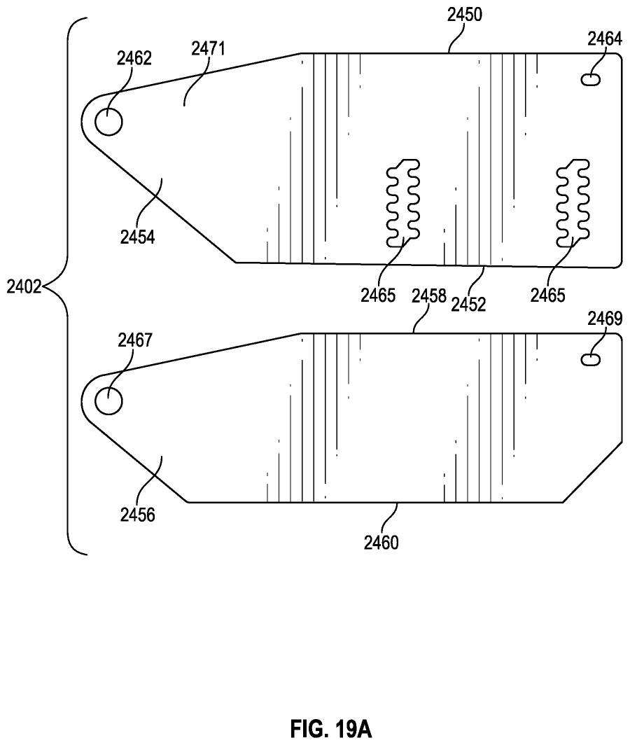

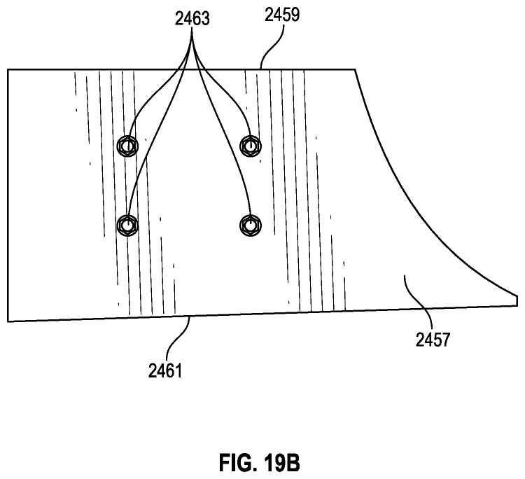

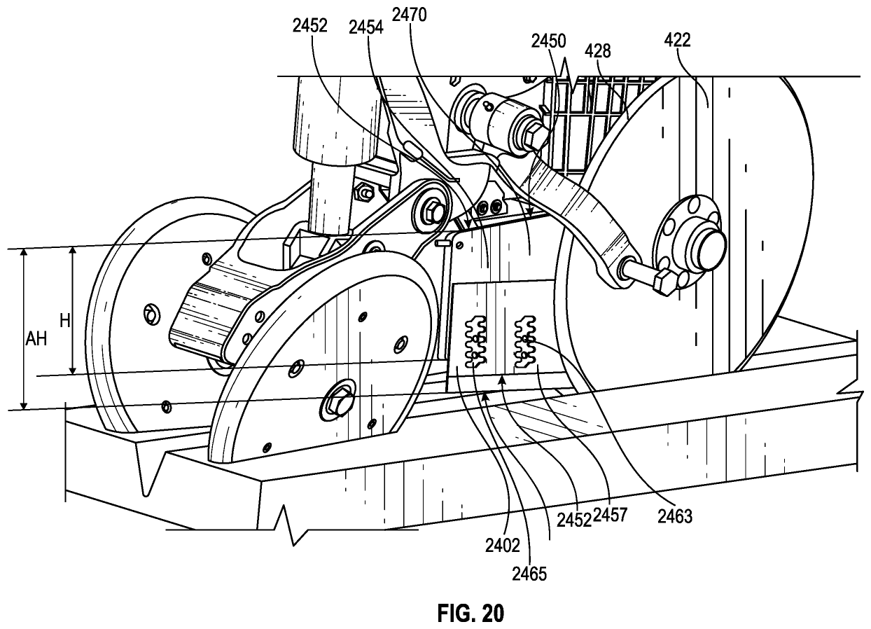

Turning now to FIGS. 19a, 19b, 20, and 21, another embodiment of a shield 2402 is illustrated. The shield 2402 is similar to the shield 402. Two of the shields 2402 are positioned on inboard sides 428 of the pair of furrow opening disks 422. Illustrated in FIG. 19a is an exploded view of the shield 2402 that includes a first shield component 2454 that can be operably connected to a second shield component 2456. Illustrated in FIGS. 19a, 19b, and 20 is one of the shields 2402 and an extension piece 2457 that is attached to and sandwiched between the first and second shield components 2454 and 2456. In other embodiments, the extension piece 2457 is attached outwardly to one of the first or the second shield components 2454 and 2456. The extension piece 2457 is configured to slide or move vertically up and/or down relative to the first or the second shield components 2454 and 2456. The shields 2402 each have an initial height H that extends from a top edge 2450 to a bottom edge 2452 as illustrated in FIG. 20. The shields 2402 are similar to the shields 402 unless identified otherwise below.

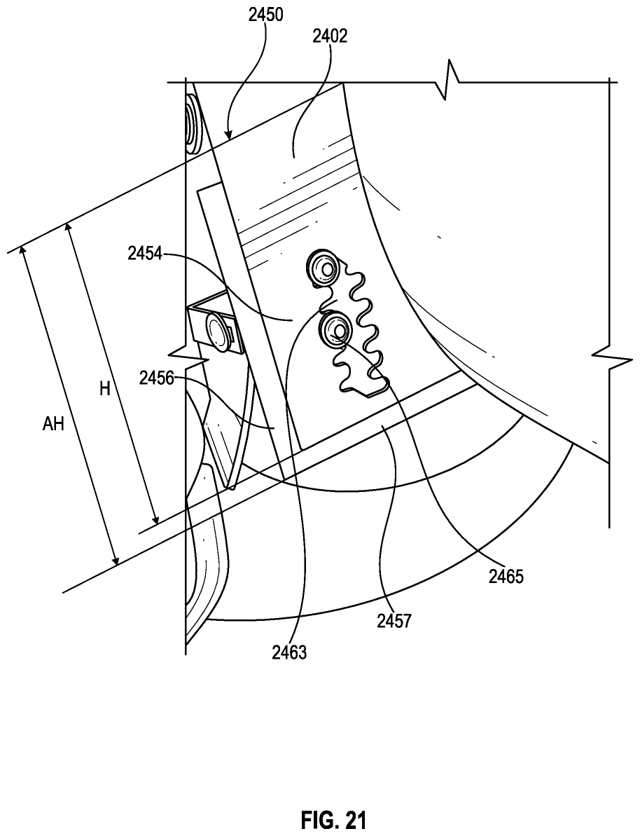

This embodiment of the shield 2402 has one attachment piece embodied as the extension piece 2457 that is assembled with the shield 2402. In other embodiments of the shield 2402, there may be additional attachment pieces or no attachment pieces. In the illustrated embodiment in FIG. 20, the extension piece 2457 is positioned in a first configuration and attached to the shield 2402 to increase the overall height of the shield 2402 to an adjusted height AH. As such, the adjusted height AH is larger or taller than the initial height H. In the illustrated embodiment in FIG. 21, the extension piece 2457 is positioned in a second configuration and attached to the shield 2402 to increase the overall height of the shield 2402 to an adjusted height AHI but does not increase as much as the adjusted height AH that is illustrated in FIG. 20.

Either the first or the second shield components 2454 or 2456 may be removable from the other of the first or the second shield components 2454 or 2456 in certain operating conditions of the planter row unit 400. In yet other embodiments, the shields 2402 are removed from the planter row unit 400.

The first shield component 2454 includes the top edge 2450 and the bottom edge 2452. The second shield component 2456 includes a top edge 2458 opposite a bottom edge 2460 with a height that spans between the top and bottom edges 2458 and 2460. The extension piece 2457 includes a top edge 2459 opposite a bottom edge 2461 with a height that spans between the top and bottom edges 2459 and 2461. One or more fasteners 2463 are attached to the extension piece 2457. The one or more fasteners 2463 are arranged and configured to engage with one or more first shield openings 2465 in the first shield component 2454 to enable the extension piece 2457 to slide or move vertically relative to the first shield component 2454. In another embodiment, the second shield component 2456 is adjustable relative to the first shield component 2454 when the first shield component 2454 is mounted to the planter row unit 400.

In the illustrated embodiment, the extension piece 2457 is adjustable relative to the first shield component 2454 such that the one or more fasteners 2463 slide relative to the plurality of first shield openings 2465. The extension piece 2457 is adjusted away or laterally from the first shield component 2454 to thereby increase the overall height of the shield 2402 to an adjusted height AH. As such, the adjusted height AH is larger or taller than the initial height H.

In another arrangement, the bottom edge 2460 of the second shield component 2456 extends below or lower than the bottom edge 2452 of the first shield component 2454 when the shield 2402 is attached to the planter row unit 400. In yet another arrangement, the top edge 2458 of the second shield component 2456 extends above the top edge 2450 of the first shield component 2454 to thereby increase the overall height of the shield 2402 to the adjusted height AH. In other embodiments, the first shield component 2454 is adjusted relative to the second shield component 2456 wherein the second shield component 2456 is mounted to the planter row unit 400.

In any form of adjustment wherein the extension piece 2457 is adjustable relative to the first shield component 2454, a gap or distance D from the bottom edge 2461 of the extension piece 2457 to the ground surface G can vary as the extension piece 2457 is adjusted. For example, when the planter row unit 400 is used to create furrows, the depth of the furrow can vary depending on the planting depth that is desired therefore adjustment of the extension piece 2457 is desired. As another example, the angle of sunlight towards the shield 2402 can vary throughout the day and with continued use of the planter row unit 400, therefore the extension piece 2457 may need adjustment to block sunlight from and improve the camera line of visualization CV of the camera and the light plane LP of the visualization system 404. Adjustment of the extension piece 2457 relative to the first shield component 2454 can be done manually by an operator or automatically by one or more of the controllers associated with the planter row unit 400.

One form of attaching or mounting the shield 2402 to the planter row unit 400 is described next, although other techniques or embodiments that attach the shield 2402 to the planter row unit 400 can be used. In this first form, the first shield component 2454 includes a first mounting hole 2462 that is configured for assembling onto the disc stud 500 of the planter row unit 400. The first shield component 2454 also includes a second mounting hole 2464 that is configured for assembling onto the visualization mounting bracket 552 of the planter row unit 400. In this form, the second shield component 2456 is configured for assembly and attachment to the planter row unit 400. The second shield component 2456 includes a first mounting hole 2467 that is configured for assembling onto the disc stud 500 of the planter row unit 400. The second shield component 2456 includes a second mounting hole 2469 that is configured for assembling onto the visualization mounting bracket 552 of the planter row unit 400. In yet other embodiments, the shield 2402 is configured differently for attachment to the planter row unit 400.

In one form of adjustment, the extension piece 2457 is adjustable relative to the first shield component 2454 such that the bottom edge 2461 of the extension piece 2457 extends a penetration distance PD into the actual trench or furrow 192 in the field or ground surface G. In an alternative embodiment that does not include the extension piece 2457, the shield 2402 including both the first and second shield components 2454 and 2456 are positioned relative to the planter row unit 400 such that both of the bottom edges 2452 and 2460 extend to the penetration distance PD into the actual trench or furrow 192. In any of these embodiments, the shields 2402 may function similarly to the shields 402 as described above.

The first shield component 2454 includes an outside face 2470 and an inside face 2471. The first shield component 2454 includes a plurality of first shield openings 2465 arranged to align with and receive a plurality of fasteners 2463 that are mounted on the extension piece 2457 such that the extension piece 2457 slides relative to the first shield component 2454 as the plurality of fasteners 2463 travel within or along the length of the plurality of first shield openings 2465. As the extension piece 2457 slides relative to the first shield component 2454, the extension piece 2457 is adjusted away or laterally from the first shield component 2454 to thereby increase the overall height of the shield 2402 to the adjusted height AH.

The extension piece 2457 can be made of any combination of rigid, flexible, or semi-flexible materials. The extension piece 2457 can be made of flexible materials such as rubber or flexible plastic. The extension piece 2457 can include other materials such as brushes, curtains, rubber flaps, or a ski member.

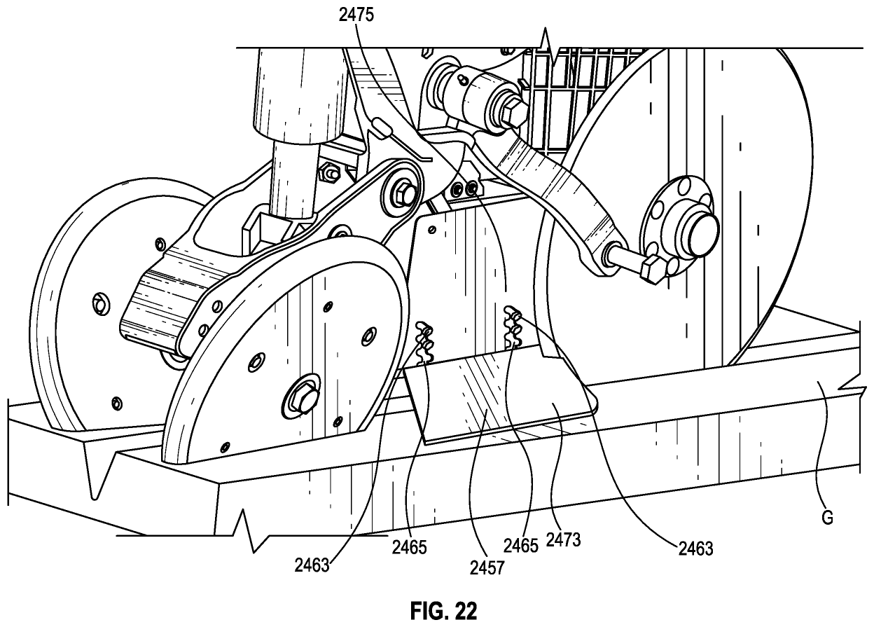

In another form illustrated in FIG. 22, the extension piece 2457 includes a straight portion 2475 adjacent a bent portion 2473. The straight portion 2475 includes the one or more fasteners 2463 mounted thereon such that the one or more fasteners 2463 assemble with the one or more first shield openings 2465. The bent portion 2473 flares away from the straight portion 2475 and also flares away from the vertical axis V and the longitudinal axis L of the planter row unit 400. The bottom edge 2452 of the first component 2454 can extend below the straight portion 2475 and in some embodiments extend below the bent portion 2473.

The extension piece 2457 may include a certain surface color or surface pattern that reduces the glare and improves computer processing by the visualization system 404. Some colors for the shield 2402 and/or the extension piece 2457 are matte black, black, brown, green, or other dark colors, alternatively the shield 2402 and/or the extension piece 2457 can be white, cream, or other light colors, or the shield 2402 may include a dark portion and a light portion. The shield 2402 can include another exterior property such as one or more markers that are used with the visualization system 404 to improve calibration of the visualization system 404 and/or the camera therein. The marker is an artifact on the exterior surface of the shield 2402 wherein the visualization system 404 will determine if the artifact is seen or detected the camera, and if the artifact is seen or detected by the camera then the visualization system 404 confirms whether the artifact is in focus or blurry. If the artifact is detected as blurry or out of focus by the camera, then a warning can be sent to the planter row unit 400 and the operator. If the artifact is not detected by the camera, then a warning can be sent to the planter row unit 400 and the operator.

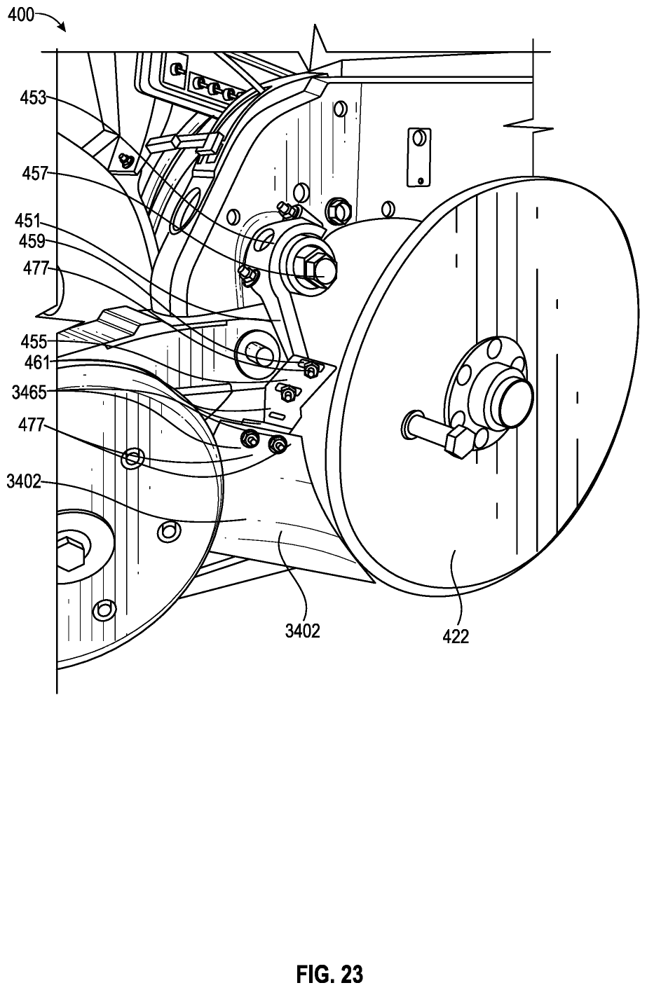

Turning now to FIGS. 23-25, another embodiment of a shield 3402 mounted to the planter row unit 400 is illustrated. The planter row unit 400 includes a pivot 457 that is operably connected, such as by a pair of pivot arms (not illustrated) to the pair of furrow opening disks 422 such that the pair of furrow opening disks 422 can pivot about the pivot 457. A pair of brackets 451 are attached to the pivot 457 such that one of the brackets 451 is associated with one of the pair of furrow opening disks 422 and the shield 3402. Each of the brackets 451 includes a pivot attachment arm 453 that is mounted on the pivot 457. Each of the brackets 451 includes a leg portion 455 that extends to and is configured to attach to one of the shields 3402. The leg portion 455 includes one or more bent sections 461 that extend to receive the shield 3402. The leg portion 455 includes one or more holes 459 sized to receive one or more fasteners 477 to connect each of the shields 3402 to the leg portion 455. One embodiment of the pair of brackets 451 is illustrated however the pair of brackets 451 can be configured differently in other embodiments.

Although not illustrated, the shield 3402 includes a pair of the shields 3402 wherein one of the shields 3402 is mounted on the pivot 457 adjacent to one of the furrow opening disks 422. Each of the shields 3402 is in-line with one of the furrow opening disks 422 or cutting discs. Each of the shields 3402 is positioned relative to one of the pair of furrow opening disks 422 such that one of the shields 3402 is directly behind one of the furrow opening disks 422. Alternatively, the shields 3402 can be positioned on inboard sides 428 of the pair of furrow opening disks 422 such that there is the small gap S or no gap between the shields 3402 and the inboard sides 428 as described in other embodiments.

The shields 3402 each have an initial height H that extends from a top edge 3450 to a bottom edge 3452. The shields 3402 are similar to the shields 402 unless identified otherwise below. Each of the shields 3402 includes a first shield component 3454 and a second shield component 3456. The first shield component 3454 includes the top edge 3450 and the bottom edge 3452. The first shield component 3454 includes a curved edge 3479 that spans between the top edge 3450 and the bottom edge 3452. The curved edge 3479 has a radius that is configured to follow a radius of the furrow opening disks 422 such that the curved edge 3479 is positioned exteriorly of the furrow opening disks 422 and any gap between the curved edge 3479 and the furrow opening disks 422 is minimized. This arrangement between the curved edge 3479 and the furrow opening disks 422 enables the shields 3402 to block or minimize sunlight and other obstructions or pollutants from the field of view or camera line of visualization CV of the camera or imaging unit 62, the light plane LP from structured light unit, and any other lights associated with the visualization system 404. The first shield component 3454 includes one or more first openings 2465 that are configured for assembling with the one or more fasteners 477 and the leg portion 455 of the planter row unit 400 to attach the shield 3402 to the planter row unit 400.

The second shield component 3456 includes a top edge 3458 opposite a bottom edge 3460 with a height HS that spans between the top and bottom edges 3458 and 3460. The second shield component 2456 extends above the first shield component 3454 when the second shield component 3456 is mounted to the planter row unit 400 to thereby increase the overall height of the shield 3402 to an adjusted height AH. The second shield component 3456 includes one or more mounting holes 3464 that are configured for assembly with the one or more fasteners 477 and the leg portion 455 to attach the shield 3402 to the planter row unit 400. In yet other embodiments, the shield 3402 is configured differently for attachment to the planter row unit 400.

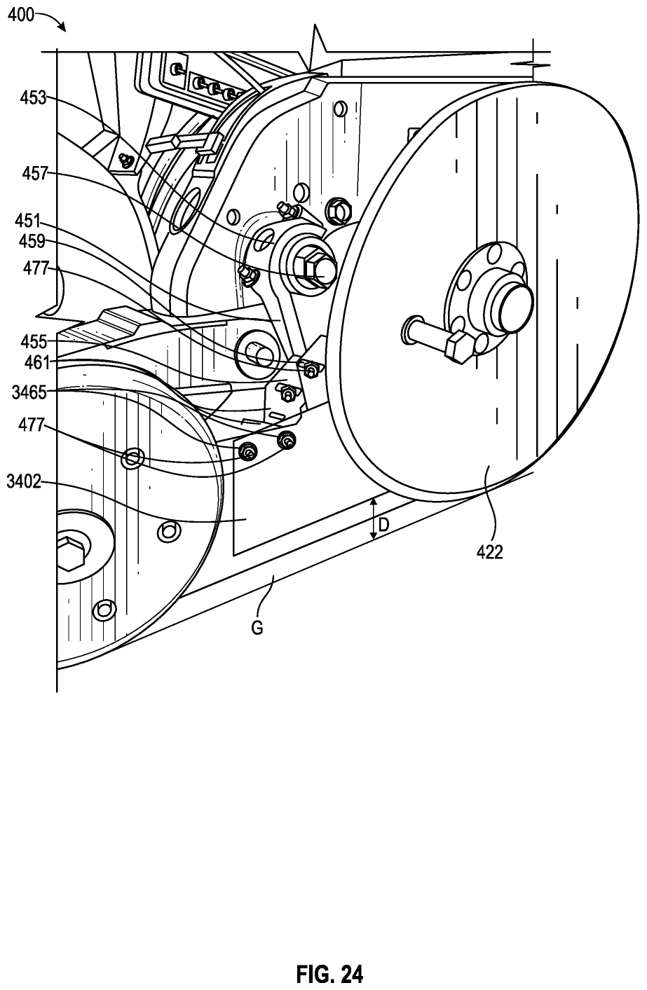

In FIG. 24, the pair of furrow opening disks 422 are shown in an upright pivoted position such that the pair of furrow opening disks 422 and the shields 3402 pivot about the pivot 457. In this upright pivoted position, the positions of one of the pair of furrow opening disks 422 and the corresponding adjacent one of the shields 3402 are adjusted together. Similarly, the positions of the other one of the pair of furrow opening disks 422 and the corresponding adjacent one of the shields 3402 are adjusted together. Beneficially, the shields 3402 maintain their position relative to the pair of furrow opening disks 422 as the pair of furrow opening disks 422 pivot about the pivot 457 therefore the shields 3402 continue to block sunlight, dust, and other debris from the camera line of visualization CV of the camera or imaging unit 62 and improve the view of the furrow 192.

A gap or distance D from the bottom edge 3452 of the shields 3402 to the ground surface G is illustrated in FIG. 24. When the planter row unit 400 is used to create furrows, the depth of the furrow can vary depending on the planting depth that is desired therefore adjustment of the shields 3402 may be desired. In some embodiments, the shields 3402 are configured differently such that the first shield component 3454 is adjusted relative to the second shield component 3456 wherein the second shield component 3456 is mounted to the planter row unit 400. In yet other embodiments, the shields 3402 are configured differently such that the second shield component 3456 is adjusted relative to the first shield component 3454 wherein the first shield component 3454 is mounted to the planter row unit 400. In yet other embodiments, the one or more first openings 3465 and/or the one or more mounting holes 3464 are configured to enable adjustment of the shields 3402 relative to the leg portion 455. For example, the one or more first openings 3465 and/or the one or more mounting holes 3464 can have a slot configuration such that the shields 3402 can be raised or lowered relative to the leg portion 455 and then held into that position by the one or more fasteners 477.

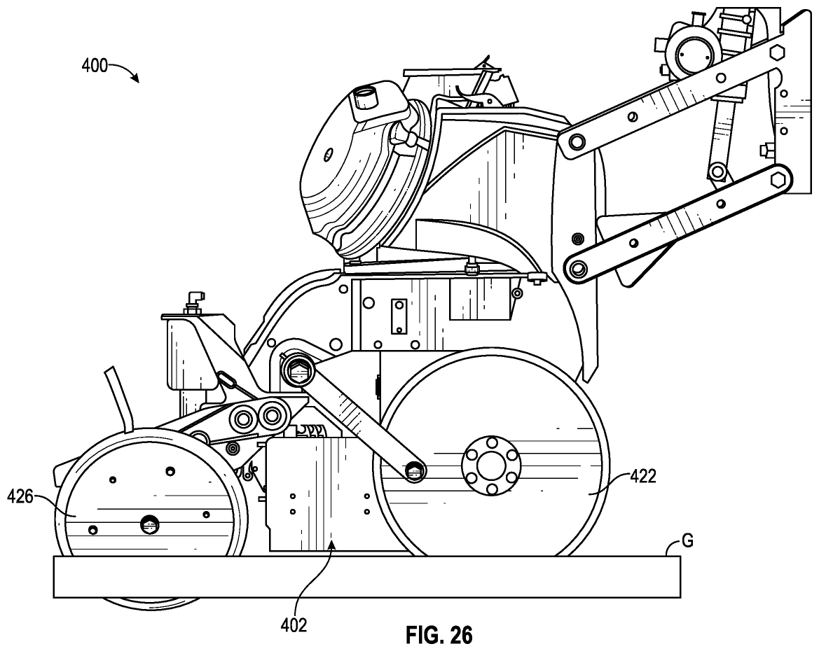

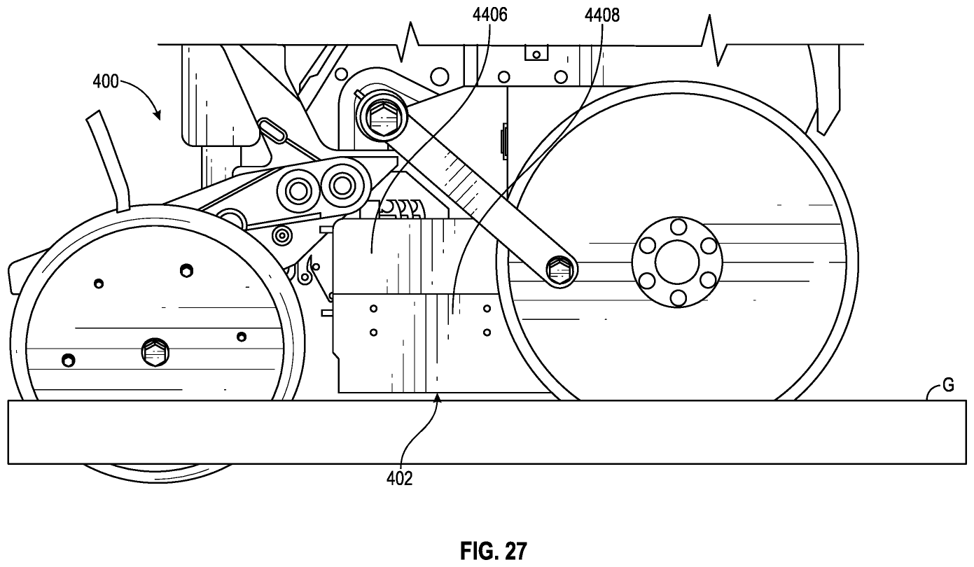

In any of the above embodiments, the shields 402, 1402, 2402, and 3402 may be straight or the shields 402, 1402, 2402, and 3402 may include a bent section or a portion that flares away from the longitudinal axis L of the planter row unit 400. The shields 402, 1402, 2402, and 3402 can be made of a rigid material as illustrated in FIG. 26 for shield 402. The shields 402, 1402, 2402, and 3402 can be made of a flexible material, or a combination of a rigid upper section 4406 positioned above a flexible lower section 4408 as illustrated in FIG. 27 for shield 402. The shields 402, 1402, 2402, and 3402 can be made of any combination of rigid, flexible, or semi-flexible materials. The shields 402, 1402, 2402, and 3402 can be made of flexible materials such as rubber or flexible plastic.

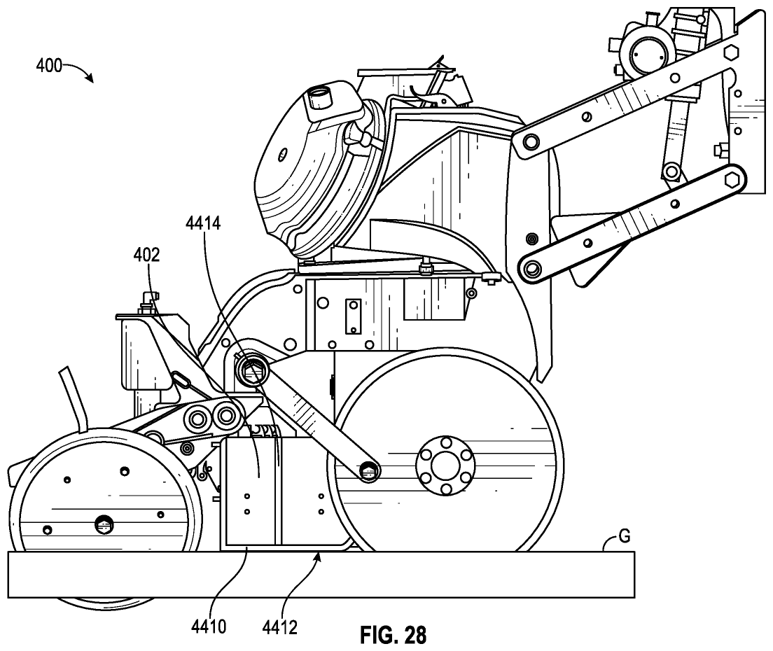

The shields 402, 1402, 2402, and 3402 can include additional mechanisms such as brushes, curtains, rubber flaps, or a ski member, attached thereto. In one embodiment illustrated in FIG. 28, the shield 402 includes a ski member 4410 attached to one or both of the bottom edges 458 and 460 of the first and second shield components 454 and 456. The ski member 4410 includes a smooth bottom surface 4412 that enables the shield 402 to ride on or travel over the ground surface G. In one form, the shield 402 is made of a flexible material and the ski member 4410 is attached thereto. The ski member 4410 may include one or more arms 4414 that are configured to attach the ski member 4410 to the shield 402. The one or more arms 4414 may be made of rigid material.

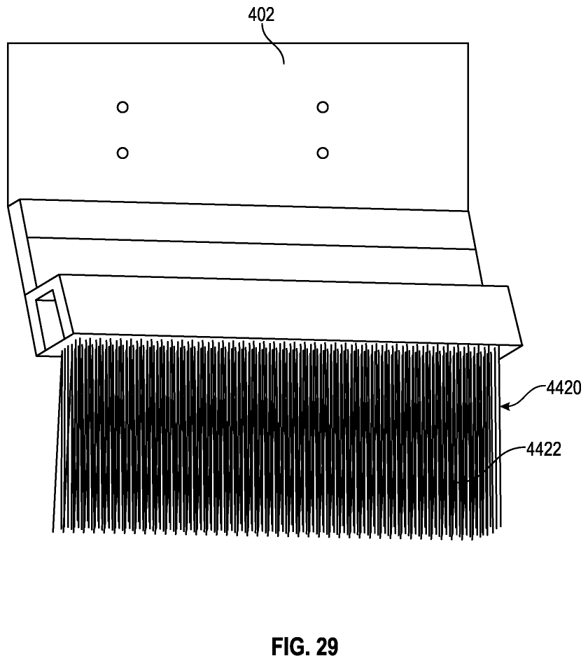

In another embodiment illustrated in FIG. 29, the shield 402 includes a brush member 4420 attached to one or both of the bottom edges 458 and 460 of the first and second shield components 454 and 456. The brush member 4420 includes a plurality of bristles or a curtain 4422 that travel over the ground surface G. In one form, the shield 402 is made of a flexible material and the brush member 4420 is attached thereto. The brush member 4420 may include one or more arms 4424 that are configured to attach the brush member 4420 to the shield 402.

The planter may include any of the shields 402, 1402, 2402, and 3402, wherein specific ones of the shields 402, 1402, 2402, and 3402 are attached at designated locations on the planter row units 400 of the planter. The shields 402, 1402, 2402, and 3402 may be beneficial for certain planting conditions or planting rows. The lateral position on the planter and environmental conditions may also affect which of the shields 402, 1402, 2402, and 3402 are placed at the planter row units 400. For example, the center planter row units 400 of the planter have the shields 402 attached thereon, the outer planter row units 400 have the shields 1402 attached thereon, and the planter row units 400 near the tires of the planter may have the shields 2402 attached thereon. As another example, the center planter row units 400 of the planter have the shields 1402 attached thereon, the outer planter row units 400 have the shields 2402 attached thereon, and the planter row units 400 near the tires of the planter may have the shields 402 attached thereon. Other arrangements of the shields 402, 1402, 2402, and 3402 on the planter row units 400 of the planter are within the scope of this application.

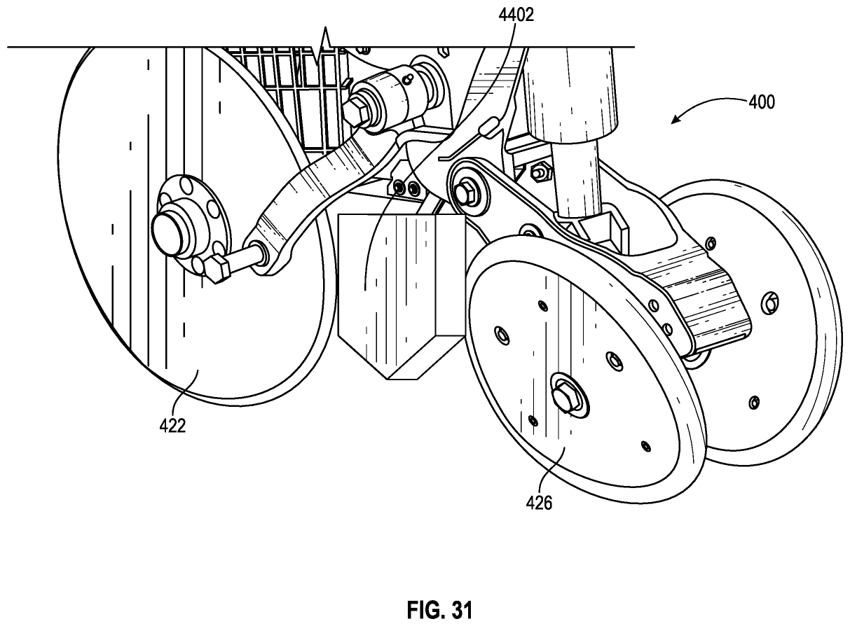

Another embodiment of a shield 4402 is illustrated in FIG. 31 wherein the shield 4402 is any type of device that provides an airflow such as compressed air in a downward direction towards the ground surface G. Some example embodiments of the shield 4402 include a blower, air knife, air curtain, fan, or other type of airflow. The shield 4402 can be positioned behind the pair of furrow opening disks 422 or inboard of the pair of furrow opening disks 422. The shield 4402 purges the air around the camera or imaging unit 62 or camera lens unit of the visualization system 404 to help clear the pollutants including dirt and dust from the air to improve the camera line of visualization CV of the camera and the image 100 from the structured light unit 64. The shield 4402 can be assembled with any of the shields 402, 1402, 2402, and 3402. In the embodiments that the shield 4402 can be assembled with any of the shields 402, 1402, 2402, and 3402, the shield 4402 may also operate to clean or purge pollutants such as dirt or mud from the shields 402, 1402, 2402, and 3402. In one embodiment, the shield 4402 is not visible in the camera line of visualization CV of the camera or imaging unit 62. In another embodiment, a portion or all of the shield 4402 is visible in the camera line of visualization CV of the camera or imaging unit 62.

The shields 402, 1402, 2402, and 3402 can include one or more exterior properties that improve the camera's performance. For example, the shields 402, 1402, 2402, and 3402 may include a certain exterior surface color or surface pattern that reduces the sunlight and/or glare from the sun in the light plane LP and/or the camera line of visualization CV of the camera and improves computer processing by the visualization system 404. Some colors for the exterior surface of the shields 402, 1402, 2402, and 3402 include matte black, black, brown, green, or other dark colors, or alternatively the shields 402, 1402, 2402, and 3402 can be white, off white, or other light colors. In some embodiments, the exterior surfaces of the shields 402, 1402, 2402, and 3402 include a first portion that is a dark color and a second portion that is a light color.

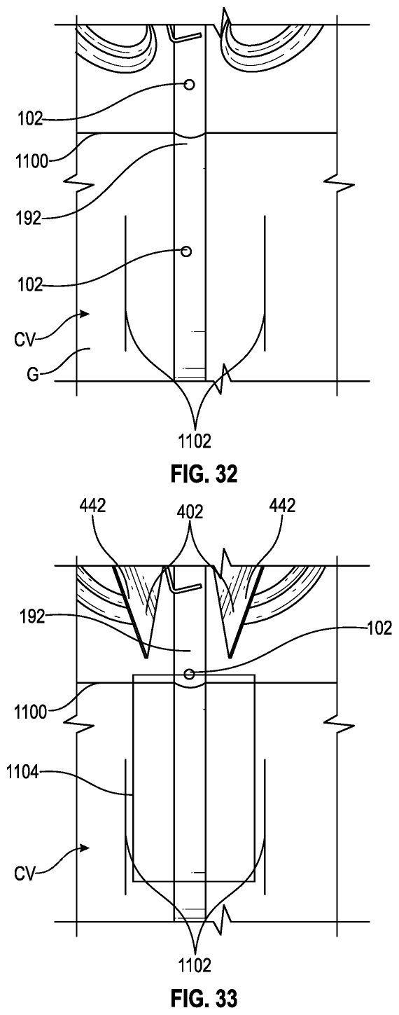

The shields 402, 1402, 2402, and 3402 may or may not be visible in the camera field of view CV. In FIG. 32, none of the shields 402, 1402, 2402, and 3402 are visible in the camera field of view CV. FIG. 32 illustrates the camera field of view CV that includes the actual trench or furrow 192 in the field or in the ground surface G and the seed or commodity 102 placed in the trench 192 but none of the shields 402, 1402, 2402, and 3402 are positioned such that they are visible in the camera field of view CV. FIG. 32 illustrates the structured light unit 64 that projects a single line laser or a two-dimensional (2D) laser or light plane LP of light toward the ground surface G, and an image 1100 illustrated as a line. The image 1100 is a single line in FIG. 32, but more complicated patterns such as multiple lines, grids, or dots could be used in order to have more 3D points. In the illustrated embodiment, the visualization system 404 includes another light source that projects a pair of guideline lights 1102 that are positioned exterior to the actual trench or furrow 192. The pair of guideline lights 1102 assist the operator driving the planter and/or the visualization system 404 to maintain the camera field of view CV positioned or oriented along the actual trench or furrow 192.

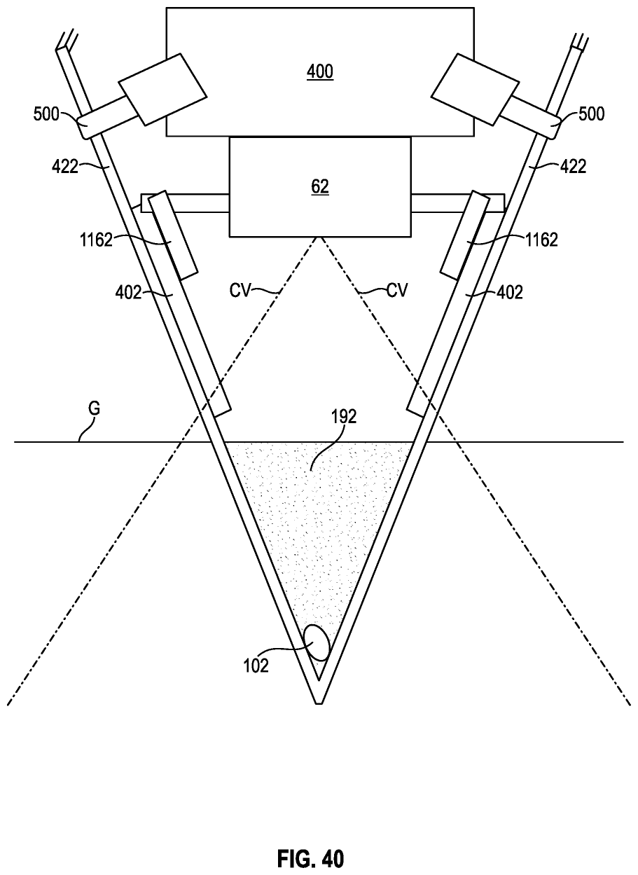

FIGS. 33 and 40 illustrate the camera field of view CV that includes the actual trench or furrow 192 in the field or in the ground surface G and the seed or commodity 102 placed in the trench 192 but a small portion of the shields 402 are positioned such that they are visible in the camera field of view CV. Although shields 402 are illustrated, any of the shields 1402, 2402, and 3402 may be used therefore shields 402 are exemplary. The shields 402 are positioned relative to the pair of furrow opening disks 422 such that the first or front portion 440 of each of the shields 402 are directly adjacent or behind the pair of furrow opening disks 422 and the second or rear portion 442 of each of the shields 402 extends away from the pair of furrow opening disks 422 towards the closing wheels 426 but the second or rear portion 442 does not extend beyond the light plane LP of light on the ground surface G. The second or rear portion 442 protrudes rearward of the pair of furrow opening disks 422 by a small amount such as 2 to 3 inches. The second or rear portion 442 is visible in the camera field of view CV in FIG. 33. FIG. 33 illustrates the structured light unit 64 that projects the single line laser or a two-dimensional (2D) laser or light plane LP of light toward the ground surface G, and the image 1100 illustrated as a line. The image 1100 is a single line in FIG. 33, but more complicated patterns such as multiple lines, grids, or dots could be used in order to have more 3D points. In the illustrated embodiment, the visualization system 404 includes another light source that projects the pair of guideline lights 1102 that are positioned exterior to the actual trench or furrow 192. The pair of guideline lights 1102 assist the operator driving the planter and/or the visualization system 404 to maintain the camera field of view CV positioned or oriented along the actual trench or furrow 192. Also illustrated in FIG. 33 is a camera zoom area 1104 that is a smaller area for the camera field of view CV wherein the camera or imaging unit 62 is zoomed in to a different angle than illustrated in FIG. 32. Illustrated in FIG. 40, the shields 402 are attached to the camera or imaging unit 62 or the shields 402 are attached to an imaging unit frame 1162 wherein the imaging unit 62 is mounted to the imaging unit frame 1162. The imaging unit frame 1162 is attached to the planter row unit 400.

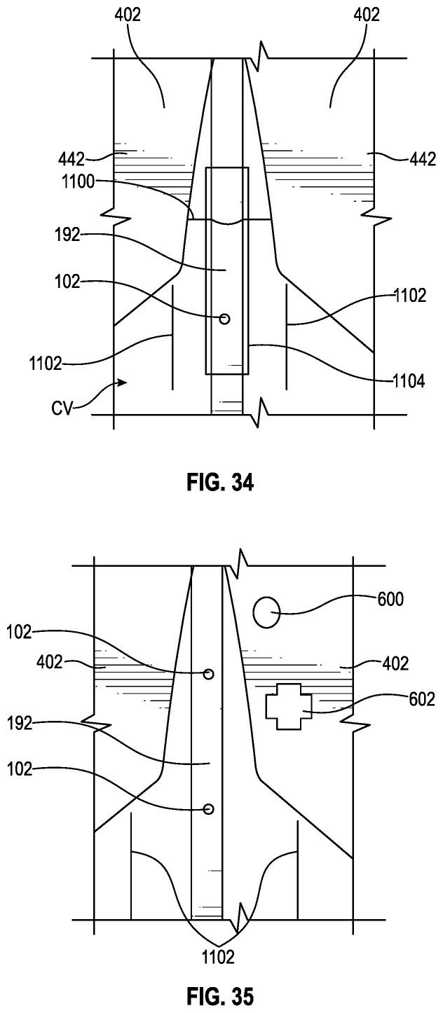

FIG. 34 illustrates the camera field of view CV that includes the actual trench or furrow 192 in the field or in the ground surface G and the seed or commodity 102 placed in the trench 192 but a large portion of the shields 402 are positioned such that they are visible in the camera field of view CV. Although shields 402 are illustrated, any of the shields 1402, 2402, and 3402 may be used therefore shields 402 are exemplary. The shields 402 are positioned relative to the pair of furrow opening disks 422 such that the first or front portion 440 of each of the shields 402 are directly adjacent or behind the pair of furrow opening disks 422 and the second or rear portion 442 of each of the shields 402 extends away from the pair of furrow opening disks 422 towards the closing wheels 426 and extends beyond the light plane LP of light on the ground surface G. The second or rear portion 442 has a length that extends from the outer diameter of the furrow opening disk 422 to a position that is located between the opening and closing wheels 422 and 426 wherein the position includes all of or portions of the camera line of visualization CV of the camera and the light plane LP from the structured light unit in the visualization system 404. A larger or longer amount of the second or rear portion 442 is visible in the camera field of view CV in FIG. 34 as compared to FIG. 33. In one embodiment, the second or rear portion 442 protrudes rearward of the pair of furrow opening disks 422 by about 7 to 8 inches. FIG. 34 illustrates the structured light unit 64 that projects the single line laser or a two-dimensional (2D) laser or light plane LP of light toward the ground surface G, and the image 1100 illustrated as a line. The image 1100 is a single line in FIG. 34, but more complicated patterns such as multiple lines, grids, or dots could be used in order to have more 3D points. In the illustrated embodiment, the visualization system 404 includes another light source that projects the pair of guideline lights 1102 that are positioned exterior to the actual trench or furrow 192. The pair of guideline lights 1102 assist the operator driving the planter and/or the visualization system 404 to maintain the camera field of view CV positioned or oriented along the actual trench or furrow 192. Also illustrated in FIG. 34 is a camera zoom area 1104 that is a smaller area for the camera field of view CV wherein the camera or imaging unit 62 is zoomed into a different angle than illustrated in FIG. 33. The camera zoom area 1104 in FIG. 34 is smaller than the camera zoom area 1104 in FIG. 33.

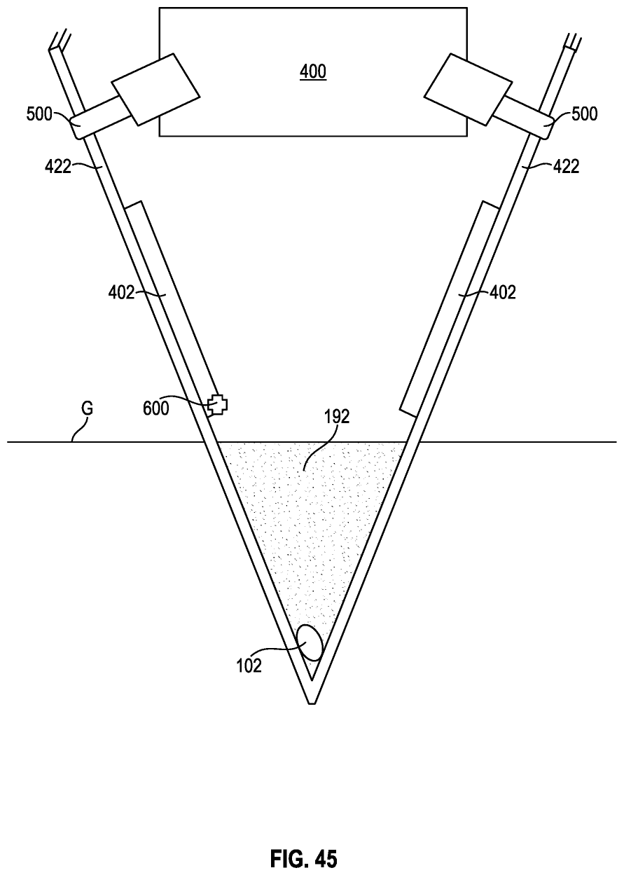

The shields 402, 1402, 2402, and 3402 can include another exterior property such as a first marker 600 and/or a second marker 602 that are used with the visualization system 404 to improve calibration of the visualization system 404, the camera or imaging unit 62, and the structured light unit and any other lights in the visualization system 404. The first and/or second markers 600 and 602 can be used in diagnostics of camera or imaging unit 62. The first and/or second markers 600 and 602 can be used to assist with alignment of the camera or imaging unit 62, the structured light unit, other lights, and the visualization system 404. The first and/or second markers 600 and 602 can be an artifact on the exterior surface of the shields 402, 1402, 2402, and 3402 wherein the visualization system 404 determines if the artifact is seen or not by the camera or imaging unit 62, and if the artifact is seen by the camera or imaging unit 62 then the visualization system 404 will determine if the artifact is in focus or blurry and not clearly seen as illustrated in FIG. 45. If the visualization system 404 determines the artifact appears as blurry or out of focus by the camera or imaging unit 62, then a warning can be sent to the planter row unit 400, the planter, and the operator. The first marker 600 is in the shape of a circle and the second marker 602 is in the shape of a cross or T. The first and/or second markers 600 and 602 can be other shapes such as a triangle, square, rectangle, or another lettered shape, to name a few examples.

In one embodiment of a calibration procedure the camera or imaging unit 62 attempts to capture an image of any of the first and/or second markers 600 and 602. If the camera or imaging unit 62 is not able to capture the image of any of the first and/or second markers 600 and 602, then a warning is sent to the operator and/or the planter row unit 400. The warning can indicate that the camera or imaging unit 62 is not able to capture the image and the visualization system 404 is not operable. If the camera or imaging unit 62 is able to capture the image of any of the first and/or second markers 600 and 602, then the controller 80 is operable to determine a location of any of the first and/or second markers 600 and 602. The controller 80 can then calibrate the visualization system 404.

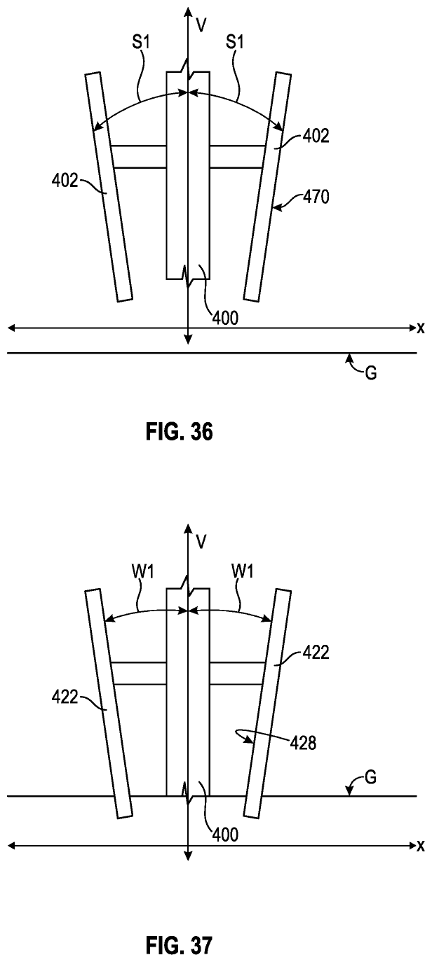

FIG. 36 illustrates the shields 402 mounted on the planter row unit 400 at a shield angle S1 that is measured between the outside faces 470 of the shields 402 and a plane that is defined by the intersection of the longitudinal axis L and the vertical axis V of the planter row unit 400. It is contemplated the outside faces 479, rather than the outside faces 470, of the shields 402 can be used to measure the shield angle S1. FIG. 37 illustrates the inboard sides 428 of the furrow opening disks 422 mounted on the planter row unit 400 at a disk angle W1 that is measured between the inboard sides 428 of the furrow opening disks 422 and the plane that is defined by the intersection of the longitudinal axis L and the vertical axis V of the planter row unit 400. In one form, the shield angle S1 matches or is the same as the disk angle W1 such that at least one of the outside faces 470, 479 of the shields 402 are in the same plane as the inboard sides 428 of the furrow opening disks 422. In this form, at least one of the outside faces 470, 479 of the shields 402 are oriented substantially planar to the respective inboard sides 428 of the furrow opening disks 422. In one embodiment, the disk angle W1 and the shield angle S1 are 32 degrees. It should be appreciated that the shields 402 are used in a field during planting and may occasionally contact the ground surface G which can result in bending a portion of the shields 402 such that the shield angle S1 no longer matches the disk angle W1. In another embodiment, the disk angle W1 and the shield angle S1 are between 25 and 45 degrees. In yet another embodiment, the disk angle W1 and the shield angle S1 are different from each other or may be within a few degrees of each other. Any of the shields 1402, 2402, 3402, and 4402 can be positioned at the shield angle S1. The shields 402 are configured for attachment to the planter row unit 400 as described previously.

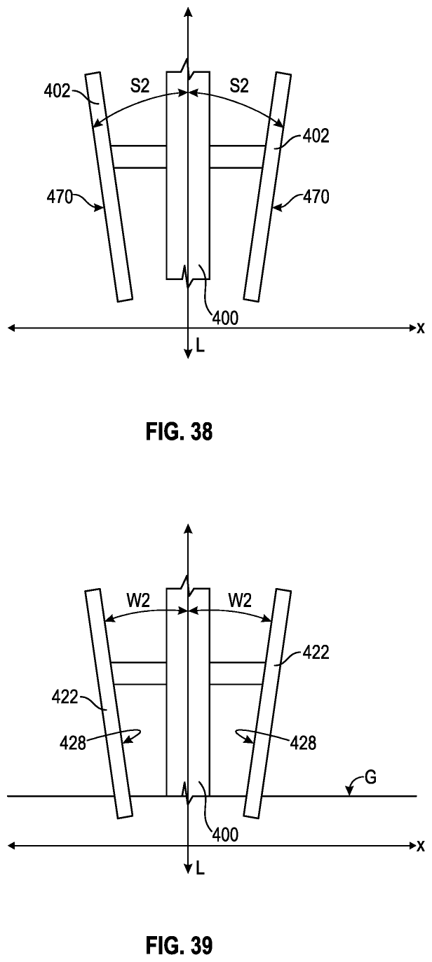

FIG. 38 illustrates the shields 402 mounted on the planter row unit 400 at the second shield angle S2 that is measured between the outside faces 470 of the shields 402 and a plane that is defined by the intersection of the vertical axis V and the horizontal axis X of the planter row unit 400. It is contemplated the outside faces 479, rather than the outside faces 470, of the shields 402 can be used to measure the second shield angle S2. FIG. 39 illustrates the inboard sides 428 of the furrow opening disks 422 mounted on the planter row unit 400 at the second disk angle W2 that is measured between the inboard sides 428 of the furrow opening disks 422 and the plane that is defined by the intersection of the vertical axis V and the horizontal axis X of the planter row unit 400. In one form, the second shield angle S2 matches or is the same as the second disk angle W2 such that at least one of the outside faces 470, 479 of the shields 402 are in the same plane as the inboard sides 428 of the furrow opening disks 422. In this form, at least one of the outside faces 470, 479 of the shields 402 are oriented substantially planar to the respective inboard sides 428 of the furrow opening disks 422. It should be appreciated that the shields 402 are used in a field during planting and may occasionally contact the ground surface G which can result in bending a portion of the shields 402 such that the second shield angle S2 no longer matches the second disk angle W2. In yet another embodiment, the second disk angle W2 and the second shield angle S2 are different from each other or may be within a few degrees of each other. Any of the shields 1402, 2402, 3402, and 4402 can be positioned at the second shield angle S2. The shields 402 are configured for attachment to the planter row unit 400 as described previously.

The shields 402, 1402, 2402, 3402, and 4402 have been shown to make a significant improvement in the camera line of visualization CV of the camera, the visibility of the light plane LP from a structured light unit and any other lights, and the visualization system 404 to thereby improve the image 100 and 1100.

The present application provides an imaging system, an imaging method, and an image processing computer readable instructions, embodied on a computer readable medium, that have many of the aspects of the systems, methods, and computer readable media mentioned heretofore and many novel features that result in the obtaining and generating of seed planting related metrics which can be used as feedback in real-time and/or offline to inform a planting operator of actionable responses, inform a planting operator of hysteresis such as for a long-term suboptimal planting condition, and/or automate planting vehicle adjustments and based on real time planting quality assessment. For example, the operator may manually operate the planting device based on the actionable responses or the operation of the planting device may be automated or autonomous based on real time planting quality assessments thereby avoiding manual operation by the operator. Additionally, the real time planting quality assessments may be archived for future agronomic uses.

Moreover, optical imaging techniques may be utilized to predict seed location and depth. The imaging system may comprise one or more imagers, passive or active illumination, a structured light unit, and a programmed processor to capture optical data of a seed or commodity falling or placed into an open furrow and produce a model which predicts where the seed or commodity may be located after the furrow is closed. Passive illumination includes ambient sunlight. Active illumination is lighting whose direction and intensity are controlled by commands or signals. An example embodiment of active illumination is a light source that is synchronized with a frame rate on an imaging apparatus or a camera. A structured light unit projects a known or patterned shape of light, such as a laser grid, lines, dots or other shapes onto a field of view of the one or more imagers. Based on the geometric relationship between the one or more imagers and the structured light unit, a three-dimensional or 3D location of the projected light is measured. The spectrum of the structured light unit could be in the visible range for a visible range imager or camera such as a color camera, or the spectrum of the structured light unit could be in the near infrared (NIR), infrared (IR) or other non-visible range for better visibility in a challenging condition such as when the planter row unit is operable in a dusty, rainy, foggy, or other visually difficult situations.

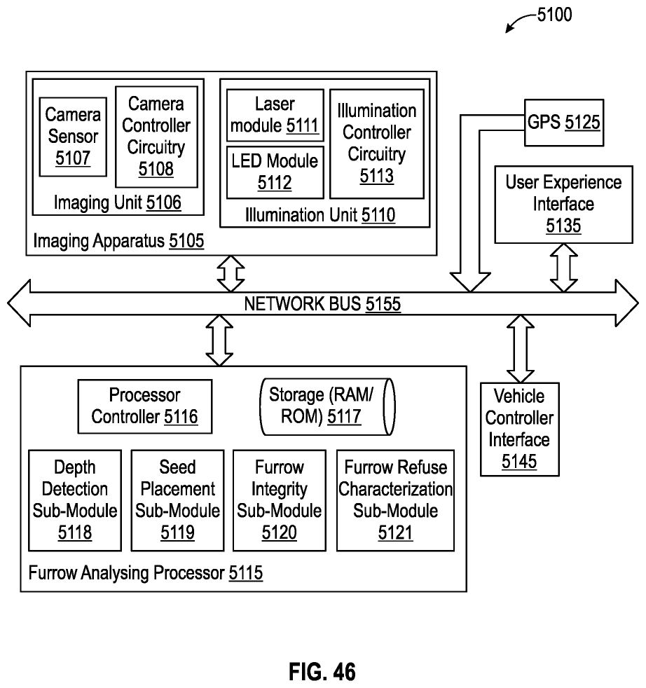

Turning now to FIG. 46, one embodiment of an imaging system 5100 is illustrated. A planting vehicle may be coupled to the imaging system 5100. One embodiment of a planting vehicle is a planter row unit 5600 which is similar to planter row unit 14 described above unless noted otherwise, therefore the planter row unit 5600 includes similar reference numbers as the planter row unit 14. The imaging system 5100 includes an imaging apparatus 5105 operably coupled to a furrow analyzing processor 5115. The furrow analyzing processor 5115 is configured to execute computer readable instructions embodied on a computer readable medium. Optionally, the imaging system 5100 may further comprise a GPS device 5125, a user experience interface (UI) 5135, and a vehicle controller interface 5145, communicatively and/or operably coupled as illustrated via a network bus 5155. Imaging apparatus 5105 may further comprise an imaging unit 106 and an illumination unit 5110, which will be described in further detail below.

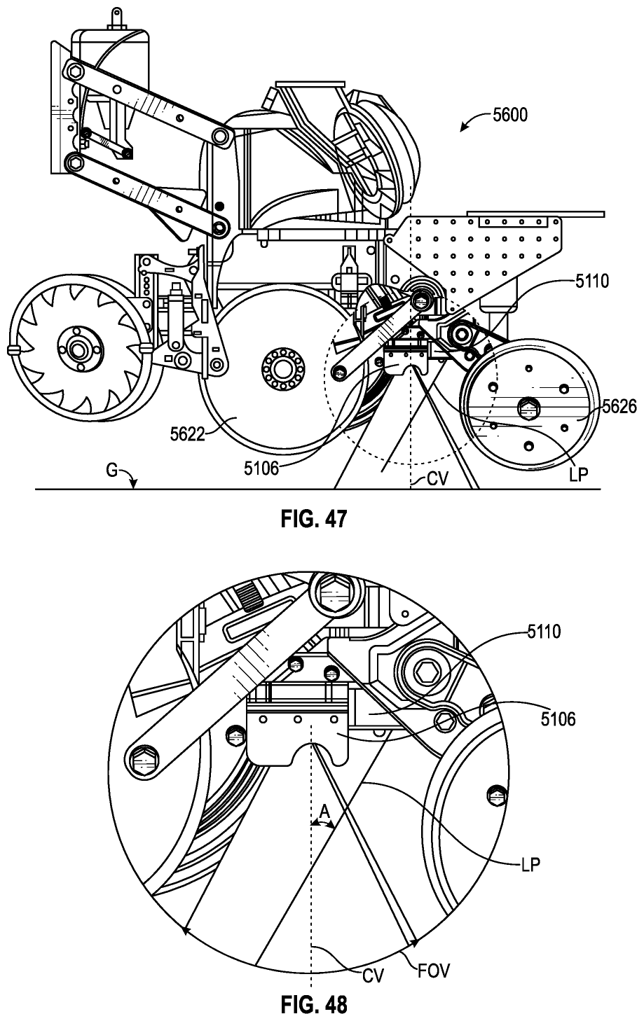

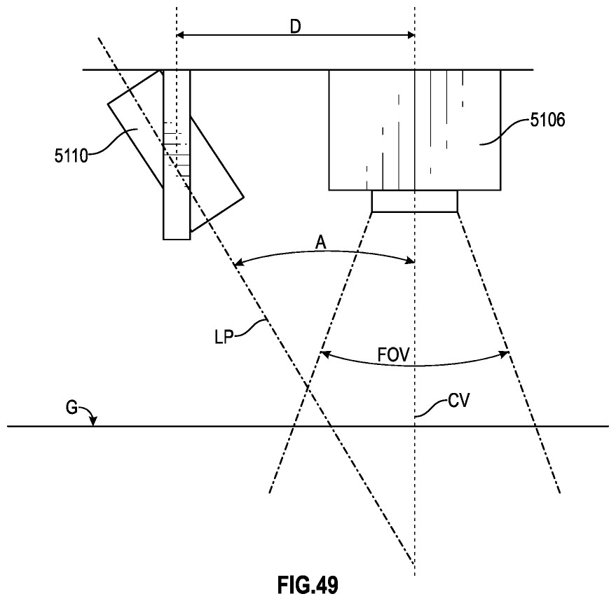

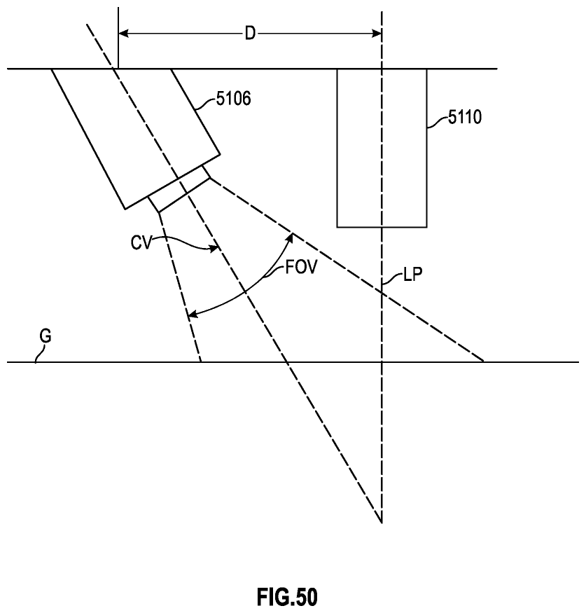

In many embodiments of the present application, and now with reference to FIGS. 47 and 48 below, the imaging apparatus 5105 is fixedly coupled to an undercarriage portion of the planting row unit 5600, between a furrow opening mechanism or disk 5622 and a furrow closing mechanism or closing wheel 5626 of the planting row unit 5600, wherein a principle optical axis or in some embodiments a camera line of visualization CV of the imaging unit 5106 is perpendicular to the ground surface G. In other embodiments, the imaging apparatus 5105 is coupled to the undercarriage portion of the planting row unit 5600 wherein the principle optical axis or in some embodiments a camera line of visualization CV of the imaging unit 5106 forms a non-perpendicular angle relative to the ground surface G. Moreover, a projection axis or in some embodiments a light plane LP of the illumination unit 5110 may be angularly offset from the principle optical axis CV of the imaging unit 106 by an angle (A) such that a field of view (FOV) of the imaging unit 5106 captures projected illumination ground reflections from the illumination unit 5110 as the projected illumination reflects projected light off the ground G, within the FOV of the imaging unit 5106. In an alternative embodiment, the illumination unit 5110 is perpendicular to the ground surface G such that the light plane LP is perpendicular to the ground surface. In this embodiment, the imaging unit 5106 is angularly offset from the light plane LP axis by an angle (A) such that a field of view (FOV) of the imaging unit 106 captures projected illumination ground reflections from the illumination unit 110 as the projected illumination reflects projected light off the ground G, within the FOV of the imaging unit 5106. The camera or imaging unit 5106 is laterally or horizontally offset a distance D from the illumination unit 5110. In some embodiments, the camera or imaging unit 5106 is vertically offset a distance V from the illumination unit 5110. FIGS. 49 and 50 include exemplary illustrations further illustrating the distance D, the FOV and projected illumination offset configuration of the illumination unit 5110 from the imaging unit 5106. In some embodiments, the illumination unit 5110 is attached to the planting row unit 5600 such that the illumination unit 5110 is aligned with the imaging apparatus 5105 such that the principle optical axis or the camera line of visualization CV is aligned with the light plane LP. In any embodiments, the geometric and distance relationships between the principle optical axis or the camera line of visualization CV of the imaging apparatus 5105 and the light plane LP of the illumination unit 110 is known.

In any embodiment, the camera or imaging unit 5106 is oriented to point down towards the ground surface G at the actual trench that is formed by the pair of furrow opening disks 5622. The camera or imaging unit 5106 also points down toward the projected light from the illumination unit 5110 at the actual trench (not illustrated) in the ground surface G. In any embodiment, the camera or imaging unit 5106 has a camera line of visualization CV that intersects with a light plane LP from the illumination unit 5110 to form an angle A there between. The angle A can be less than 90 degrees, 90 degrees, or an obtuse angle. The illumination unit 5110 projects a narrow band of light across the actual trench (not illustrated) to produce a line of illumination or patterned light that appears distorted from perspectives other than that of the illumination unit 5110. The illumination unit 5110 points towards the ground surface G and the actual trench formed therein. In any embodiment, the illumination unit 5110 and the camera or imaging unit 5106 are accurately calibrated relative to each other. The illumination unit 5110 includes a single laser or single light source that projects a single line, multiple lines, dots, cross, triangle, or other known pattern of light, collectively “patterned light” on the trench in the ground surface G.

With reference to FIG. 51 includes an exemplary illustrative example of a scene that is expected to be captured by the imaging apparatus 5105, in juxtaposition with an exemplary real world test image captured by imaging apparatus 5105 in FIG. 52. As will be discussed in further detail below, attributes of the imaged projected illumination reflections may become altered or distorted in response to the structure and shape characteristics of a created furrow. FIGS. 51 and 52 represent a control situation wherein a furrow and surrounding soil are of optimal structure, shape, and composition. It is noted that as a created furrow and surrounding soil become less optimal with respect to structure, shape, and composition, projected illumination reflections may be imaged as having distorted aspects with respect to the illustration in FIG. 51. These distorted aspects may be detected by processing steps of embodiments of the present application.

Referring back to FIG. 46, the imaging apparatus 5105, may comprise an imaging unit 5106 and an illumination unit 5110. In many embodiments, the imaging unit 5106 further comprises a camera sensor 5107. In the present embodiment, the camera sensor 5107 is a monochrome, visible-light range, imaging sensor. The camera sensor 5107 can be similar to the camera or imaging unit 62. In other embodiments, the camera sensor 5107 may comprise a plurality of sensors and sensor types. In yet other embodiments, the imaging unit 5106 and sensor 5107 are configured differently and may include infrared radar, push broom lidar scanner, lidar scanner, optical imagers, infrared camera, or other imaging techniques, to thereby collect image data. The imaging unit 5106 further comprises camera controller circuitry which is configured to synchronize camera exposure based on vehicle speed and illumination operations. In one form, the imaging unit 5106 is synchronized to placement of the commodity or seed into the open furrow, vehicle speed, and illumination operation to ensure that the commodity or seed is positioned in about the same location in the captured image.

In some embodiments, the illumination unit 5110 may comprise a plurality of the illumination devices wherein some devices are configured to provide environment illumination and other devices configured to provide projected target illumination so as to add objects to the scene which may be imaged. For example, an ultraviolet LED could be an illumination device added to image nitrogen or fertilizer. An infrared LED could be an illumination device added to image residue or other material that is not a commodity but is found in the furrow. Therefore different materials can be imaged by varying the type of illumination device or the number of illumination devices.

In the present embodiment, by way of illustrative example, the illumination unit 5110 comprises a laser module 5111 configured to project target illumination (see FIG. 52), and an LED module 5112 configured to spread cast illumination to the vehicle undercarriage environment (see FIG. 52). The illumination unit 5110 comprises the laser module 5111 and the LED module 5112 in one unit but in other embodiments the laser module 5111 and the LED module 5112 are separated from each other. The laser module 5111 is configured to project target illumination such as for a structured light described previously. As illustrated in FIG. 52, the laser module 5111 projects a straight line which forms a V shape on a furrow in the ground surface G. The LED module 5112 is a flash or active illumination as described previously. The illumination unit 110 also comprises illumination controller circuitry 5113 which is configured to dynamically adjust operating illumination of the laser module 5111 and/or the LED module 5112. The illumination unit 5110 can control operation of the laser module 5111 independently from operation of the LED module 5112. The illumination unit 5110 can control operation of the laser module 5111 to project a targeted illumination with operation of the LED module 5112 occurring simultaneously or separately and not at the same time as operation of the laser module 5111. One embodiment that can occur, wherein the LED module 5112 is not operated, is if there is sufficient passive illumination that active illumination from the LED module 5112 is not needed to adequately capture an image by the camera sensor 5107.

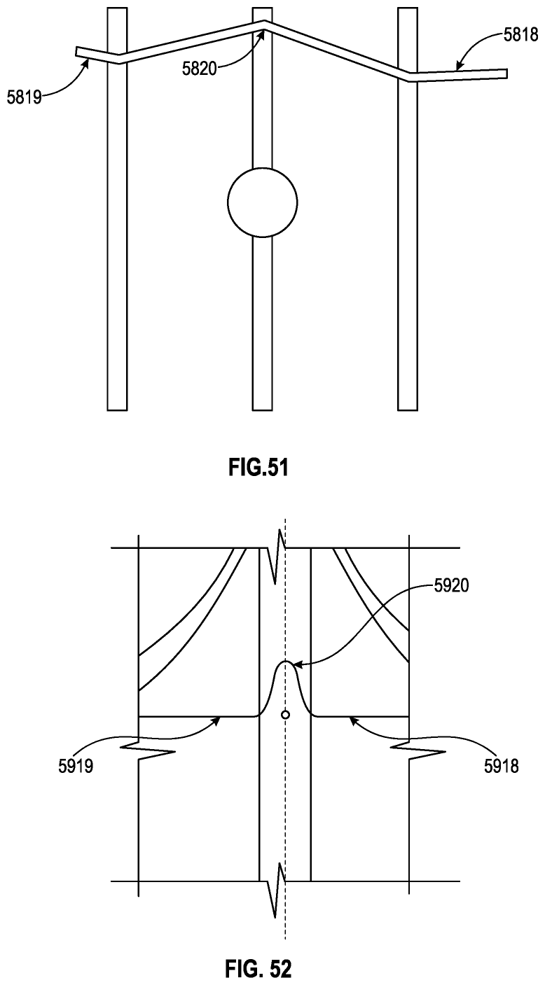

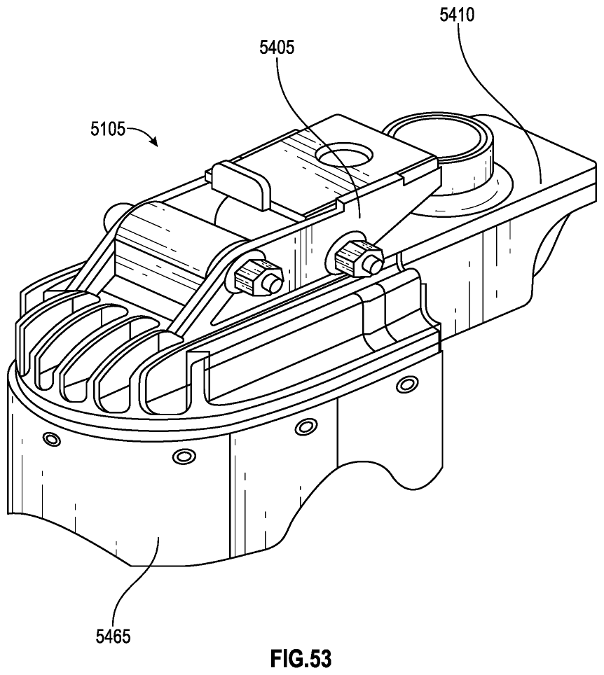

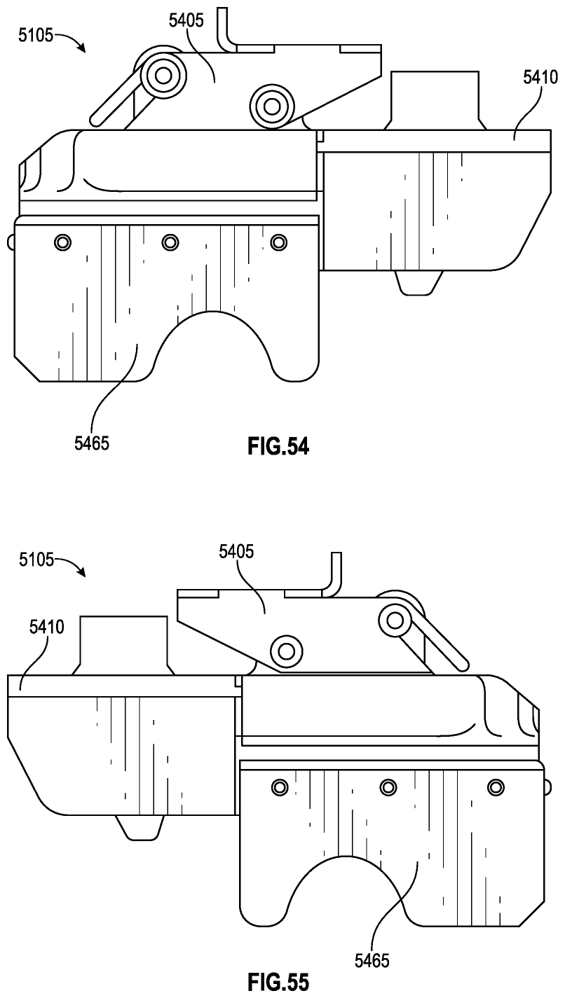

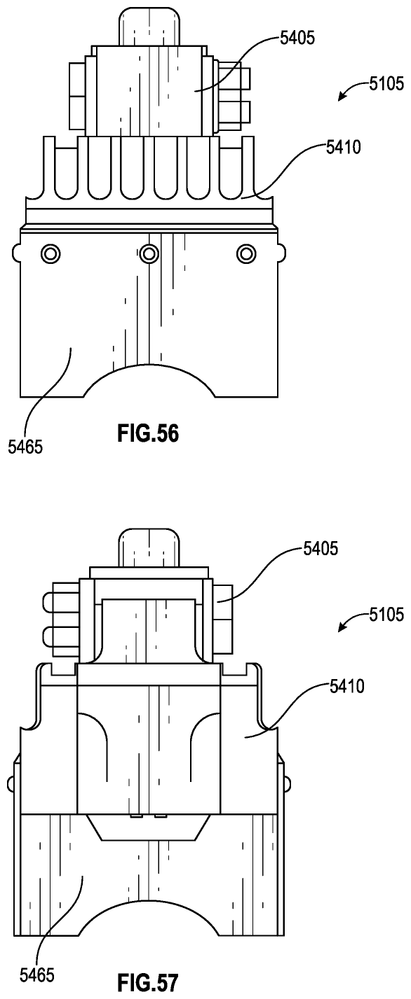

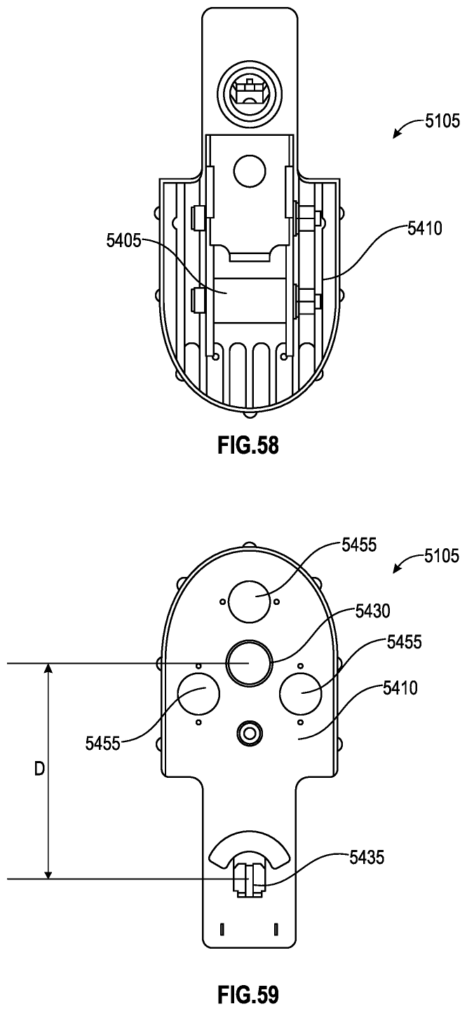

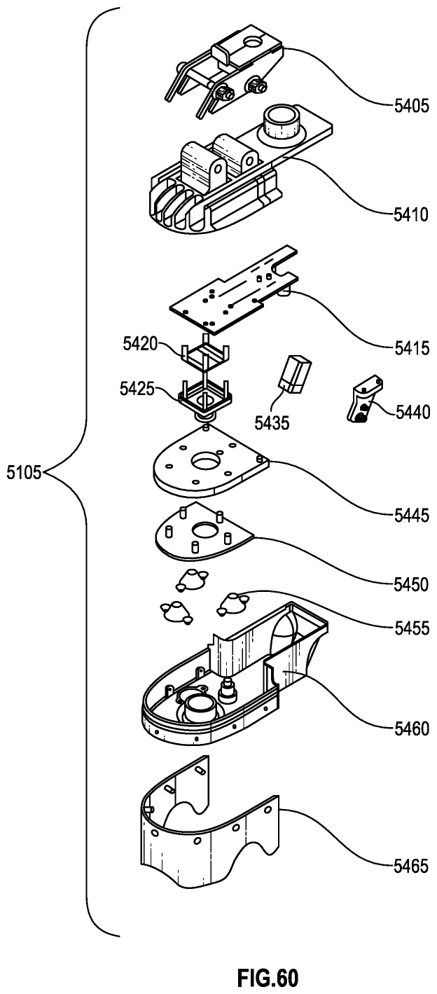

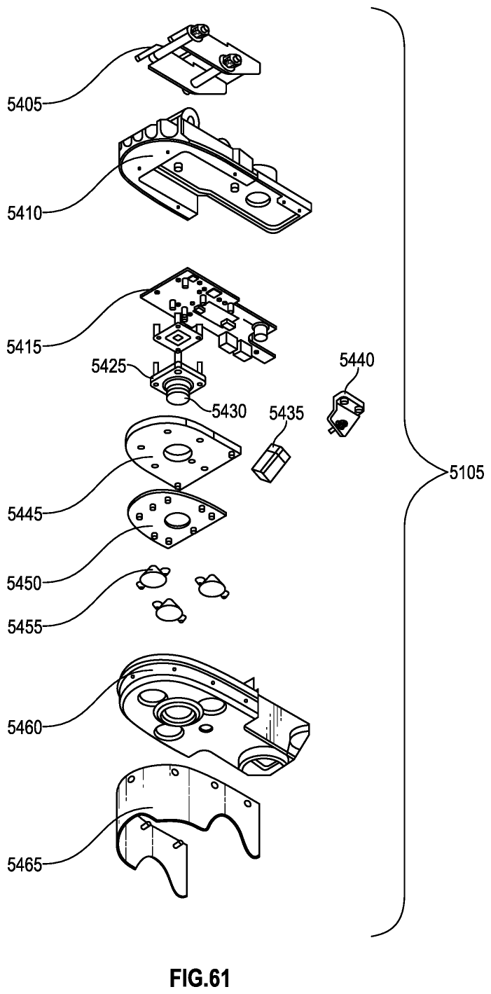

Now with reference to FIGS. 53 through 63, an exemplary configuration of the imaging apparatus 105 is illustrated and described. FIG. 52 illustrates an isometric view of an outer portion of an embodiment of the imaging apparatus 5105. FIGS. 52 and 53 illustrate opposing side views respectively of an outer portion of an embodiment of the imaging apparatus 5105. FIGS. 54 and 55 illustrate front and back views, respectively, of an outer portion of an embodiment of the imaging apparatus 5105. FIGS. 56 and 57 illustrate top (vehicle facing) and bottom (soil facing) views, respectively, of an outer portion of an embodiment of the imaging apparatus 5105. FIGS. 58 and 59 respectively illustrate isometric angled views of an exploded configuration of the imaging apparatus 5105 in accordance with an embodiment of the present application. FIGS. 60 and 61 respectively are isometric angled views of an exploded configuration of the imaging apparatus 5105 of FIG. 53.

With continued reference to FIGS. 58 and 59, the imaging apparatus 5105 may comprise a mounting component 5405, a base plate heat sink mounting component 5410, a synchronization board 5415, an imaging sensor coupled circuit board 5420, an imaging sensor lens mounting component 5425, an imaging sensor lens 5430, a laser module 5435, a laser mounting component 5440, an LED heat spreading component 5445, an LED PCBA apparatus 5450 containing a plurality of LEDs, a plurality of LED lens 5455, an imaging apparatus covering component 5460, and a shielding component 5465. In this illustrated embodiment, the laser module 5435 and the laser mounting component 5440 are separate and a distance from the plurality of LEDs and the plurality of LED lens 5455. In other embodiments, the laser module 5435 and the laser mounting component 5440 are assembled with the plurality of LEDs and the plurality of LED lens 5455.

The LED PCBA apparatus 5450 containing the plurality of LEDs and the plurality of LED lens 5455 includes three LEDs and three of the plurality of LED lens 5455. In other embodiments, the LED PCBA apparatus 5450 may contain fewer or more of the plurality of LEDs and the plurality of LED lens 5455. In the illustrated embodiment, the plurality of LEDs and the plurality of LED lens 5455 are arranged or positioned around the imaging sensor lens 5430. In other embodiments, the plurality of LEDs and the plurality of LED lens 5455 may be arranged differently relative to the imaging sensor lens 5430.

The laser module 5435 and the laser mounting component 5440 are mounted in-line with the imaging sensor lens 5430 in the illustrated embodiment. In other embodiments, the laser module 5435 and the laser mounting component 5440 may be mounted in a different position relative to the imaging sensor lens 5430. In any embodiment, the physical location and relationship is known for laser module 5435 and/or the laser mounting component 5440 relative to the imaging sensor lens 5430. The imaging sensor lens 5430 is laterally or horizontally offset a distance D from the laser module 5435 and the laser mounting component 5440. In other embodiments, the imaging sensor lens 5430 is vertically offset a distance V from the laser module 5435 and the laser mounting component 5440. Although one imaging sensor lens 5430 is illustrated, additional imaging sensor lens 5430 can be used with the laser module 5435 and the laser mounting component 5440. In any embodiment, the imaging sensor lens 5430 has a camera line of visualization CV that intersects with a light plane LP from the laser module 5435 to form an angle A there between. The imaging sensor lens 5430 is mounted between the pair of closing wheels 5626 and the pair of furrow opening disks 5622 or alternatively the imaging sensor lens 5430 is mounted between the pair of closing wheels 5626 and a seed delivery system (not illustrated). The laser module 5435 and the laser mounting component 5440 is also mounted between the pair of closing wheels 5626 and the pair of furrow opening disks 5622 or alternatively the laser module 5435 and the laser mounting component 5440 is mounted between the pair of closing wheels 5626 and the seed delivery system (not illustrated).

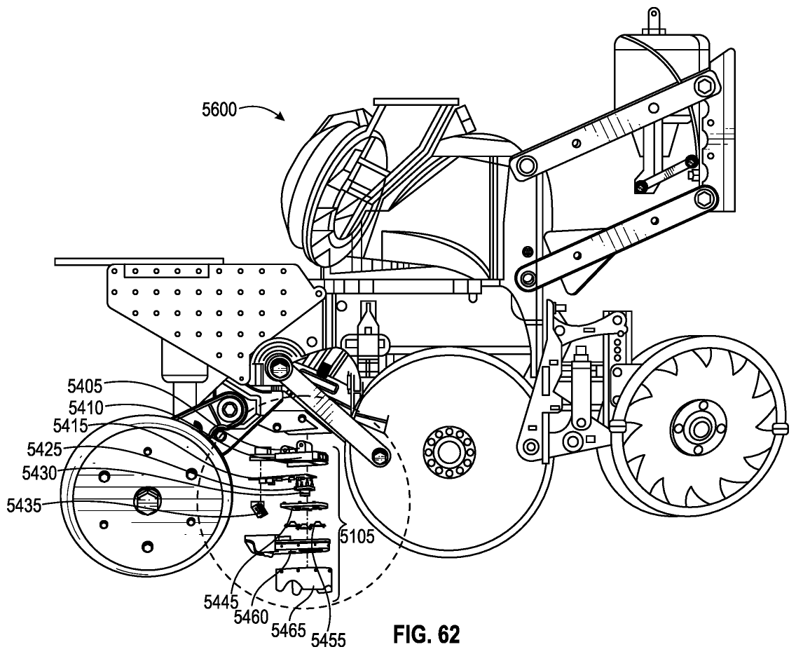

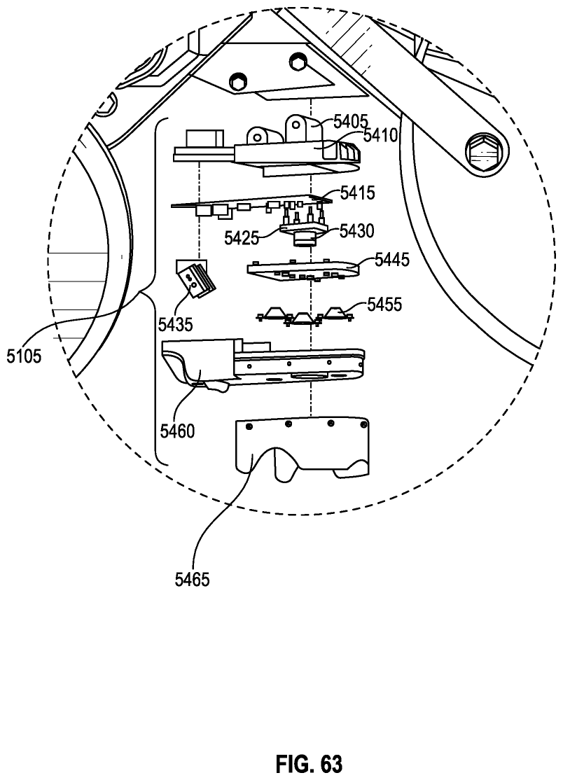

With reference to FIGS. 62 and 63, are illustrative views showing the elements of the imaging apparatus 5105 with respect to the planter row unit 5600, wherein the imaging apparatus elements are exploded for illustrative viewability.

Referring back to FIG. 46, the imaging system 5100 comprises a programmed processor 5115, referred to herein as furrow analyzing processor 5115, which may further comprise a processor controller 5116, RAM and ROM memory 5117, a seed depth detection submodule 5118, a seed placement detection submodule 5119, a furrow integrity submodule 5120, and a furrow refuse characterization submodule 5121.

With reference to FIGS. 47 through 67, the present description will now provide details directed towards the operation and method step execution of the imaging system 5100 as coupled to the planter row unit 5600 during a planting process. In many embodiments, the method steps are dependent on a type of captured image. That is, as noted below, several determination processes are described wherein a particular determination process is executed in response to the programmed processor triggering and receiving a particular type of captured image. In many embodiments, the illumination controller circuitry 5113 in conjunction with the camera controller circuitry 5108 and the LED module 5112 may be configured and operably coupled to actuate the shutter of the camera sensor 5107 according to a preprogrammed schedule wherein the schedule comprises a first exposure mode that includes capturing a calibration scene image frame, with a first exposure, once every 20 frames; a second exposure mode that includes capturing a projected laser line scene image (illumination based exposure), with a second exposure, once every five frames; and a third exposure mode that includes capturing LED active image frames of the scene when capturing image frames between the capturing of the first capturing mode and the second capturing mode. The differences between the first, second, and third exposure modes comprises different rates of imaging and/or different states of the laser module 5111 and the LED module 5112 such as whether the laser or structured light is projected or not. The exposure mode is defined by a combination of the shutter rate of the imaging unit 5106, LED illumination level of the LED module 5112, and the activation of the laser module 5111. The seed depth determination module captured images can include any mix of those variables as required or desired for a particular application. For example, in one embodiment, the first exposure mode comprises opening an imaging shutter of the imaging unit 5106 for 1 image per every 20 images, under full illumination level (or a predetermined level) of the laser module 5111. In this same embodiment, the second exposure mode comprises opening the imaging shutter of the imaging unit 5106 for 1 image per every 5 images, wherein the laser component is projected by the laser module 5111, and the projection constitutes the “second exposure” mode. In this embodiment, there is not an additional activation of LED Module 5112 for the second mode but in other embodiments, there could be additional activation of LED Module 5112. In this same embodiment, the third exposure mode captures images between the first mode (calibration used images), and the second mode (projected laser containing images).

For example, there is a first imaging state to capture images 1-4, 6-9, 11-14, and 16-19, a second imaging state to capture images 5, 10, 15, and 20, wherein, image 1 is used as a calibration image. Then, for the next twenty images, image 21 would be the calibration (first exposure mode) image, images 22-24, 26-29, 31-34, and 36-39 would be the third exposure mode images, and images 25, 30, 35, and 40 would be the second exposure mode images that have projected laser lines in them. In this example, the first exposure mode image is used as a calibration image.

In many embodiments, the LED illumination level and exposure time of the camera sensor 5107, during the first capturing mode, may be based on vehicle velocity. In other embodiments, each of the LED illumination level and the camera sensor exposure time, during the first capturing mode, may be experimentally determined.

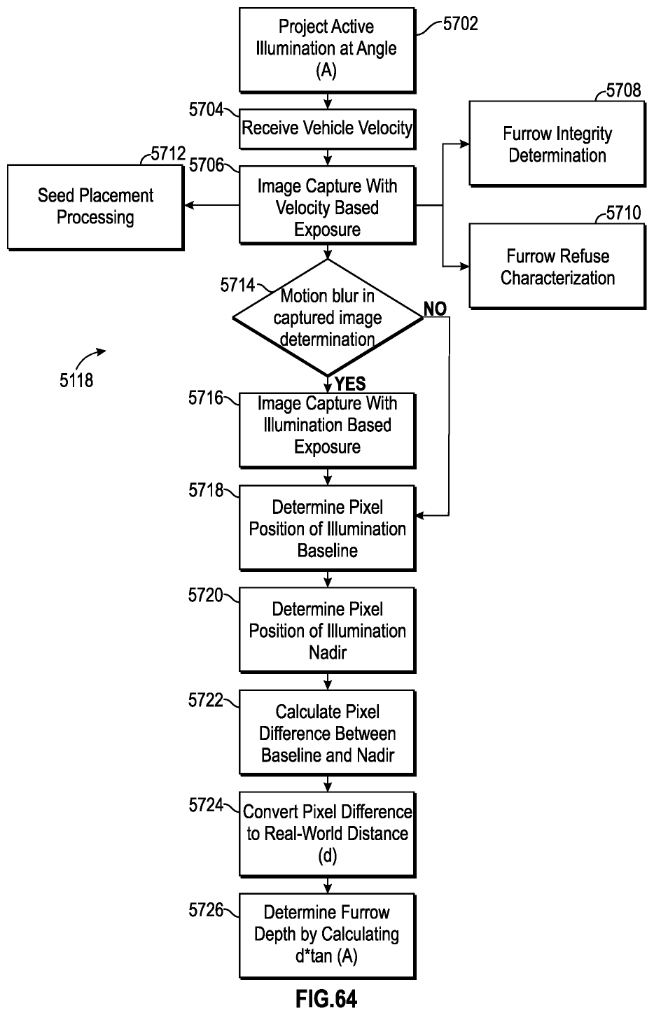

FIG. 64 illustrates a seed depth detection submodule 5118 executed by the furrow analyzing processor 5115 of the imaging system 5100. In one embodiment, the seed depth determination submodule 5118 is executed on images captured under the second exposure mode, however in other embodiments the images may be be captured under the first or third exposure modes or a combination of first, second, and/or third exposure modes.

At step 5702, the laser module 5435 projects active illumination at the angle A towards the ground surface G and the actual furrow in the ground surface G. The angle A has been described previously as the angle A between the camera line of visualization CV of the imaging sensor lens 5430 that intersects with the light plane LP from the laser module 5435. At step 5704, the seed depth detection submodule 5118 executed by the furrow analyzing processor 5115 receives a vehicle velocity of the planter row unit 5600 traveling at the vehicle velocity from one or more sensors on the planter row unit 5600. In one embodiment, the velocity is zero or not in motion such that an illumination baseline can be determined as described below. At step 5706, a seed or commodity is placed or dropped into the furrow in the ground surface G and an image of the seed or commodity in the furrow is captured under velocity based exposure by the imaging unit 5106. The image will also include the furrow and if present debris in the furrow. At step 5708, a furrow integrity determination is made by the seed depth detection submodule 5118 executed by the furrow analyzing processor 5115 based in part on the image captured with velocity based exposure from step 5706. The furrow integrity determination at step 5708 analyzes the image captured with velocity based exposure from step 5706 to determine if the lines of the laser module 5435 are blurry such that there are distorted pixels. Distorted pixels of the lines of the laser module 5435 in the image captured from step 5706 typically indicates that the soil is soft and the actual furrow may collapse prior to closure by the closing system or closing wheel 5626. If the lines of the laser module 5435 in the image captured from step 5706 are crisp and clear, then the soil of the actual furrow should not collapse prior to closure by the closing system or closing wheel 5626.

The furrow refuse characterization at step 5710 executed by the furrow analyzing processor 5115 analyzes the image captured with velocity based exposure from step 5706 to determine if there exists any objects or debris in the actual furrow besides the seed or commodity. As described herein, the furrow refuse characterization at step 5710 executed by the furrow analyzing processor 5115 can perform a color percentage analysis on captured images, wherein a high percentage of tan, beige, and brown colors, with respect to a predetermined threshold, may indicate an amount of refuse within the imaged furrow. The furrow refuse characterization at step 5710 executed by the furrow analyzing processor 5115 is executed on images captured under the second exposure mode. The furrow refuse characterization at step 5710 can also implement a color detection or ‘state of decay’ detection based on color and other visual factors with IR which can detect live or dead plant material. Different organic compounds of the plant material have different peaks of absorption. In some embodiments, an optical filter was attached to the imaging unit 5106 to filter or remove certain spectrums of light to maximize or speed up image processing by the furrow analyzing processor 5115.

Continuing from step 5706, a seed placement processing step 5712 can be performed and is further described below as a seed placement determination submodule 5119.

Continuing from step 5706, a motion blur determination in the captured image with velocity based exposure at step 5714 is made by the seed depth detection submodule 5118 executed by the furrow analyzing processor 5115. If the seed depth detection submodule 5118 executed by the furrow analyzing processor 115 determines that an unacceptable amount of motion blur is present in the captured image, then LED module 5112 is activated to illuminate the seed or commodity in the furrow such that the imaging unit 5106 captures an illumination based image of the seed and the furrow in step 5716. The illumination based image of the seed and the furrow can be another calibration image captured with a higher level of LED illumination in one embodiment. In another embodiment, the illumination based image is a reconstruction of the calibration image capturing. In yet another embodiment, the illumination based image is an image captured with LED and laser activation. If the seed depth detection submodule 5118 executed by the furrow analyzing processor 5115 determines that an unacceptable amount of motion blur is not present in the captured image, then the seed depth detection submodule 118 executed by the furrow analyzing processor 5115 proceeds to step 5718.

At step 5718, a pixel position of a baseline of the top of the ground surface G is determined from the captured image from step 5706 and in some embodiments from the captured image from step 5716 by the seed depth detection submodule 5118 executed by the furrow analyzing processor 5115. If the illumination based captured image from step 5716 is present then it is also used with the captured image with velocity based exposure from step 5706 to determine the pixel position of the baseline in step 5718. If the illumination based captured image from step 5716 is not present then only the captured image with velocity based exposure from step 5706 is used to determine the pixel position of the baseline in step 5718. An illustration of the pixel position of the baseline of the top of the ground surface G is 5818 or 5819 in FIG. 51. An illustration of the pixel position of the baseline of the top of the ground surface G is 5918 or 5919 in FIG. 52 that is determined in step 5718 from the captured image from step 5706.

At step 5720, a pixel position of a nadir or the bottom vertex of the actual furrow in the ground surface G is determined from the captured image from step 5706 and in some embodiments from the captured image from step 5716 by the seed depth detection submodule 5118 executed by the furrow analyzing processor 5115. If the illumination based captured image from step 5716 is present then it is also used with the captured image with velocity based exposure from step 5706 to determine the pixel position of the nadir in step 5720. If the illumination based captured image from step 5716 is not present then only the captured image with velocity based exposure from step 5706 is used to determine the pixel position of the nadir in step 5720. An illustration of the pixel position of the nadir or the bottom vertex of the actual furrow in ground surface G is 5820 in FIG. 51. An illustration of the pixel position of the nadir or the bottom vertex of the actual furrow in the ground surface G is 5920 in FIG. 52 that is determined in step 5720 from the captured image from step 5706.

In step 5722, the seed depth detection submodule 5118 executed by the furrow analyzing processor 5115 determines or calculates a pixel difference between the pixel position of the baseline of the top of the ground surface G in step 5718 and the pixel position of the nadir or the bottom vertex of the actual furrow in the ground surface G in step 5720. In step 5724, the seed depth detection submodule 5118 executed by the furrow analyzing processor 115 determines or converts the pixel difference from step 5722 into a real world distance (d) that corresponds to a number of vertical pixels between step 5718 and step 5720. For example, the seed depth detection submodule 118 executed by the furrow analyzing processor 5115 uses a predetermined pixel size to distance conversion number to convert the pixel difference from step 5722 into the real world distance (d). The predetermined pixel size is known and can be modified as desired based on the imaging unit 5106.

In step 5726, the seed depth detection submodule 5118 executed by the furrow analyzing processor 5115 determines or calculates a furrow depth from the real world distance (d) in step 5724 and the angle A described previously in the step 5702. In some embodiments, the seed depth detection submodule 5118 executed by the furrow analyzing processor 5115 determines or calculates the seed depth (d)*tangent (A) in the furrow.

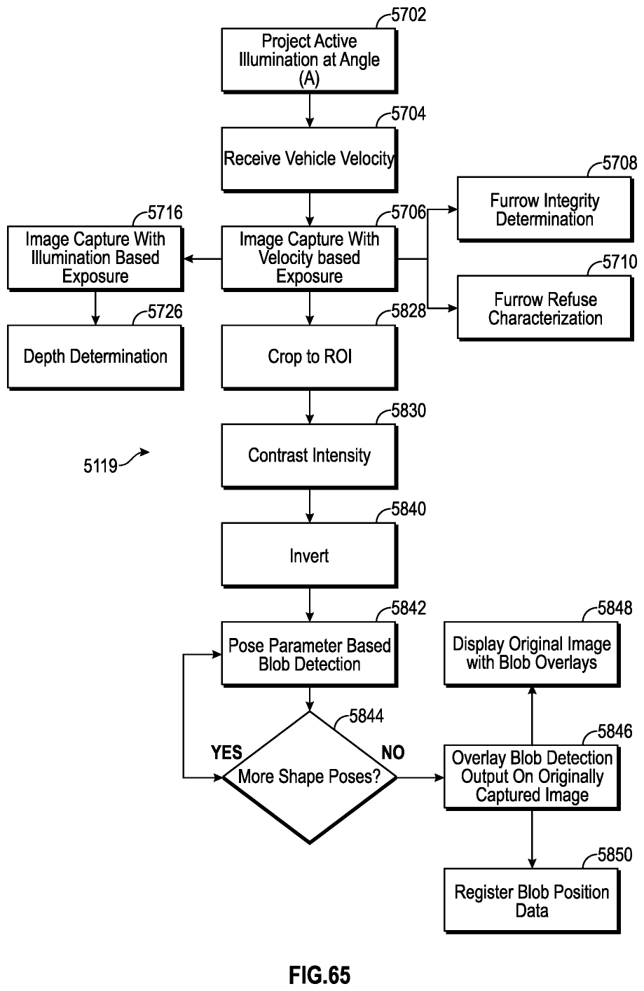

FIG. 65 illustrates a seed placement determination submodule 5119 executed by the furrow analyzing processor 5115 of the imaging system 5100. In one embodiment, the seed placement determination submodule 5119 is executed on images captured under the third exposure mode. The seed placement determination submodule 5119 can be executed on other exposure modes such as the second exposure mode.

The seed placement determination submodule 5119 executed by the furrow analyzing processor 5115 includes the steps 5702, 5704, 5706, and optionally steps 5708, 5710, 5714, 5716, 5718, 5720, 5722, 5724, and 5726 from the seed depth detection submodule 118 as described with respect to FIG. 64. The seed placement determination submodule 5119 corresponds to a seed placement processing step 5712 illustrated in FIG. 64.

Continuing from step 5706 to step 5828, seed placement determination submodule 5119 executed by the furrow analyzing processor 5115 determines from the image of the seed or commodity placed or dropped into the furrow in the ground surface G under velocity based exposure by the imaging unit 5106 to crop the image to a region of interest that includes the seed in the furrow. Step 5828 includes cropping the image to the center of the vertical strike of the seed in the image to avoid determining excess pixel locations for anything else in the images which in turn can decrease the processing time for additional steps described next.

Continuing from step 5828, in step 5830 seed placement determination submodule 5119 executed by the furrow analyzing processor 5115 contrasts the intensity from the cropped image of the seed or commodity placed or dropped into the furrow in the ground surface G. In step 5830, the furrow analyzing processor 5115 contrasts the intensity of the image is adjusted and maximized to be black and white to eliminate other colors such as gray from the image and create a contrasted image.

In step 5840, seed placement determination submodule 5119 executed by the furrow analyzing processor 5115 inverts the contrasted image from step 5830 to create an inverted image. Seed placement determination submodule 5119 executed by the furrow analyzing processor 5115 manipulates the contrasted image from step 5830 such that any pixels in the contrasted image that were white now become black and any pixels in the contrasted image that were black now become white to create the inverted image in step 5840.

In step 5842, seed placement determination submodule 5119 executed by the furrow analyzing processor 5115 analyzes the inverted image from step 5840 to detect blobs which are further analyzed to determine a pose parameter based on the blob detection. Step 5842 is better illustrated with an example seed commodity being corn wherein the images include the corn seed. The seed placement determination submodule 5119 executed by the furrow analyzing processor 5115 analyses the blobs from the inverted image in step 5840 wherein the blobs are representative of corn seed and the furrow analyzing processor 5115 further determines a pose of each of the blobs. The corn seed has a typical shape depending on the view of the corn seed such as triangular, cylindrical or circular, or a rectangle with a dimple on it. The seed placement determination submodule 5119 executed by the furrow analyzing processor 5115 can perform different algorithms that correspond to the view of the corn seed that most closely resembles the blob in the image. The pose or orientation parameter of the blob provides the pose of the corn seed wherein seed placement determination submodule 5119 executed by the furrow analyzing processor 5115 can provide this information to an operator of the planter row unit 5600. Other types of seed or commodities can be analyzed by the seed placement determination submodule 5119 executed by the furrow analyzing processor 5115.

In step 5844, seed placement determination submodule 5119 executed by the furrow analyzing processor 5115 analyzes the shapes from the pose parameter determined in step 5842, and determines if enough shape poses have been collected to form an overlay of blob detection output on the originally captured image from step 5706. If an adequate number of shape poses have been collected in step 5844, then in step 5846 seed placement determination submodule 5119 executed by the furrow analyzing processor 5115 creates an overlay blob detection output on the originally captured image from step 5706. There are different metrics that can be determined from the overlay blob detection output. One output includes determining a location or depth of each of the blobs or seeds. Another output includes determining an average distance between two of the blobs or seeds. Yet another output includes determining a standard deviation of that average distance which further determines the consistency of spacing between two of the blobs. These outputs can be presented to the user via the user experience interface 5135 for action by the user. Alternatively, these outputs could be acted upon automatically by the planter row unit 5600 via the vehicle controller interface 5145. If not enough of the shape poses have been collected in step 5844, then the seed placement determination submodule 5119 executed by the furrow analyzing processor 5115 continues to analyze and collect the poses from the pose parameter based blob detection in step 5842.

In step 5848, the seed placement determination submodule 5119 executed by the furrow analyzing processor 5115 then displays the overlay blob detection output on the originally captured image from step 5706 on the user experience interface 5135 for the operator to view.

In step 5850, the seed placement determination submodule 5119 executed by the furrow analyzing processor 5115 then registers the blob position data from the originally captured image from step 5706. The blob position data that is registered includes the orientation of the corn seed that is in the actual furrow that displays the face of the corn seed that is facing or closest to the imaging unit 5106. For example, the corn seed has three distinct faces that include triangular, cylindrical or circular, or a rectangle with a dimple on one of the faces of the rectangle. The seed placement determination submodule 5119 executed by the furrow analyzing processor 5115 can perform different algorithms that correspond to the view or face of the corn seed that most closely resembles the blob in the image. The seed placement determination submodule 5119 executed by the furrow analyzing processor 5115 performs an algorithm to determine the pose of the corn seed that most closely matches the models used in the algorithm.

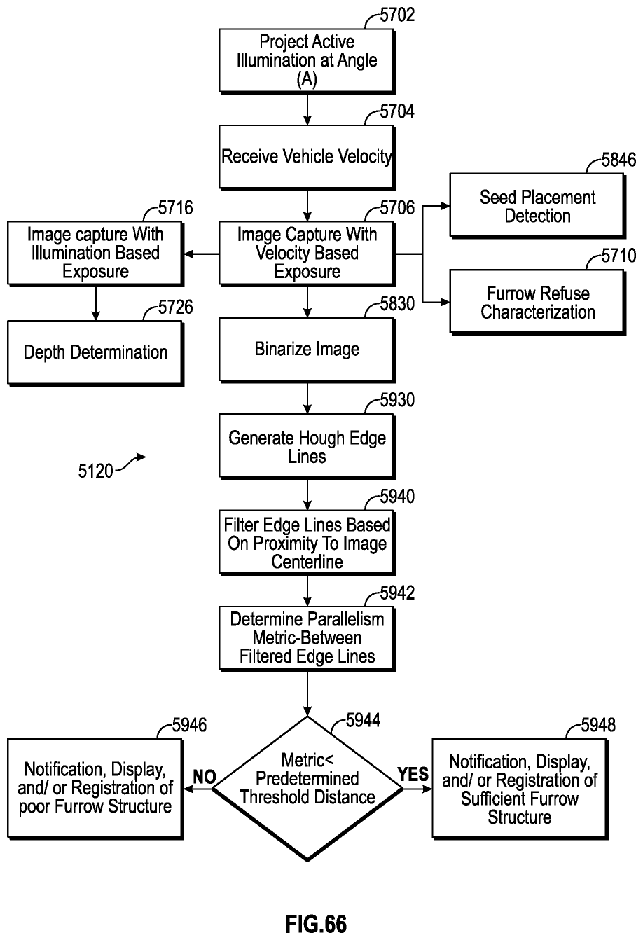

FIG. 66 illustrates a first embodiment of a furrow integrity submodule 5120 executed by the furrow analyzing processor 5115. The first furrow integrity submodule 5120 is executed on images captured under either the second exposure mode or the third exposure mode.

The first embodiment of the furrow integrity submodule 5120 executed by the furrow analyzing processor 5115 includes the steps 5702, 5704, 5706, and optionally steps 5710, 5714, 5716, 5718, 5720, 5722, 5724, and 5726 from the seed depth detection submodule 5118 as described with respect to FIG. 65. The first embodiment of the furrow integrity submodule 5120 executed by the furrow analyzing processor 5115 includes the step 5716 and optionally steps 5828, 5830, 5840, 5842, 5844, and 5846 from the seed placement detection submodule 5119 as described with respect to FIG. 64.

Continuing from step 5706 with step 5830, the first embodiment of the furrow integrity submodule 5120 executed by the furrow analyzing processor 5115 contrasts the intensity from the image captured with velocity based exposure from step 5706. In step 5830, the first embodiment of the furrow integrity submodule 5120 executed by the furrow analyzing processor 5115 contrasts the intensity of the image such that the intensity is adjusted and maximized to be black and white to eliminate other colors from the image and create a contrasted image which in this embodiment is a binarized image.

Step 5930 includes the first embodiment of the furrow integrity submodule 5120 executed by the furrow analyzing processor 5115 generating one or more hough edge lines via hough edge detection from the pixels in the binarized image in step 5830. Step 5940 includes the first embodiment of the furrow integrity submodule 5120 executed by the furrow analyzing processor 5115 filtering the hough edge lines generated in step 5930 based on the proximity to a centerline of the binarized image in step 5830.

Step 5942 includes the first embodiment of the furrow integrity submodule 5120 executed by the furrow analyzing processor 5115 determining a parallelism metric between the filtered hough edge lines from step 5940. The parallelism metric between the filtered hough edge lines measures how parallel the filtered hough edge lines are relative to each other.

Step 5944 includes the first embodiment of the furrow integrity submodule 5120 executed by the furrow analyzing processor 5115 determining if the parallelism metric from step 5942 is less than or greater than a predetermined threshold distance. The predetermined threshold distance indicates if the actual furrow is very stable, or the actual furrow is partially collapsing and/or the actual furrow has already collapsed. In one embodiment, the predetermined threshold distance was one foot. For example, if the parallelism metric from step 5942 is less than one foot or the predetermined threshold distance, then the furrow walls of the actual furrow are sufficient and indicates that the furrow walls should not collapse in step 948. If the parallelism metric from step 5942 is greater than one foot or the predetermined threshold distance, then the furrow structure is not sufficient and indicates that the furrow walls of the actual furrow may collapse in step 5946. It is understood that if the parallelism metric from step 5942 is 100% parallel filtered hough edge lines then the actual furrow is perfect.

If the parallelism metric from step 5942 is greater than the predetermined threshold distance, then the first embodiment of the furrow integrity submodule 5120 executed by the furrow analyzing processor 5115 provides a notification, display, and/or registration of poor or inadequate furrow structure in step 5946.

If the parallelism metric from step 5942 is less than the predetermined threshold distance, then the first embodiment of the furrow integrity submodule 5120 executed by the furrow analyzing processor 5115 provides a notification, display, and/or registration of sufficient furrow structure in step 5948.

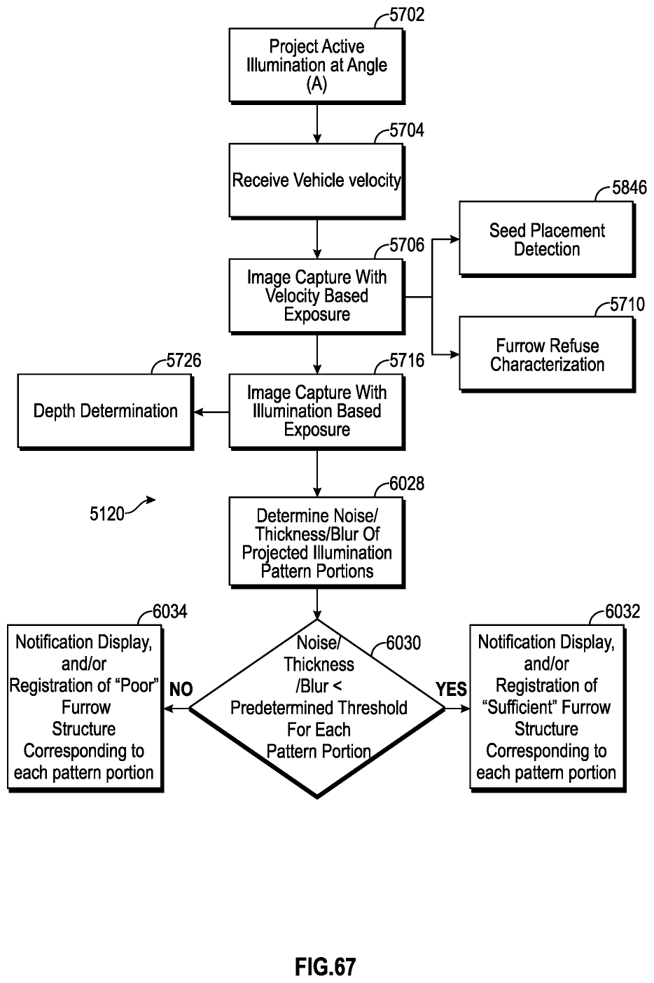

FIG. 67 illustrates a second embodiment of a furrow integrity submodule 5120 executed by the furrow analyzing processor 5115. The second embodiment of the furrow integrity submodule 5120 is executed on images captured under the second exposure mode. In another embodiment the furrow integrity submodule 5120 is executed on images captured under the third exposure mode.

The second embodiment of the furrow integrity submodule 5120 executed by the furrow analyzing processor 5115 includes the steps 5702, 5704, 5706, and optionally steps 5710, 5714, 5716, 5718, 5720, 5722, 5724, and 5726 from the seed depth detection submodule 5118 as described with respect to FIG. 65. The second embodiment of the furrow integrity submodule 5120 executed by the furrow analyzing processor 5115 includes the step 5716 and optionally steps 5828, 5830, 5840, 5842, 5844, and 5846 from the seed placement detection submodule 5119 as described with respect to FIG. 66.

Continuing from step 716, in step 6028, the second embodiment of the furrow integrity submodule 5120 executed by the furrow analyzing processor 5115 determines an amount of image noise, thickness of line, and/or blur of the projected illumination pattern portions of the illumination based on the image of the seed and the furrow in step 5716. The image noise is a variation of brightness or color information in images. For example, the projected laser line is sharper and clearer when the laser is projected along a smoother ground surface G than compared to a less smooth or uneven ground surface G where randomly positioned tiny peaks, valleys, and edges of the surface material reflect rays of the laser in various directions which makes the projected illumination pattern portions of the illumination look fuzzy or blurry which indicate thicker or wider portions along the lines of the projected illumination pattern portions The wider or thicker portions of the lines of the projected illumination pattern portions and the location of the thicker portions along the line (bottom, center, or top) inform the furrow quality score and indicate if the furrow is actively collapsing or stable.

In step 6030, the second embodiment of a furrow integrity submodule 5120 executed by the furrow analyzing processor 5115 compares the amount of image noise, thickness of lines, and/or blur of the projection illumination pattern portions to a predetermined threshold for each pattern portion. The second embodiment of a furrow integrity submodule 5120 executed by the furrow analyzing processor 5115 determines if the amount of image noise, thickness of lines, and/or blur of the projection illumination pattern portions is less than a predetermined threshold for each pattern portion.

In step 6032, if the amount of image noise, thickness of lines, and/or blur of the projection illumination pattern portions is less than a predetermined threshold for each pattern portion, then the second embodiment of a furrow integrity submodule 5120 executed by the furrow analyzing processor 5115 has an output notification and registration of “sufficient” furrow structure corresponding to each pattern portion.

In step 6034, if the amount of image noise, thickness of lines, and/or blur of the projection illumination pattern portions is greater than a predetermined threshold for each pattern portion, then the second embodiment of a furrow integrity submodule 5120 executed by the furrow analyzing processor 5115 has an output notification and registration of “poor” furrow structure corresponding to each pattern portion.

As illustrated above, the second embodiment of the furrow integrity submodule 5120 executed by the furrow analyzing processor 5115 is executed on images captured under the second exposure mode. In some embodiments, the second embodiment of the furrow integrity submodule 120 executed by the furrow analyzing processor 5115 is executed on images captured under the third exposure mode.

Furthermore, in many embodiments, the second embodiment of the furrow integrity submodule 120 executed by the furrow analyzing processor 5115 further comprises accumulating multiple images over time and averaging (or otherwise combining) the image data, and then determining noise/thickness/blur of the averaged (or otherwise combined) image data. The second embodiment of the furrow integrity submodule 5120 may be considered a statistical furrow integrity determination.

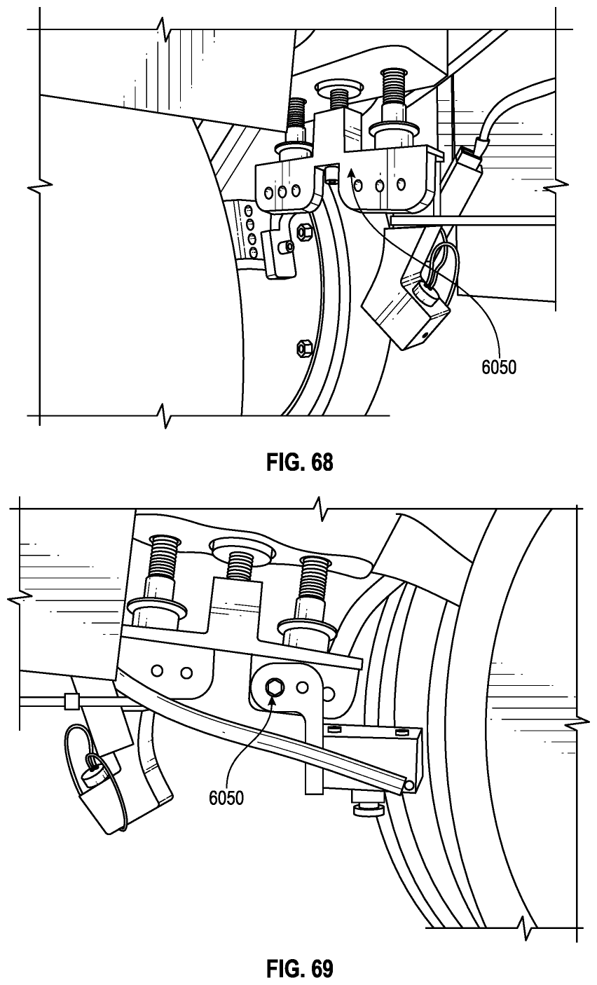

An alternative embodiment of an imaging apparatus 6050 having an imaging unit and an illumination unit is illustrated in FIGS. 68 and 69. The imaging apparatus 6050 is similar to the imaging apparatus 5105.

In some embodiments, in accordance with the present application, images and determined metrics as described above may be tagged during registration with GPS information producing a field map. In many embodiments, the user experience interface 5135 may comprise a processor enabled display system wherein the processor executes computer readable instructions that operate a dynamic widget which produces visualized output illustrating of a plurality of captured data.

In some embodiments of the present application, the imaging apparatus 5105 may capture a plurality of open furrow images and generate modified images based on a rolling average of N_{V} or N_{I} images, wherein N_{V} is a number of images captured according to vehicle velocity-based exposure and N_{I} is a number of images captured according to illumination viewing based exposure. Each generated modified image may comprise stacked or aggregated image data, for example, and without limitation, a modified image may be an average image of N_{V} images or an average image of N_{I} images wherein the processes indicated above with reference to FIGS. 64-67 may be carried out utilizing a generated modified image of either type when appropriate. That is, processing steps subsequent to the velocity-based image capturing may be carried out utilizing a generated modified image which may be an average of N_{V} images, furthermore, processing steps subsequent to the illumination viewing-based image capturing may be carried out on a generated modified image which may be an average of N_{I} images. As introduced above and further described here, the capturing of N images (image stack) comprises a rolling technique so that as each new frame is captured an old frame is removed from the stack. In many embodiments, with each new frame added, the system may also calculate a histogram, brightness, and exposure of the stack image data, wherein it is contemplated that image stacking may be used to overcome sensor noise or as an accommodation/alternative for long exposure requirements.

In some alternative embodiments the generation of modified images may comprise techniques other than averaging. For example, and without limitation, the generated modified images based on N images may comprise aggregating a modified image using local maxima of pixel values of the N images, using summations of pixel values across the N images, using standard deviations of pixel values across the N images, using the median of pixel values across the N images, and/or using a corrected mean across the N images. In some additional embodiments the N images may comprises images captured at various exposure thus producing a blended exposure modified image. Furthermore, the number of images in a stack (i.e. N) may be dynamic.

Another alternative embodiment includes a system and method of structured light-based furrow monitoring that may comprise one or more visual light illumination sources, one or more imagers, and a programmed processing unit uniquely configured to image an open furrow, monitor seed or commodity placement, and identify fertilizer application wherein, the one or more illumination sources may project, into the opened furrow, a pattern of light including shadow lines and high contrast edges, which are observable by the one or more imagers. Furthermore, the programmed processing unit may embody processor-readable instructions which when executed may cause a processor to receive image data of the open furrow, generate a three-dimensional model of the open furrow, generate a three-dimensional model of a falling seed, and determine a seed location prediction, based on the received image data, projected pattern data, generated models, and vehicle parameters.

Another alternative embodiment includes a system and method of stereo vision-based furrow monitoring that may comprise a plurality of imagers and a programmed processing unit uniquely configured to image an open furrow, monitor seed placement, and identify fertilizer application wherein, the programmed processing unit may comprise computer-readable instructions which, when executed by a processor of the programmed processing unit, may cause the processor to receive optical image data from two or more of the plurality of imagers, generate a three-dimensional model of the open furrow, generate a three-dimensional model of a falling seed, and determine a seed location prediction based on the received image data of the two or more imagers and vehicle parameters.

Another alternative embodiment includes a system and method of furrow profiling via push broom lidar that may comprise one or more IR imagers, one or more IR laser emitters, and a programmed processing unit uniquely configured to image an open furrow, monitor seed placement, and identify fertilizer application wherein, the one or more IR laser emitters may be configured to project, into the opened furrow, an IR laser illumination pattern which is observable by the one or more imagers. The programmed processing unit may embody processor-readable instructions which when executed by a processor may cause the processor to receive IR pattern-illuminated image data of the open furrow and generate a three-dimensional model of the open furrow, generate a three-dimensional model of a falling seed, and determine a seed location prediction, based on depth information inferred from imaged IR laser pattern effects which are observable within the furrow.

Another alternative embodiment includes a system and method of furrow profiling via scanning lidar that may comprise a novel scanning mechanism wherein, the scanning mechanism may allow the one or more IR laser emitters to generate specialized and dynamic IR laser illumination patterns which, when captured by the IR imagers, may be processed to infer additional depth, cross-sectional shape, and elevation data due to additional observable effects from the specialized imaged IR laser pattern projected within the furrow.

Another alternative embodiment includes a system and method of furrow imaging via imager synchronized multi-angled pulse laser illumination that may comprise a plurality of pulse laser lighting devices, one or more optical imagers, a safety interlock mechanism, and a programmed processing unit wherein, the plurality of lighting devices include, but are not limited to, pulsed IR laser diodes arranged to illuminate an open furrow from a plurality of distinct angles and configured for synchronized illumination with coordinated imager position and/or exposure. In the present embodiment, the synchronization may comprise, for example, and without limitation, triggering strobe illumination by strobe at a predetermined frame rate, and executing a comparative feature analysis algorithm to infer furrow data. In one embodiment, the predetermined frame rate is a rate of one every 3 or 4 frames. It is contemplated that the current configuration may make the comparative feature analysis more robust.

Another alternative embodiment includes a system and method of furrow imaging via pulsed dynamic spectrum illumination that may comprise a plurality of laser lighting devices, a plurality of imaging devices, a safety interlock mechanism, and a programmed processing unit. The plurality of lighting devices may include, but are not limited to, pulsed illumination devices across a broadband range of the electromagnetic spectrum wherein, an open furrow may be selectively illuminated with one or more wavelengths of the electromagnetic spectrum at a given time. Thus, the programmed processor, may process furrow images captured while the furrow is illuminated under alternating wavelengths of the electromagnetic spectrum. By way of non-limiting example, an illumination sequence may comprise the system providing illumination at a first wavelength, and then providing broadband illumination, which is illumination at substantially all wavelengths producible by the system, or any combination thereof. The illumination sequence may continue wherein, at each instance of illumination, the system may provide one or more electromagnetic spectrum wavelengths for illumination of the furrow.

Yet another alternative embodiment includes systems and methods that may comprise implementing a plurality of differing lighting devices which provide illumination types including, but not limited to, edge source illumination, line source illumination, point source illumination, diffused source illumination, two or more axial illuminations, wherein a programmed processor may be operably coupled to the plurality of illumination devices and one or more sensors for synchronization and image analysis, based on a generated illumination condition under which an open furrow image is captured.

Another alternative embodiment includes systems and methods that may comprise triggering an application of a fluid, within the open furrow, by utilizing any one or a combination of the above optical furrow monitoring systems to obtain an identified seed location data from the captured image. Alternatively, or additionally, systems and methods may comprise triggering an application of a fluid, within the open furrow, by utilizing any one or a combination of the above optical furrow monitoring systems and furrow image/model data for fluid applicator device triggering. In the present embodiment, the system comprises an applicator control module, and one or more applicator devices operably coupled to a novel furrow monitoring system wherein, the one or more applicator devices may be configured to expel fluid material in one or more directions and to a plurality of locations within the open furrow based at least on any of an identified seed location in a captured image, a calculated or predicted seed location from the captured image, furrow and seed image data/models, and/or vehicle parameters. In the present embodiment, a trigger signal may be generated by the furrow analyzing processor based on one or more of the identified seed location in the captured image, a soil characteristic determined from the captured image, or a pest identified in the captured image. An applicator control module receives the trigger signal and triggers the one or more applicator devices to expel fluid material.

Some of the benefits of the present disclosure include measuring and visualizing a three dimensional (3D) geometric shape of a seed trench or furrow created by a planter row unit while the planter row unit is forming the seed trench. The present disclosure utilizes any of the previously described visualization systems 60 or 404, or imaging system 100, that are attached to the planter row units 14 or 400. The present disclosure can also utilize other types of visualization systems, imaging systems, planter row units, or planting vehicles. Any of the visualization or imaging systems utilized herein include one or more of a camera or imaging unit, a structured light unit or illumination unit, and an illumination source configured to spread cast or environment illumination to the vehicle undercarriage environment and the trench.

As described previously, in any embodiment, the one or more camera or imaging unit is oriented to point down towards the ground surface G at the actual trench that is formed by the pair of furrow opening disks or opening system. The camera or imaging unit also points down toward the projected light from the illumination unit at the actual trench (not illustrated) in the ground surface G. In any embodiment, the camera or imaging unit has a camera line of visualization CV that intersects with a light plane LP from the illumination unit to form an angle A there between. The illumination unit or structured light projects a narrow band of light across the actual trench (not illustrated) to produce a line of illumination or patterned light. The illumination unit points towards the ground surface G and the actual trench formed therein. In any embodiment, the illumination unit and the camera or imaging unit are accurately calibrated relative to each other. The illumination unit includes a single laser or single light source that projects a single line, multiple lines, dots, cross, triangle, or other known pattern of light, collectively “patterned light” on the trench in the ground surface G. The illumination unit includes a light source that casts environmental light toward the trench in the ground surface G.

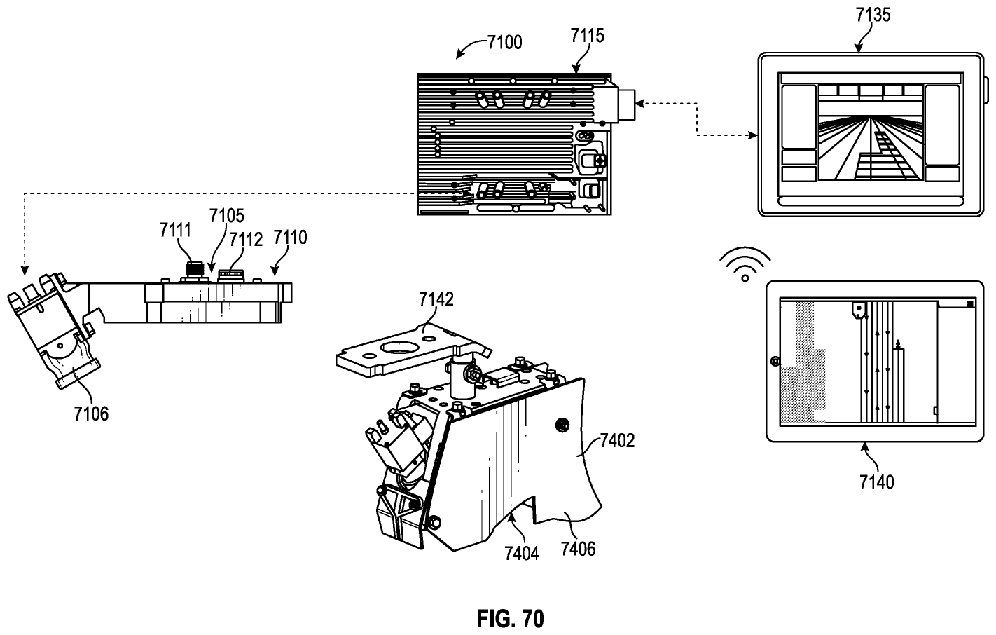

Turning to FIG. 70 is one embodiment of an imaging system 7100. A planting vehicle (not illustrated) may be coupled to the imaging system 7100. Illustrative examples of the planting vehicle are the planter row units previously described above; however, other forms of planter row units may be assembled with the imaging system 7100. The imaging system 7100 is schematically represented but can be any arrangement as previously described. The imaging system 7100 includes an imaging apparatus 7105 operably coupled to a vehicle controller 7115 that includes a furrow analyzing processor.

The furrow analyzing processor of the vehicle controller 7115 is configured to execute computer readable instructions embodied on a computer readable medium. The imaging system 7100 may further comprise a graphical user interface (“UI”) 7135 for visual display of images captured by the imaging apparatus 7105, one or more furrow characteristics, and/or one or more operational parameters detected of the planting vehicle as described below. The UI 7135 can be communicatively and/or operably coupled with one or more one or more toggles or switches (not illustrated) in a user cab of the planting vehicle for operational engagement by the operator or user. The UI 7135 is communicatively and/or operably coupled with the vehicle controller 7115. In some embodiments, the UI 7135 is configured to interact and receive instructions from the operator.

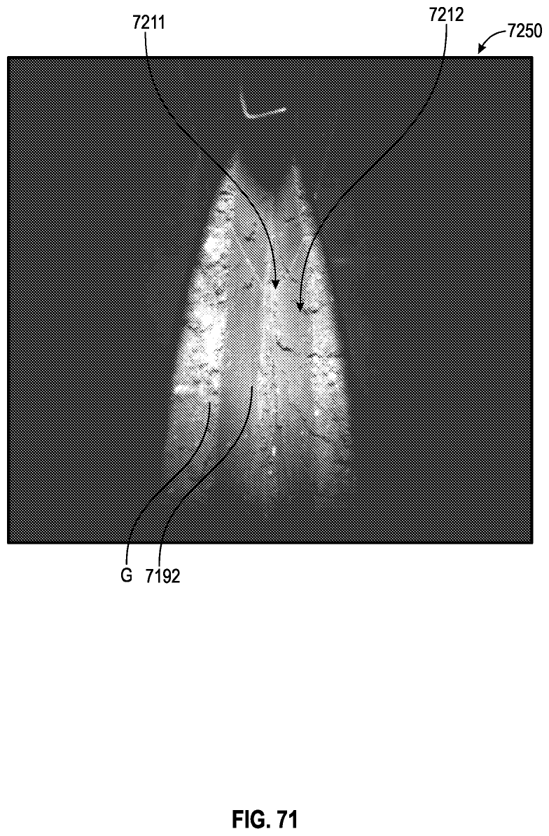

The imaging apparatus 7105 may further comprise an imaging unit 7106 and an illumination unit 7110. The imaging unit 7106 is similar to the imaging unit 106 described above. The illumination unit 7110 is similar to the illumination unit 110 described above. The illumination unit 7110 comprises a laser module 7111 that projects a target illumination 7211 (see FIG. 71). The illumination unit 7110 comprises a cast illumination module or LED module 7112 that spreads cast illumination 7212 to the vehicle undercarriage environment and onto a trench 7192 in a ground surface G (see FIG. 71). The one or more toggles or switches can be operably connected with the imaging apparatus 7105 to engage or disengage the LED module 7112 as desired by the operator. Alternatively, or additionally, the vehicle controller 7115 can also be operably connected with the imaging apparatus 7105 to engage or disengage the LED module 7112 when certain furrow characteristics are detected as described in more detail below.

Optionally, the imaging system 7100 includes a GPS device (not illustrated). The imaging system 7100 is operably connected to a mobile device 7140 such as a mobile phone, computer, laptop, or electronic tablet that includes a user interface for operably engaging with the imaging system 7100 and the operator; however, in other embodiments the imaging system 7100 is not connected to the mobile device 7140. The user interface of the mobile device 7140 can display the same display as the UI 7135 or a different display than UI 7135.

The imaging apparatus 7105 is mounted on a mounting bracket 7142 that is attached to the planter row unit. Alternatively, the imaging apparatus 7105 is mounted or attached to the planter row unit differently as previously described. The imaging system 7100 is operable with any of the shields 402, 1402, 2402, 3402, and 4402, previously described. The imaging system 7100 is also operable with a shield 7402 wherein the shield 7402 is similar to any of shields 402, 1402, 2402, 3402, and 4402. The shield 7402 includes an opening 7404 in a lower portion 7406 of the shield 7402 so that the target illumination 7211 from the laser module 7111 is not blocked by the shield 7402. The opening 7404 enables the projected target illumination 7211 to be projected outward on the ground G by the laser module 7111 which forms more points of the projected target illumination 7211 on the shoulders of the furrow 7192 which greatly benefits the vehicle controller 7115 to determine where one or more reference points of the ground G is located.

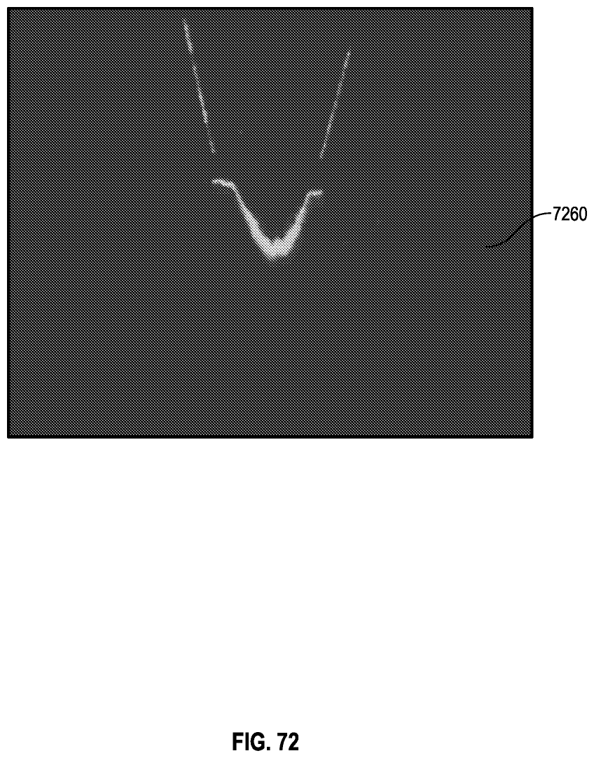

As illustrated in FIGS. 71 and 72, the laser module 7111 projects a straight line which forms a V shape on the furrow 7192 in the ground surface G. The LED module 7112 is a flash or active illumination as described previously. The illumination unit 7110 and/or the vehicle controller 7115 controls operation of the laser module 7111 independently from operation of the LED module 7112. The laser module 7111 can be controlled, such as by the vehicle controller 7115 or the operator, to operate and project a targeted illumination with operation of the LED module 7112 occurring simultaneously as shown in a captured image 7250 as displayed on the UI 7135 as illustrated in FIG. 71. The laser module 7111 can be controlled, such as by the vehicle controller 7115 or the operator, to operate and project a targeted illumination with operation of the LED module 7112 occurring separately such that the LED module 7112 is not operated at the same time as operation of the laser module 7111 as shown in a captured image 7260 as displayed on the UI 7135 as illustrated in FIG. 72.

FIG. 71 illustrates the captured image 7250 as displayed on the UI 7135 that includes the actual furrow 7192 in the ground surface G, the cast illumination 7212 from the LED module 7112, and the targeted illumination 7211 of the laser module 7111. The seed or commodity is not shown in the trench 7192. The captured image 7250 illustrates the laser module 7111 that projects a single line laser or a two-dimensional (2D) laser or light plane LP of light toward the ground surface G, and an image 7211 is illustrated as a line. The image 7211 is a single line in FIG. 71, but more complicated patterns such as multiple lines, grids, or dots could be used in order to have more 3D points. The LED module 7112 projects or casts light towards the actual trench or furrow 7192 to illuminate the actual trench or furrow 7192 and the light plane LP of light from the laser module 7111 as the captured image 7250 from the imaging unit 7106 is displayed on the UI 7135 for the operator. Optionally or additionally, the captured image 7250 can be displayed on the mobile device 7140 or other remote device for the operator to view.

Operation of the LED module 7112 can occur by the operator engaging or dis-engaging the LED module 7112 when certain furrow conditions occur while the laser module 7111 is activated and one or more images are captured by the imaging unit 7106 for display on the UI 7135. Alternatively, operation of the LED module 7112 can occur automatically when certain furrow conditions occur such that the vehicle controller and furrow analyzing processor 7115 engage or dis-engage the LED module 7112 while the laser module 7111 is activated and one or more images are captured by the imaging unit 7106 for display on the UI 7135. The captured image 7250 as displayed on the UI 7135 that includes the actual furrow 7192 in the ground surface G, the cast illumination 7212 from the LED module 7112, and the targeted illumination 7211 of the laser module 7111 is shown in FIG. 71. Some non-limiting examples of the furrow conditions or characteristics that can occur that may trigger operation or non-operation of the LED module 7112 are described below.

FIG. 72 illustrates the captured image from FIG. 71 without the cast illumination from the LED module 7112 such that the LED module 7112 is in a state of non-operation while the laser module 7111 is in a state of operation for the captured image 7260 that is shown on the UI 7135 in FIG. 72. In FIG. 72, the captured image 7260 displays the targeted illumination of the laser module 7111 without activation of the LED module 7112 to better depict the cross-sectional structure of the actual trench more clearly as compared to the captured image 7250 that includes operation of the LED module 7112 in FIG. 71. Moreover, the operator is better able to appreciate the furrow conditions from the captured image 7260 in FIG. 72. The operator can toggle or select when to turn the LED module 7112 on or off but the laser module 7111 is preferably always operational while the imaging unit 7106 captures images for display on the UI 7135.

Some of the furrow characteristics that can be determined with the dis-engagement of the LED module 7112 while the laser module 7111 is activated and the imaging unit 7106 captures images for display on the UI 7135 are described next. Some furrow characteristics include furrow or commodity depth which is the actual furrow depth or commodity depth as compared to the ideal furrow depth or commodity depth. Another furrow characteristic is three-dimensional trench profile which is the three-dimensional actual trench profile compared to the three-dimensional ideal profile. Another furrow characteristic is cleanliness of the furrow or in-furrow residue level to determine if debris, vegetation, or refuse has fallen into the actual furrow. Another furrow characteristic is structure and/or integrity of the actual furrow to determine if the furrow walls have partially or fully collapsed. Another furrow characteristic is trench formation quality that is determined by accuracy of actual trench walls relative to ideal trench walls. Other furrow characteristics include speed optimization, productivity score, and planting rate that is determined via accuracy of actual spacing of the commodity relative to ideal spacing of commodity and/or commodity orientation, residue optimization via accuracy of actual commodity to soil contact relative to ideal commodity to soil contact, and seed to soil contact via accurate closing of the trench relative to ideal closing of the trench.

The furrow characteristics that are detected by the imaging system 7100 when the LED module 7112 is not operational while the laser module 7111 is activated and the imaging unit 7106 captures images that are displayed on the UI 7135, i.e., the captured image 7260, enable the operator or the vehicle controller 7115 to diagnose certain operational parameters of the planting vehicle that may need adjustment. Once the operational parameters are diagnosed, the operator adjusts the planting vehicle accordingly. Alternatively, the vehicle controller 7115 automatically performs a diagnostic inquiry to detect the furrow characteristics. The vehicle controller 7115 is operationally connected with the planting vehicle and can automatically adjust the planting vehicle based on the diagnostic inquiry.

The operator or the vehicle controller 7115 diagnoses the detected furrow characteristic from the captured image 7260 and determines the appropriate operational parameter of the planting vehicle for adjustment. Optionally, the vehicle controller 7115 automatically adjusts the appropriate operational parameter of the planting vehicle. One example of an operational parameter of the planting vehicle that can be adjusted based on the detected furrow characteristic is an amount of downforce that is applied by one or more gauge wheels. Some detected furrow characteristics include furrow depth, commodity depth or orientation, three-dimensional actual trench profile, or trench formation quality, that can trigger adjustment of the amount of downforce that is applied by the gauge wheels.

Another example of an operational parameter of the planting vehicle that can be adjusted based on the detected furrow characteristic is the depth of the furrow opening disks 22, 422, or 5622. Some detected furrow characteristics include furrow depth or furrow cross-sectional shape that can trigger adjustment of the depth of the furrow opening disks 22, 422, or 5622. For example, if the furrow depth is not at an ideal furrow depth or the furrow cross-sectional shape is not an ideal cross-sectional shape, then these furrow characteristics indicate that there is residue, debris, or vegetation in the trench 7192 that is not desired.

Another example of an operational parameter of the planting vehicle that can be adjusted based on the detected furrow characteristic is the closing wheel pressure that corresponds to adjustment of the closing system or the closing wheels 26, 426, or 5626. Some detected furrow characteristics include furrow shape, soil moisture, furrow sidewall condition, and soil composition that is determined via accuracy of actual commodity to soil contact relative to ideal commodity to soil contact. Another example of an operational parameter of the planting vehicle that can be adjusted is position of the row cleaners based on the detected furrow characteristic of the amount of residue.

Another example of an operational parameter of the planting vehicle that can be adjusted based on the detected furrow characteristic is the rate of deposit of seed or commodity that corresponds to adjustment of the seed meter 20. Some detected furrow characteristics include commodity orientation, commodity spacing, accuracy of actual commodity to soil contact relative to ideal commodity to soil contact.

The operator or the vehicle controller 7115 diagnoses problematic issues with the laser module 7111 from the captured image 7260. Some problematic issues include the laser module 7111 is broken or covered with dirt or other environmental materials.

The vehicle controller 7115 can be operably coupled with a GPS to enable location-based field registration and mapping of any of seed placement, seed depth estimation, furrow shape estimation, residue, furrow structure estimation, and location based images on the map from the captured images 7260. The location-based field registration can also account for the velocity of the planting vehicle at the time any images were captured. Another aspect of the present application provides systems and methods for automatically adjusting planter components in response to determined furrow and/or seeding metrics.

While this disclosure has been described with respect to at least one embodiment, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

1. A visualization system for a planter row unit, the planter row unit including a closing system and one or more furrow opening disks, the visualization system comprising:
a structured light unit coupled to the planter row unit at a location between the closing system and the one or more furrow opening disks, where the structured light unit is configured to project a patterned light on a ground surface having a trench formed therein by the one or more furrow opening disks;
a camera coupled to the planter row unit at a location between the closing system and the one or more furrow opening disks, wherein the camera is configured to capture a two-dimensional image of the patterned light on the trench in the ground surface; and
a controller operatively coupled to the camera, the controller configured to determine a three-dimensional measurement of the trench from the two-dimensional image.

2. The visualization system of claim 1, further comprising a general illumination light coupled to the planter row unit at a location between the closing system and the one or more furrow opening disks, wherein the general illumination light and the structured light unit are operable in an alternating sequence while the camera is operable.

3. The visualization system of claim 1, further comprising a general illumination light coupled to the planter row unit at a location between the closing system and the one or more furrow opening disks, where the general illumination light, the structured light unit, and the camera are operable in a synchronized manner;
wherein the general illumination light and the structured light unit are activated when the camera captures the two-dimensional image.

5. The visualization system of claim 1, wherein, when a commodity is disposed in the trench, the camera and the controller are configured to determine a depth of the commodity in the trench based on a location of the commodity in the trench in the two-dimensional image and three-dimensional measurement of the trench.

6. The visualization system of claim 5, wherein the camera and the controller are operable in a synchronized manner to capture the image of the commodity in the trench.

7. The visualization system of claim 1, wherein the patterned light comprises one or more points in the two-dimensional image, where the controller is configured to determine the three-dimensional measurement of the trench from the one or more points.

8. The visualization system of claim 1, further comprising a spotlight or a light emitting diode coupled to the planter row unit, wherein the spotlight or the light emitting diode is coupled between the closing system and the one or more furrow opening disks.

9. A method of determining a three-dimensional measurement of a trench formed in a ground surface by a planter row unit, the planter row unit comprising a closing system and one or more furrow opening disks, the method comprising:
forming a trench by the planter row unit in the ground surface;
projecting a patterned light from a visualization system on the trench, the visualization system comprising a structured light unit and a camera coupled to the planter row unit;
capturing with the camera a two-dimensional image of the projected patterned light on the trench;
communicating the two-dimensional image of the projected patterned light from the camera to a controller; and
determining with the controller a three-dimensional measurement of the trench from the two-dimensional image.

10. The method of claim 9, further comprising:
determining a three-dimensional location of the projected patterned light from the captured two-dimensional image with the visualization system and the three-dimensional measurement of the trench; and
measuring a three-dimensional trench profile from the three-dimensional measurement of the trench with the visualization system.

11. The method of claim 10, further comprising determining a trench quality condition of the trench by comparing the three-dimensional trench profile to an ideal trench profile.

12. The method of claim 10, further comprising:
accumulating two or more images of the trench with the camera; and
reconstructing a length of the trench profile with the accumulated two or more images with the visualization system.

13. The method of claim 9, further comprising illuminating the trench with a general illumination light that is mounted on the planter row unit.

14. The method of claim 13, further comprising alternating between operating the general illumination light and projecting the patterned light from the structured light unit.

15. The method of claim 14, further comprising synchronizing the general illumination light, the structured light unit, and the camera such that the general illumination light and the structured light unit are activated when the camera captures the two-dimensional image.

16. The method of claim 9, further comprising:
depositing a commodity in the trench by the planter row unit;
determining a location of the commodity in the trench in the two-dimensional image with the visualization system; and
determining the commodity depth from the location of the commodity in the two-dimensional image and the three-dimensional measurement of the trench with the visualization system.

17. A method of measuring an actual trench profile formed by a planter row unit, the planter row unit having a closing system and one or more furrow opening disks, the method comprising:
projecting a patterned light from a visualization system onto a trench formed in a ground surface by the one or more furrow opening disks, wherein the visualization system comprises at least a structured light unit and a camera;
capturing a two-dimensional image of the projected patterned light on the trench with the camera of the visualization system, the camera being coupled to the planter row unit;
determining via a controller a three-dimensional location of the projected patterned light from the captured two-dimensional image, the controller being operably coupled to the camera for receiving the two-dimensional image; and
measuring an actual trench depth from the three-dimensional location of the projected patterned light with the visualization system.

18. The method of claim 17, further comprising:
measuring a three-dimensional actual trench profile from the three-dimensional location of the projected patterned light with the visualization system;
capturing two or more images of the actual trench profile with the camera; and
reconstructing a length of the actual trench profile with the two or more images.

19. The method of claim 18, further comprising determining a trench quality condition of the trench by comparing the three-dimensional actual trench profile to an ideal trench profile.

20. The method of claim 17, further comprising:
depositing a commodity in the actual trench by the planter row unit;
determining a location of the commodity in the two-dimensional image; and
determining the commodity depth from the location of the commodity in the two-dimensional image and the actual trench depth.
